(19) United States
(12) Patent Application Publication
(10) Pub. No.: US 2026/0281334 A1
(43) Pub. Date: Sep. 17, 2026

(54) SIGNALING INFORMATION ABOUT MULTIPLE POST PROCESSING FILTERS

(71) Applicant: Nokia Technologies Oy, Espoo (FI)

(72) Inventors: Miska Matias HANNUKSELA, Tampere (FI); Francesco CRICRÌ, Tampere (FI)

(21) Appl. No.: 19/473,351

(22) PCT Filed: Apr. 10, 2024
(86) PCT No.: PCT/IB2024/053477

§ 371 Date: Oct. 7, 2025

Related U.S. Application Data
(60) Provisional application No. 63/495,341, filed on Apr. 11, 2023.

(30) Foreign Application Priority Data
Sep. 21, 2023 (FI) 20236050

(51) Int. Cl. H04N 19/117; H04N 19/179; H04N 19/46; H04N 19/82

(52) U.S. Cl. CPC H04N 19/117; H04N 19/179; H04N 19/46; H04N 19/82

(57) ABSTRACT

Various embodiments provide methods, apparatuses, and computer program products. An example apparatus includes: at least one processor; and at least one memory storing instructions that, when executed by the at least one processor, causes the apparatus at least to: receive, from an encoder, an encoding of at least one picture; receive signaling from the encoder, the signaling comprising information related to a group of at least one post-processing filter; and use the information related to the group of the at least one post-processing filter to infer whether and how to use at least one post-processing filter in the group of the at least one post-processing filter for the at least one picture.

### TECHNICAL FIELD

The examples and non-limiting embodiments relate generally to multimedia transport and, more particularly, to signaling information about multiple post processing filters.

### BACKGROUND

It is known to perform data compression and decoding in a multimedia system.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder used for data compression on a general level.

FIG. 5 shows a system pipeline for VCM.

FIG. 6 shows an example where two postfilters are to be used in cascade.

FIG. 7 shows an example implementing filters of different complexity.

FIG. 8 shows an example implementing two filters in parallel, one filter for visual enhancement and another filter for machine enhancement.

FIG. 9 shows an example where one or more coefficients are used to weight the contribution of the output of each of the two postfilters.

FIG. 10 shows an example where the output of a first filter is used for displaying and the output of a second filter is used as input to one or more machine analysis tasks.

FIG. 11 shows an example using two filters of low complexity for visual enhancement and spatial upsampling, and using two other filters of high complexity for visual enhancement and spatial upsampling.

FIG. 12 shows an example using a combination of two filters for visual enhancement, a filter for machine enhancement and a filter for frame upsampling.

FIG. 13 is a block diagram illustrating a system in accordance with an example.

FIG. 14 is an example apparatus configured to implement the examples described herein.

FIG. 15 shows a representation of an example of non-volatile memory media used to store instructions that implement the examples described herein.

FIG. 16 is an example method performed with a decoder, based on the examples described herein.

FIG. 17 is an example method performed with an encoder, based on the examples described herein.

FIG. 18 is another example method performed with an encoder, based on the example embodiments described herein.

FIG. 19 is another example method performed with an decoder, based on the example embodiments described herein.

FIG. 20 is yet another example method performed with an decoder, based on the example embodiments described herein.

FIG. 21 is yet another example method performed with an encoder, based on the example embodiments described herein.

FIG. 22 is still another example method performed with an decoder, based on the example embodiments described herein.

FIG. 23 is still another example method performed with an encoder, based on the example embodiments described herein.

### DETAILED DESCRIPTION OF EXAMPLE EMBODIMENTS

Described herein is a method and apparatus for signaling information about multiple post-processing filters.

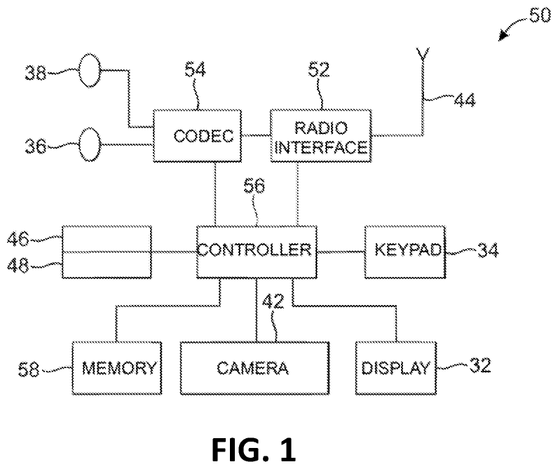

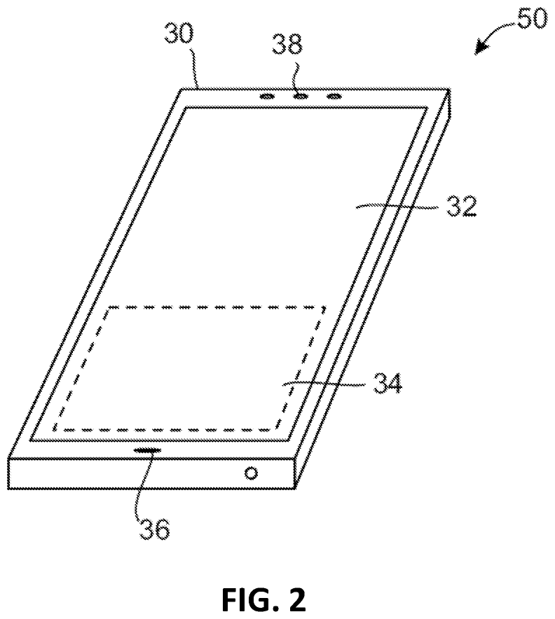

The following describes in detail a suitable apparatus and possible mechanisms for a video/image encoding process according to embodiments. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

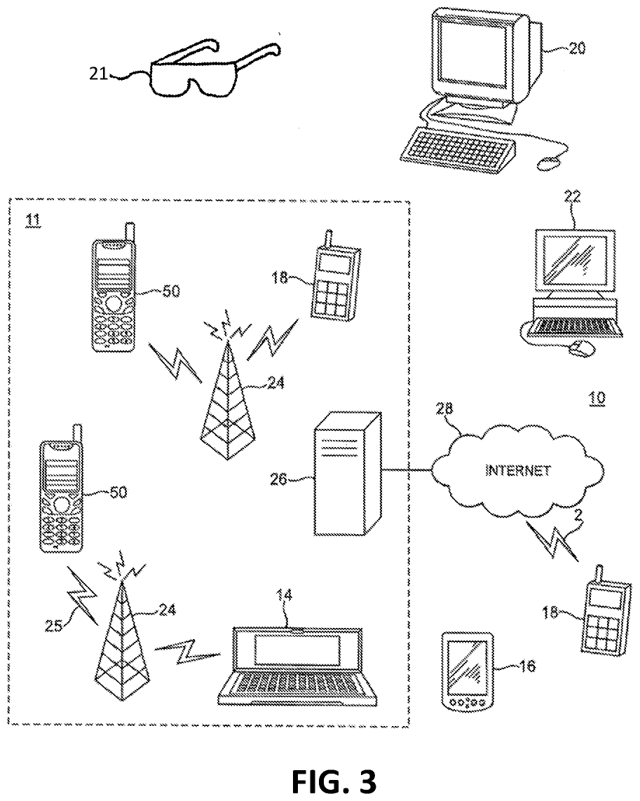

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22, or a head-mounted display (HMD) 21. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

Recently, Hypertext Transfer Protocol (HTTP) has been widely used for the delivery of real-time multimedia content over the Internet, such as in video streaming applications. Several commercial solutions for adaptive streaming over HTTP, such as Microsoft® Smooth Streaming, Apple® Adaptive HTTP Live Streaming and Adobe® Dynamic Streaming, have been launched as well as standardization projects have been carried out. Adaptive HTTP streaming (AHS) was first standardized in Release 9 of 3rd Generation Partnership Project (3GPP) packet-switched streaming (PSS) service (3GPP TS 26.234 Release 9: “Transparent end-to-end packet-switched streaming service (PSS); protocols and codecs”). MPEG took 3GPP AHS Release 9 as a starting point for the MPEG DASH standard (ISO/IEC 23009-1: “Dynamic adaptive streaming over HTTP (DASH)-Part 1: Media presentation description and segment formats,” International Standard, 2nd Edition, 2014). 3GPP continued to work on adaptive HTTP streaming in communication with MPEG and published 3GP-DASH (Dynamic Adaptive Streaming over HTTP; 3GPP TS 26.247: “Transparent end-to-end packet-switched streaming Service (PSS); Progressive download and dynamic adaptive Streaming over HTTP (3GP-DASH)”. MPEG DASH and 3GP-DASH are technically close to each other and may therefore be collectively referred to as DASH. Some concepts, formats, and operations of DASH are described below as an example of a video streaming system, wherein the embodiments may be implemented. The embodiments of the invention are not limited to DASH, but rather the description is given for one possible basis on top of which the invention may be partly or fully realized.

In DASH, the multimedia content may be stored on an HTTP server and may be delivered using HTTP. The content may be stored on the server in two parts: Media Presentation Description (MPD), which describes a manifest of the available content, its various alternatives, their URL addresses, and other characteristics; and segments, which contain the actual multimedia bitstreams in the form of chunks, in a single file or multiple files. The MDP provides the necessary information for clients to establish a dynamic adaptive streaming over HTTP. The MPD contains information describing media presentation, such as an HTTP-uniform resource locator (URL) of each Segment to make GET Segment request. To play the content, the DASH client may obtain the MPD e.g. by using HTTP, email, thumb drive, broadcast, or other transport methods. By parsing the MPD, the DASH client may become aware of the program timing, media-content availability, media types, resolutions, minimum and maximum bandwidths, and the existence of various encoded alternatives of multimedia components, accessibility features and required digital rights management (DRM), media-component locations on the network, and other content characteristics. Using this information, the DASH client may select the appropriate encoded alternative and start streaming the content by fetching the segments using e.g. HTTP GET requests. After appropriate buffering to allow for network throughput variations, the client may continue fetching the subsequent segments and also monitor the network bandwidth fluctuations. The client may decide how to adapt to the available bandwidth by fetching segments of different alternatives (with lower or higher bitrates) to maintain an adequate buffer.

In DASH, hierarchical data model is used to structure media presentation as follows. A media presentation consists of a sequence of one or more Periods, each Period contains one or more Groups, each Group contains one or more Adaptation Sets, each Adaptation Sets contains one or more Representations, each Representation consists of one or more Segments. A Representation is one of the alternative choices of the media content or a subset thereof typically differing by the encoding choice, e.g. by bitrate, resolution, language, codec, etc. The Segment contains certain duration of media data, and metadata to decode and present the included media content. A Segment is identified by a URI and can typically be requested by a HTTP GET request. A Segment may be defined as a unit of data associated with an HTTP-URL and optionally a byte range that are specified by an MPD.

The DASH MPD complies with Extensible Markup Language (XML) and is therefore specified through elements and attributes as defined in XML.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from [www.ietf.org/rfc/rfc3550.txt (last accessed on Sep. 29, 2021)]. In RTP transport, media data is encapsulated into RTP packets. Typically, each media type or media coding format has a dedicated RTP payload format.

RTP is designed to carry a multitude of multimedia formats, which permits the development of new formats without revising the RTP standard. To this end, the information required by a specific application of the protocol is not included in the generic RTP header. For a class of applications (e.g., audio, video), an RTP profile may be defined. For a media format (e.g., a specific video coding format), an associated RTP payload format may be defined. Every instantiation of RTP in a particular application may require a profile and payload format specifications. For example, an RTP profile for audio and video conferences with minimal control is defined in RFC 3551, and an Audio-Visual Profile with Feedback (AVPF) is specified in RFC 4585. The profile may define a set of static payload type assignments and/or may use a dynamic mechanism for mapping between a payload format and a payload type (PT) value using Session Description Protocol (SDP). The latter mechanism is used for newer video codec such as RTP payload format for H.264 defined in RFC 6184 or RTP Payload Format for HEVC defined in RFC 7798.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver device may group packets by synchronization source for playback. Examples of synchronization sources include the sender of a stream of packets derived from a signal source such as a microphone or a camera, or an RTP mixer. Each RTP stream is identified by a SSRC that is unique within the RTP session.

A point-to-point RTP session includes two endpoints, communicating using unicast. Both RTP and RTCP traffic are conveyed endpoint to endpoint.

Many multipoint audio-visual conferences operate utilizing a centralized unit, which may be called Multipoint Control Unit (MCU). An MCU may implement the functionality of an RTP translator or an RTP mixer. An RTP translator may be a media translator that may modify the media inside the RTP stream. A media translator may for example decode and re-encode the media content (e.g., transcode the media content). An RTP mixer is a middlebox that aggregates multiple RTP streams that are part of a session by generating one or more new RTP streams. An RTP mixer may manipulate the media data. One common application for a mixer is to allow a participant to receive a session with a reduced number of resources compared to receiving individual RTP streams from all endpoints. A mixer can be viewed as a device terminating the RTP streams received from other endpoints in the same RTP session. Using the media data carried in the received RTP streams, a mixer generates derived RTP streams that are sent to the receiving endpoints.

The Session Description Protocol (SDP) may be used to convey media details, transport addresses, and other session description metadata, when initiating multimedia teleconferences, voice-over-IP calls, or other multimedia delivery sessions. SDP is a format for describing multimedia communication sessions for the purposes of announcement and invitation. SDP does not deliver any media streams itself but may be used between endpoints e.g., for negotiation of network metrics, media types, and/or other associated properties. SDP is extensible for the support of new media types and formats.

SDP uses attributes to extend the core protocol. Attributes can appear within the Session or Media sections and are scoped accordingly as session-level or media-level. New attributes can be added to the standard through registration with IANA. A media description may contain any number of “a=” lines (attribute-fields) that are media description specific. Session-level attributes convey additional information that applies to the session as a whole rather than to individual media descriptions.

The “fmtp” attribute of SDP allows parameters that are specific to a particular format to be conveyed in a way that SDP does not have to understand them. The format must be one of the formats specified for the media. Format-specific parameters, semicolon separated, may be any set of parameters required to be conveyed by SDP and given unchanged to the media tool that will use this format. At most one instance of this attribute is allowed for each format.

The SDP offer/answer model specifies a mechanism in which endpoints achieve a common operating point of media details and other session description metadata when initiating the multimedia delivery session. One endpoint, the offerer sends a session description (the offer) to the other endpoint, the answerer. The offer contains all the media parameters needed to exchange media with the offerer, including codecs, transport addresses, and protocols to transfer media. When the answerer receives an offer, it elaborates an answer and sends it back to the offerer. The answer contains the media parameters that the answerer is willing to use for that particular session. SDP may be used as the format for the offer and the answer.

An initial SDP offer includes zero or more media streams, wherein each media stream is described by an “m=” line and its associated attributes. Zero media streams implies that the offerer wishes to communicate, but that the streams for the session will be added at a later time through a modified offer.

A direction attribute may be used in the SDP offer/answer model as follows. If the offerer wishes to only send media on a stream to its peer, it marks the stream as sendonly with the “a=sendonly” attribute. If the offerer wishes to only receive media from its peer, it marks the stream as recvonly. If the offerer wishes to both send and receive media with its peer, it may include an “a=sendrecv” attribute in the offer, or it may omit it, since sendrecv is the default.

In the SDP offer/answer model, the list of media formats for each media stream comprises the set of formats (codecs and any parameters associated with the codec, in the case of RTP) that the offerer is capable of sending and/or receiving (depending on the direction attributes). If multiple formats are listed, it means that the offerer is capable of making use of any of those formats during the session and thus the answerer may change formats in the middle of the session, making use of any of the formats listed, without sending a new offer. For a sendonly stream, the offer indicates those formats the offerer is willing to send for this stream. For a recvonly stream, the offer indicates those formats the offerer is willing to receive for this stream. For a sendrecv stream, the offer indicates those codecs or formats that the offerer is willing to send and receive with. The list of media formats in the “m=” line is listed in the order preference, the first entry in the list being the most preferred.

SDP may be used for declarative purposes, e.g., for describing a stream available to be received over a streaming session. For example, SDP may be included in Real Time Streaming Protocol (RTSP).

A Multipurpose Internet Mail Extension (MIME) is an extension to an email protocol which makes it possible to transmit and receive different kinds of data files on the Internet, for example video, audio, images, and software. An internet media type is an identifier used on the Internet to indicate the type of data that a file contains. Such internet media types may also be called as content types. Several MIME type/subtype combinations exist that can contain different media formats. Content type information may be included by a transmitting entity in a MIME header at the beginning of a media transmission. A receiving entity thus may need to examine the details of such media content to determine if the specific elements can be rendered given an available set of codecs. Especially when the end system has limited resources, or the connection to the end system has limited bandwidth, it may be helpful to know from the content type alone if the content can be rendered.

One of the original motivations for MIME is the ability to identify the specific media type of a message part. However, due to various factors, it is not always possible from looking at the MIME type and subtype to know which specific media formats are contained in the body part or which codecs are indicated in order to render the content. Optional media parameters may be provided in addition to the MIME type and subtype to provide further details of the media content.

Optional media parameters may be conveyed in SDP, e.g., using the “a=fmtp” line of SDP. Optional media parameters may be specified to apply for certain direction attribute(s) with an SDP offer/answer and/or for declarative purposes. Optional media parameters may be specified not to apply for certain direction attribute(s) with an SDP offer/answer and/or for declarative purposes. Semantics of optional media parameters may depend on and may differ based on which direction attribute(s) of an SDP offer/answer they are used with and/or whether they are used for declarative purposes.

An example of an optional media parameter specified in the VVC RTP payload format is sprop-sei. When present, sprop-sei conveys one or more SEI messages that describe bitstream characteristics. A decoder can rely on the bitstream characteristics that are described in the SEI messages carried within sprop-sei for the entire duration of the session, independently of the persistence scopes of the SEI messages specified in H.274/VSEI or VVC. The value of sprop-sei may be defined as a comma-separated list, where each list element is a base64 representation (as defined in RFC 4648) of an SEI NAL unit.

In an example, empty or truncated SEI message payloads are allowed in sprop-sei to indicate the capability of the offerer to encode these SEI messages with any SEI message payload that starts with the bits included in sprop-sei (if any).

In an example, an optional recv-sei MIME parameter in an SDP answer indicate which SEI messages must be present in the bitstream from the offerer to the answerer. The SEI messages in recv-sei may be allowed or required to be of the following types: the SEI message may be required to be the same as directly included in the sprop-sei of the offer; the SEI message may be required to have a type indicated in a SEI manifest SEI message in the sprop-sei of the offer; the SEI message may be required to have a type and start with the respective content indicated by a SEI prefix indication SEI message contained within the srop-sei. When an SEI message with a particular SEI message type is present in sprop-sei of an offer and is absent in recv-sei in an answer, it may indicate that the answerer does not support the processing the SEI message included in sprop-sei.

In an example, an optional recv-sei MIME parameter is introduced along the following principles: The SEI messages included in recv-sei in an answer indicate which SEI messages must be present in the bitstream from the offerer to the answerer. When recv-sei is present in an answer, the SEI message types in recv-sei may be required to be the same as or a subset of those included in the sprop-sei of the offer. When recv-sei is present in an answer, the SEI message payload for a particular SEI message type in recv-sei may be required to start with the SEI message payload bits present (if any) in recv-sei for the same SEI message type. It is suggested to allow empty or truncated SEI message payloads in recv-sei to indicate that the answerer has the liberty to encode any values for remaining of the SEI message payload (as long as they conform to the specification where the SEI message is specified). When an SEI message with a particular SEI message type is present in sprop-sei of an offer and is absent in recv-sei in an answer, it may indicate that the answerer does not support the processing the SEI message included in sprop-sei.

In an example, an optional MIME parameter in an SDP offer from the offerer to the answerer contains an SEI NAL unit containing an SEI manifest SEI message and one or more SEI prefix indication SEI messages to indicate a capability of an encoder in the offerer to encode SEI messages as indicated by the semantics of the SEI manifest SEI message and the one or more SEI prefix indication SEI messages and encode a bitstream obeying the constraints implied by the encoded SEI messages.

In an example, an optional MIME parameter in an SDP answer from the answerer to the offerer contains an SEI NAL unit containing an SEI manifest SEI message and one or more SEI prefix indication SEI messages to indicate a requirement or preference of the offerer for encoded SEI messages included in the bitstream from the offerer to the answerer, as indicated by the semantics of the SEI manifest SEI message and the one or more SEI prefix indication SEI messages.

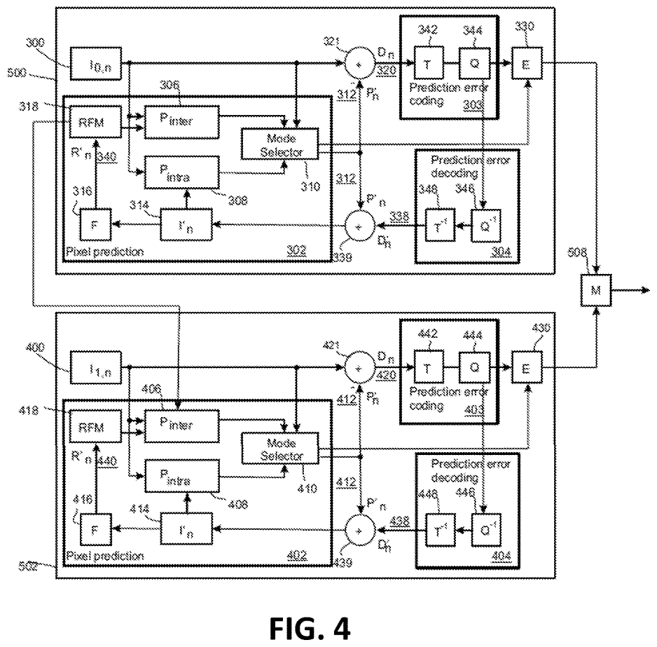

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pᵢₙₜₑᵣ), an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives base layer images (I_{0,n}) 300 of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

### Fundamentals of Neural Networks

A neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two of the most widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers, and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of device, such as mobile phones. Examples include image and video analysis and processing, social media data analysis, device usage data analysis, etc.

An important property of neural nets (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

As used herein, the terms “model”, “neural network”, “neural net” and “network” interchangeably, and also the weights of neural networks are sometimes referred to as learnable parameters or simply as parameters.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data is usually split into at least two sets, the training set and the validation set. The training set is used for training the network, i.e., to modify its learnable parameters in order to minimize the loss. The validation set is used for checking the performance of the network on data which was not used to minimize the loss, as an indication of the final performance of the model. In particular, the errors on the training set and on the validation set are monitored during the training process to understand the following things:

If the network is learning at all—in this case, the training set error should decrease, otherwise the model is in the regime of underfitting.

If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set, but performs poorly on a set not used for tuning its parameters.

While the above background information on neural networks and related training algorithms may be valid at the time when this document was written, the field of neural networks and machine learning in general is developing at a fast pace. Thus, it is to be understood that at least some of the embodiments described herein are not limited to the definition of a neural network, or a machine learning model, or a training algorithm that was given in the background information above.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder (we refer to these simply as encoder and decoder, even though we may refer to algorithms which are learned from data instead of being tuned by hand). The encoder takes as input an image and produces a code which requires less bits than the input image. This code may be obtained by applying a binarization or quantization process to the output of the encoder. The decoder takes in this code and reconstructs the image which was input to the encoder.

Such encoder and decoder are usually trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These metrics are meant to be correlated to the human visual perception quality, so that minimizing or maximizing one or more of these metrics results into improving the visual quality of the decoded image as perceived by humans.

### Some Video Coding and Video Metadata Specifications

The Advanced Video Coding standard (which may be abbreviated H.264, AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated H.265, HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance of Open Media (AOM). The AV1 specification was published in 2018. AOM is reportedly working on the AV2 specification.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams. VUI parameters and SEI messages may, for example, assist in processes related to decoding, display or other purposes.

### Fundamentals of Video/Image Coding

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr or Cg and Co; regardless of the actual color representation method in use. The actual color representation method in use may be indicated, e.g., in a coded bitstream e.g., using the Video Usability Information (VUI) syntax. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Coding formats or standards may allow to code sample arrays as separate color planes into the bitstream and respectively decode separately coded color planes from the bitstream. When separate color planes are in use, each one of them is separately processed (by the encoder and/or the decoder) as a picture with monochrome sampling.

Video codec consists of an encoder that transforms the input video into a compressed representation suited for storage/transmission and a decoder that can decompress the compressed video representation back into a viewable form. Typically encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures (a.k.a. reference pictures).

In temporal inter prediction, the sources of prediction are previously decoded pictures in the same scalable layer. In intra block copy (IBC; a.k.a. intra-block-copy prediction), prediction may be applied similarly to temporal inter prediction but the reference picture is the current picture and only previously decoded samples can be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

Image and video codecs may use a set of filters, which may enhance the visual quality of the predicted visual content. Filters may be applied either in-loop or out-of-loop, or both. In-loop filters (which may be also called loop filters) are used in reconstructing prediction reference that may be used for predicting forthcoming video signal. In other words, in the case of in-loop filters, the filter applied on one block in the currently encoded frame may affect the encoding of another block in the same frame and/or in another frame which is predicted from the current frame. An in-loop filter may affect the bitrate and/or the visual quality. In fact, an enhanced block may cause a smaller residual (difference between original block and predicted-and-filtered block), thus requiring less bits to be encoded. An out-of-the loop filter (which may also be called a post-processing filter or a post-filter) may be applied on a frame or part of a frame after it has been reconstructed, the filtered visual content may not be used as a source for prediction, and thus it may only impact the visual quality of the frames that are output by the decoder.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures.

In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks.

Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or or co-located blocks in temporal reference picture.

Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage may additionally or alternatively be used, e.g., for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) including coded video data.

The phrase along the bitstream (e.g., indicating along the bitstream) or along a coded unit of a bitstream (e.g., indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is included in a container file, such as a file conforming to the ISO Base Media File Format, and certain file metadata is stored in the file in a manner that associates the metadata to the bitstream, such as boxes in the sample entry for a track including the bitstream, a sample group for the track including the bitstream, or a timed metadata track associated with the track including the bitstream. In another example, the phrase along the bitstream may be used when the bitstream is made available as a stream over a communication protocol and a media description, such as a streaming manifest, is provided to describe the stream.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload, when a start code would have occurred otherwise. In order to enable straightforward gateway operation between packet and stream-oriented systems, start code emulation prevention may be performed regardless of whether the bytestream format is in use or not. A NAL unit may be defined as a syntax structure including an indication of the type of data to follow and bytes including that data in the form of a raw byte sequence payload interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g., called nuh_layer_id in H.265/HEVC and H.266/VVC), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as temporal layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Some video coding specifications enable metadata OBUs. A metadata OBU comprises a type field, which specifies the type of metadata.

A coded video sequence (CVS) may be defined as a sequence of coded pictures in decoding order that is independently decodable and is followed by another coded video sequence or the end of the bitstream.

A coded layer video sequence (CLVS) may be defined as a sequence of pictures and associated other data within the same scalable layer (e.g., with the same value of nuh_layer_id in VVC) that is decodable independently of other pictures in the same layer.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance. The variable including a POC value of a picture may be referred to as PicOrderCntVal.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de) coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have _idc postfix in its name.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

### Scalable Video Coding

A scalable bitstream may include a “base layer” providing the lowest quality video available and one or more enhancement layers that enhance the video quality when received and decoded together with the lower layers. In order to improve coding efficiency for the enhancement layers, the coded representation of that layer may depend on the lower layers. E.g., the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use e.g., with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

Scalability modes or scalability dimensions may include but are not limited to the following:

Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer.

Spatial scalability: Base layer pictures are coded at a lower resolution (i.e., have fewer samples) than enhancement layer pictures. Spatial scalability and quality scalability may sometimes be considered the same type of scalability.

Bit-depth scalability: Base layer pictures are coded at lower bit-depth (e.g., 8 bits) than enhancement layer pictures (e.g., 10 or 12 bits).

Dynamic range scalability: Scalable layers represent a different dynamic range and/or images obtained using a different tone mapping function and/or a different optical transfer function.

Chroma format scalability: Base layer pictures provide lower spatial resolution in chroma sample arrays (e.g., coded in 4:2:0 chroma format) than enhancement layer pictures (e.g., 4:4:4 format).

Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.

Region-of-interest (ROI) scalability: An enhancement layer represents a spatial subset of the base layer. ROI scalability may be used together with other types of scalabilities, e.g., quality or spatial scalability so that the enhancement layer provides higher subjective quality for the spatial subset.

View scalability, which may also be referred to as multiview coding. The base layer represents a first set of views, whereas an enhancement layer represents a second set of views.

Depth scalability, which may also be referred to as depth-enhanced coding. A layer or some layers of a bitstream may represent texture view(s), while other layer or layers may represent depth view(s).

In all of the above scalability cases, base layer information could be used to code enhancement layer to minimize the additional bitrate overhead.

Scalability can be enabled in two basic ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame-based scalability, approach can be implemented very efficiently with minimal changes to single layer codecs while still achieving majority of the coding efficiency gains available. Essentially a reference frame-based scalability codec can be implemented by utilizing the same hardware or software implementation for all the layers, just taking care of the DPB management by external means.

In ROI scalability, spatial correspondence of an ROI enhancement layer in relation to its reference layer(s) is indicated. In VVC, scaling windows can be used to indicate this spatial correspondence.

It has been proposed, e.g. in JVET-O1150 (https://www.jvet-experts.org/doc_end_user/documents/15_Gothenburg/wg11/JVET-O1150-v2.zip), that temporal sublayers could be used for any type of scalability. A mapping of scalability dimensions to sublayer identifiers could be provided e.g. in a VPS or in an SEI message.

### Neural-Network Post-Filter Characteristics (NNPFC) and Neural-Network Post-Filter Activation (NNPFA) SEI Messages

The neural-network post-filter characteristics (NNPFC) SEI message and the neural-network post-filter activation (NNPFA) SEI message have been described in document JVET-AC2032.

The NNPFC SEI message comprises the nnpfc_id syntax element, which contains an identifying number that may be used to identify a post-processing filter. A base post-processing filter is the filter that is contained in or identified by the first NNPFC SEI message, in decoding order, that has a particular nnpfc_id value within a coded layer video sequence (CLVS). If an NNPFC SEI message is neither the first NNPFC SEI message, in decoding order, in the current CLVS nor a repetition of the first NNPFC SEI message, in decoding order, that has a particular nnpfc_id value within the current CLVS, the NNPFC SEI message defines an update relative to the base post-processing filter, and the update relative to the base post-processing filter is applied to obtain a post-processing filter associated with the nnpfc_id value. The update may be obtained by decoding the coded neural network bitstream in the second NNPFC SEI message (when nnpfc_mode_idc is equal to 0) or through the Uniform Resource Identifier defining the update (when nnpfc_mode_idc is equal to 1). Otherwise (i.e., when there is no update defined by an NNPFC SEI message), the post-processing filter associated with the nnpfc_id value is assigned to be the same as the base post-processing filter.

The NNPFC SEI message comprises nnpfc_mode_idc syntax element, the semantics of which may be defined as follows:

nnpfc_mode_idc equal to 1 specifies that the base post-processing filter or the update relative to the base post-processing filter associated with the nnpfc_id value is a neural network identified by the Uniform Resource Identifier (URI) nnpfc_uri with the format identified by the tag URI nnpfc_tag_uri.

nnpfc_mode_idc equal to 0 indicates that this SEI message contains an ISO/IEC 15938-17 bitstream that specifies the base post-processing filter or updates relative to the base post-processing filter with the same nnpfc_id value.

The NNPFC SEI message may also comprise:
1. Purpose of the post-processing filter, which may comprise one or more of the following: visual quality improvement, chroma upsampling from the 4:2:0 chroma format to the 4:2:2 or 4:4:4 chroma format, or from the 4:2:2 chroma format to the 4:4:4 chroma format, increasing the width or height, frame rate upsampling, bit depth upsampling, colorization.
2. Formatting of the input tensors that are given as input to the neural network inference
3. Formatting of the output tensors that are resulting from the neural network inference
4. Characterization of the complexity of the neural network

The NNPFA SEI message specifies the neural-network post-processing filter that may be used for post-processing filtering for the current picture, or for post-processing filtering for the current picture and one or more other pictures. The NNPFA SEI message comprises the nnpfa_target_id syntax element, which indicates that the neural-network post-processing filter with nnpfc_id equal to nnfpa_target_id may be used for post-processing filtering for the indicated persistence. The indicated persistence may be the current picture only (nnpfa_persistence_flag equal to 0), or until the end of the current CLVS or the next picture, in output order, in the current layer associated with a NNPFA SEI message with the same nnpfa_target_id as the current SEI message (nnpfa_persistence_flag equal to 1). A target filter or a target NNPF may be defined as the NNPF that is identified by the value of nnpfa_target_id. A target filter identifier may be defined as the value of nnpfa_target_id. Generally, a target filter or a target filter identifier need not be limited to a NNPF or an identifier of a NNPF but may apply generally to any type of a post-filter or any type of a post-processing operation, in which case the target filter may be identified using a target filter identifier in an SEI message similarly to identifying the target NNPF using the value of nnpfa_target_id in an NNPFA SEI message.

### SEI Manifest SEI Message

An SEI manifest SEI message has been specified for example in the H.265/HEVC standard and the H.266/VVC standard. An SEI manifest SEI message conveys information on SEI messages that are indicated as expected (i.e., likely) to be present or not present in a coded video sequence (CVS) or a bitstream. Such information may include the following:
The indication that certain types of SEI messages are expected (i.e., likely) to be present (although not guaranteed to be present) in the CVS.
For each type of SEI message that is indicated as expected (e.g., likely) to be present in the CVS, the degree of expressed necessity of interpretation of the SEI messages of this type, as follows:
   The degree of necessity of interpretation of an SEI message type may be indicated as “necessary”, “unnecessary”, or “undetermined”.
   An SEI message is indicated by the encoder (i.e., the content producer) as being “necessary” when the information conveyed by the SEI message is considered as necessary for interpretation by the decoder or receiving system in order to properly process the content and enable an adequate user experience; it does not mean that the bitstream is required to contain the SEI message in order to be a conforming bitstream. It is at the discretion of the encoder to determine which SEI messages are to be considered as necessary in a particular CVS.
The indication that certain types of SEI messages are expected (e.g., likely) not to be present (although not guaranteed not to be present) in the CVS.

The content of an SEI manifest SEI message may, for example, be used by transport-layer or systems-layer processing elements to determine whether the CVS is suitable for delivery to a receiving and decoding system, based on whether the receiving system can properly process the CVS to enable an adequate user experience or whether the CVS satisfies the application needs.

It may be required that an SEI NAL unit containing an SEI manifest SEI message does not contain any other SEI messages other than SEI prefix indication SEI messages. When present in an SEI NAL unit, the SEI manifest SEI message may be required to be the first SEI message in the SEI NAL unit.

### SEI Prefix Indication SEI Message

An SEI prefix indication SEI message has been specified in the H.265/HEVC standard and the H.266/VVC standard. The SEI prefix indication SEI message carries one or more SEI prefix indications for SEI messages of a particular value of SEI payload type (payloadType). Each SEI prefix indication is a bit string that follows the SEI payload syntax of that value of payloadType and contains a number of complete syntax elements starting from the first syntax element in the SEI payload.

Each SEI prefix indication for an SEI message of a particular value of payloadType indicates that one or more SEI messages of this value of payloadType are expected or likely to be present in the coded video sequence (CVS) and to start with the provided bit string. A starting bit string would typically contain only a true subset of an SEI payload of the type of SEI message indicated by the payloadType, may contain a complete SEI payload, and shall not contain more than a complete SEI payload. It is not prohibited for SEI messages of the indicated value of payloadType to be present that do not start with any of the indicated bit strings.

SEI prefix indications should provide sufficient information for indicating what type of processing is needed or what type of content is included. The former (type of processing) indicates decoder-side processing capability, e.g., whether some type of frame unpacking is needed. The latter (type of content) indicates, for example, whether the bitstream contains subtitle captions in a particular language.

The content of an SEI prefix indication SEI message may, for example, be used by transport-layer or systems-layer processing elements to determine whether the CVS is suitable for delivery to a receiving and decoding system, based on whether the receiving system can properly process the CVS to enable an adequate user experience or whether the CVS satisfies the application needs.

### SEI Processing Order

The SEI processing order SEI message has been described in document JVET-AA2027. The SEI processing order SEI message carries information indicating the preferred processing order, as determined by the encoder (i.e., the content producer), for different types of SEI messages that may be present in the bitstream. When an SEI processing order SEI message is present, it is present in the first access unit of the coded video sequence (CVS). The SEI processing order SEI message persists in decoding order from the current access unit until the end of the CVS. The SEI processing order SEI message comprises a list of pairs, each pair comprising a SEI payload type value po_sei_payload_type[i] and a processing order value po_sei_processing_order[i]. po_sei_payload_type[i] specifies the value of payloadType for the i-th SEI message for which information is provided in the SEI processing order SEI message. po_sei_processing_order[i] indicates the preferred order of processing any SEI message with payloadType equal to po_sei_payload_type[i]. po_sei_processing_order[m] greater than 0 and less than po_sei_processing_order[n] indicates any SEI message with payloadType equal to po_sei_payload_type[m], when present, should be processed before any SEI message with payloadType equal to po_sei_payload_type[n], when present. po_sei_processing_order[m] greater than 0 and equal to po_sei_processing_order[n] indicates that the preferred order of processing of SEI messages with payloadTypes equal to po_sei_payload_type[m] and po_sei_payload_type[n] is unknown or unspecified or determined by external means not specified in this Specification. po_sei_processing_order[i] equal to 0 specifies that the preferred order of processing SEI messages with payloadType equal to po_sei_payload_type[i] is unknown or unspecified or determined by external means.

### Information on Video Coding for Machines (VCM)

Reducing the distortion in image and video compression is often intended to increase human perceptual quality, as humans are considered to be the end users, i.e. consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. This may raise the following question: when decoded data is consumed by machines, shouldn't we aim at a different quality metric—other than human perceptual quality—when considering media compression in inter-machine communications? Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines.

It is likely that the receiver-side device has multiple “machines” or neural networks (NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

Also, please notice that we use the term “receiver-side” or “decoder-side” to refer to the physical or abstract entity or device which contains one or more machines, and runs these one or more machines on some encoded and eventually decoded video representation which is encoded by another physical or abstract entity or device, the “encoder-side device”.

The encoded video data may be stored into a memory device, for example as a file. The stored file may later be provided to another device.

Alternatively, the encoded video data may be streamed from one device to another.

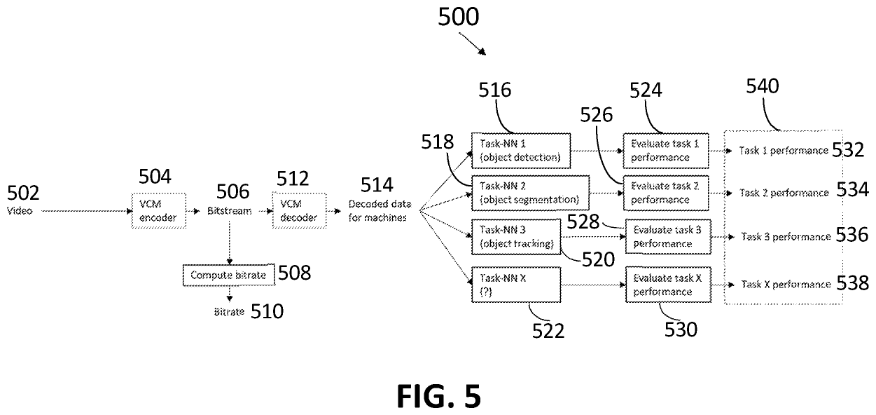

FIG. 5 is a general illustration of the pipeline 500 of Video Coding for Machines. A VCM encoder 504 encodes the input video 502 into a bitstream 506. A bitrate 510 may be computed 508 from the bitstream 506 in order to evaluate the size of the bitstream 506. A VCM decoder 512 decodes the bitstream output 506 by the VCM encoder 504. The output 514 of the VCM decoder 512 is referred in FIG. 5 as “Decoded data for machines”. This data 514 may be considered as the decoded or reconstructed video. However, in some implementations of this pipeline 500, this data 514 may not have the same or similar characteristics as the original video 502 which was input to the VCM encoder 504. For example, this data 514 may not be easily understandable by a human by simply rendering the data onto a screen. The output 514 of VCM decoder 512 is then input to one or more task neural networks (516, 518, 520, 522). In FIG. 5, for the sake of illustrating that there may be any number of task-NNs, there are three example task-NNs, namely a task-NN 516 for object detection, a task-NN 518 for object segmentation, a task-NN 3 for object tracking, and a non-specified one (Task-NN X 522). The goal of VCM is to obtain a low bitrate while guaranteeing that the task-NNs (516, 518, 520, 522) still perform well in terms of the evaluation metric associated to each task.

As shown in FIG. 5, a performance (532) of the first task (e.g. object detection) is evaluated (524) and, a performance (534) of the second task (e.g. object segmentation) is evaluated (526), a performance (536) of the third task (e.g. object tracking) is evaluated (528), and a performance (538) of the unspecified task is evaluated (530). The evaluated performances (532, 534, 536, 538) are collectively given as 540.

When a conventional video encoder, such as a H.266/VVC encoder, is used as a VCM encoder, one or more of the following approaches may be used to adapt the encoding to be suitable to machine analysis tasks (1-4 as follows):
1. One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:

The quantization parameter (QP) may be adjusted spatially in a manner that ROIs are encoded using finer quantization step size(s) than other regions. For example, QP may be adjusted CTU-wise.

The video is preprocessed to contain only the ROIs, while the other areas are replaced by one or more constant values or removed.

A grid is formed in a manner that a single grid cell covers a ROI. Grid rows or grid columns that contain no ROIs are downsampled as preprocessing to encoding.
2. Quantization parameter of the highest temporal sublayer(s) is increased (i.e. coarser quantization is used) when compared to practices for human watchable video.
3. The original video is temporally downsampled as preprocessing prior to encoding. A frame rate upsampling method may be used as postprocessing subsequent to decoding, if machine analysis at the original frame rate is desired.
4. A filter is used to preprocess the input to the conventional encoder. The filter may be a machine learning based filter, such as a convolutional neural network.

The examples described herein provide solutions to at least the following problems: 1. How can a receiver evaluate whether to use one or more post-processing filters, based on one or more criteria?, and 2. How can a receiver be informed about how to use two or more post-processing filters for the same picture or for the same picture unit?

The examples described herein provide mechanisms for signalling information, from an encoder to a decoder, about a group of one or more post-processing filters, such as neural network based post-processing filters, and/or other post-processing operations. In the following, even though the term post-processing filter is used in embodiments, it is to be understood that the embodiments generally apply to any post-processing operation. The signalled information may be signalled in-band or out-of-band, with respect to the encoded content (such as an encoded video).

The one or more post-processing filters comprised in the group of one or more post-processing filters (to which the signalled information applies) may be indicated in several possible ways.

In one embodiment, the signalled information is part of a nesting SEI message, e.g., an SEI message that comprises one or more other SEI messages. The other SEI messages may comprise, among other, one or more NNPFC SEI messages (as specified in H.266/VVC and VSEI standard specifications) which describe characteristics of post-processing filters comprised in the group of one or more post-processing filters.

In another embodiment, the signalled information is part of a (non-nesting) SEI message. The signalled information may comprise one or more filter identifiers (or filter IDs), that identify the post-processing filters comprised in the group of one or more post-processing filters.

In one embodiment, the signalled information may comprise indicating how two or more post-processing filters comprised in the group of one or more post-processing filters are to be used.

In one embodiment, the signalled information may comprise indicating that the two or more post-processing filters are to be used in cascade, for at least one picture of the video sequence. Furthermore, in an additional embodiment, the signalled information may comprise an order for the two or more post-processing filters to be used in cascade.

In one embodiment, the signalled information may comprise indicating that two or more post-processing filters in a group are alternatives, for at least one picture of the video sequence. It is up to the receiver to choose among those, for example based on criteria such as complexity and availability of resources.

In one embodiment, the signalled information may comprise indicating that at least one of the inputs to two or more post-processing filters in the group comprises the same data or substantially the same data, for at least one picture of the video sequence.

In one embodiment, the signalled information may comprise indicating that the two or more post-processing filters take the same data as input, and that their outputs are to be combined based at least on a combination operation, for at least one picture of the video sequence. In one embodiment, the signalled information may comprise an indication of the combination operation. In one embodiment, the combination operation may be performed based at least on one or more coefficients. In one embodiment, the one or more coefficients are predetermined. In another embodiment, the signalled information may comprise the one or more coefficients that may be used for performing the combination operation.

In one embodiment, the signalled information may comprise indicating that the two or more post-processing filters take the same data as input, and that their outputs may be used separately for different purposes or goals, for at least one picture of the video sequence.

In one embodiment, the signalled information comprises one or more sets of expected gains associated to respective one or more post-processing filters in the group of post-processing filters, or comprises one set of expected gains associated to all the postfilters in the group of postfilters, for the case where a purpose of the one or more post-processing filters or all the postfilters, respectively, is visual enhancement, or enhancement of machine analysis task(s), or any other purpose where the goal is to obtain a gain in terms of one or more metrics. Such an expected gain may have been determined during or after a development stage of the postfilter, based at least on a performance of the postfilter on a validation dataset. In the set of expected gains associated to a certain postfilter or to the postfilters in a certain group of postfilters, there may be one or more expected gains associated to that postfilter or to the postfilters in that group of postfilters, where different expected gains may be expressed in terms of different metrics.

In one embodiment, the signalled information comprises one or more sets of actual gains associated to respective one or more post-processing filters in the group of post-processing filters, or comprises one set of actual gains associated to all the postfilters in the group of postfilters, for the case where a purpose of the one or more post-processing filters or all the postfilters, respectively, is visual enhancement, or enhancement of machine analysis task(s), or any other purpose where the goal is to obtain a gain in terms of one or more metrics. In the set of actual gains associated to a certain postfilter or to the postfilters in a certain group of postfilters, there may be one or more actual gains associated to that postfilter or to the postfilters in that group of postfilters, where different actual gains may be expressed in terms of different metrics.

In one embodiment, the signalled information may comprise one or more filter identifiers (filter IDs) that identify respective one or more post-processing filters with the same purpose, where only one of the identified one or more post-processing filters is used or activated for any input picture. The signalled information may indicate or may be considered to imply for a decoder that either all of the identified one or more post-processing filters are intended to be applied as activated or none of them are intended to be applied. In an additional embodiment, the signalled information may comprise an indication that a portion of the properties of the identified one or more post-processing filters are shared (i.e., in common) for all of them.

The examples described herein include mechanisms for signalling information, from an encoder to a decoder, about a group of one or more post-processing filters, such as neural network based post-processing filters, and/or other post-processing operations. In the following, even though the term post-processing filter (or, for short, postfilter or filter) is used in embodiments, it is to be understood that the embodiments generally apply to any post-processing operation. The signalled information may be signalled in-band or out-of-band, with respect to the encoded content (such as an encoded video). Even though most embodiments and examples are described in terms of signalling the information in SEI messages (for example, in a “postfilter group SEI message” (PFG SEI message)) for convenience, other means to carry the signalled information may be possible.

There may be one or more groups, where each group may comprise one or more post-processing filters. In the following, for the sake of simplicity, embodiments are described with reference to one group.

Two or more groups may comprise or refer to the same set of postfilters, or may comprise or refer to respective two or more disjoints sets of postfilters, or may comprise or refer to respective two or more overlapping (i.e., joint) sets of postfilters.

In at least some of the syntax tables in this document: any byte alignment related syntax may have been ignored for the sake of simplicity.

### Indicating the Postfilters Belonging to a Group

The one or more post-processing filters comprised in a group of one or more post-processing filters (to which the signalled information applies) may be indicated in different possible ways. In the following, several embodiments describe possible ways for indicating which postfilters belong to a group.

In one embodiment, the signalled information is part of a nesting SEI message, e.g., an SEI message that comprises one or more other SEI messages. The one or more other SEI messages may comprise one or more SEI messages that describe or comprise information about respective one or more postfilters that belong to the group represented by this nesting SEI message. In one example, the one or more other SEI messages may comprise, among others, one or more NNPFC SEI messages (as specified in H.266/VVC and VSEI standard specifications) which describe characteristics of respective one or more post-processing filters comprised in the group of one or more post-processing filters.

In one example, the nesting SEI message comprises the following: an identifier for the group of postfilters, a syntax element indicative of the count of nested NNPFC SEI messages, a first NNPFC SEI message, describing characteristics of a first post-processing filter, a second NNPFC SEI message, describing characteristics of a second post-processing filter, a gain SEI message (or, alternatively, just gain information, represented by one or more syntax elements), and other syntax elements, according to some of the embodiments, such as information about the order of filters, etc. This example may be represented, in terms of syntax, as follows:

| | Descriptor |
|---|---|
| postfilter_group( payloadSize ) { | |
| pfg_id | ue(v) |
| pfg_num_filters_minus2 | ue(v) |
| for( i = 0; i <= pfg_num_filters_minus2 + 1; i++ ) | |
| nn_post_filter_characteristics( ) | |
| nnpf_gain_sei_message( ) | |
| nnpf_order( ) | |
| } | |

Where pfg_id is an identifier for the group of filters defined by this SEI message, pfg_num_filters_minus2+2 indicates the number of NNPFC SEI messages present in the nesting SEI message postfilter_group( ), nn_post_filter_characteristics( ) indicates an NNPFC SEI message, nnpf_gain_sei_message( ) indicates a gain SEI message, nnpf_order( ) indicates a syntax structure indicating information about the order of the filters whose characteristics are indicated in the nn_post_filter_characteristics( ) SEI messages when they are used in cascade. It is to be understood that instead of pfg_num_filters_minus2, any other syntax element indicative of the count of the nested NNPFC SEI messages could be used in the syntax structure. For example, pfg_num_filters_minus2 could be replaced by pfg_num_filters_minus1, which indicates the number of NNPFC SEI messages present in the nesting SEI message minus 1. It may be allowed nnpf_order( ) to be absent, in which case a default order of cascading filters, such as the order that they are listed in the for loop, may be used. In one example, the nnpf_order( ) syntax structure may comprise pfg_order[i] syntax elements for each value of i in the range of 0 to pfg_num_filters_minus2+1, inclusive, where examples of specifying the semantics of pfg_order[i] are provided subsequently.

In another example, the nesting SEI message comprises the following: a first NNPFA SEI message activating a first post-processing filter, a second NNPFA SEI message activating a second post-processing filter, a gain SEI message (or, alternatively, just gain information, represented by one or more syntax elements), and other syntax elements, according to some of the embodiments described herein, such as information about the order of filters, etc. This example may be represented, in terms of syntax, as follows:

| | Descriptor |
|---|---|
| postfilter_group_activation( payloadSize ) { | |
| pfg_num_filters_minus2 | ue(v) |
| for( i = 0; i <= pfg_num_filters_minus2 + 1; i++ ) | |
| nn_post_filter_activation( ) | |
| nnpf_gain_sei_message( ) | |
| nnpf_order( ) | |
| } | |

Where nn_post_filter_activation( ) indicates an NNPFA SEI message. Other syntax elements and structures are like in the example above.

In an additional embodiment, where the nesting SEI message comprises one or more NNPFA SEI messages, the persistence scope of the group of postfilters is equal to the shortest persistence scope among the persistence scopes of all the one or more NNPFs activated by the respective one or more NNPFA SEI messages. In an alternative additional embodiment, where the nesting SEI message comprises one or more NNPFA SEI messages, the persistence scope of the group of postfilters is equal to the longest persistence scope among the persistence scopes of all the one or more NNPFs activated by the respective one or more NNPFA SEI messages. In a yet alternative additional embodiment, where the nesting SEI message comprises one or more NNPFA SEI messages, the persistence scopes of all the NNPFs in the group of postfilters are required to be the same or substantially the same.

In another embodiment, the signalled information is part of a (non-nesting) SEI message. The signalled information may comprise one or more filter identifiers (or filter IDs) that identify respective one or more post-processing filters comprised in the group of one or more post-processing filters, to which other information comprised in the signalled information applies.

In one example, the SEI message comprises the following: one or more filter IDs, other syntax elements, according to some of the embodiments described herein, such as an identifier for the filter group, information about the gain brought by the one or more postfilters indicated by the one or more filter IDs, information about the order of filters, etc. This example may be represented, in terms of syntax, as follows:

| | Descriptor |
|---|---|
| postfilter_group( payloadSize ) { | |
| pfg_id | ue(v) |
| pfg_num_filters_minus2 | ue(v) |
| for( i = 0; i <= pfg_num_filters_minus2 + 1; i++ ) { | |
| pfg_filter_id[ i ] | ue(v) |
| pfg_gain[ i ] | ue(v) |
| pfg_order[ i ] | ue(v) |
| } | |
| } | |

Where pfg_id is an identifier for the group of filters defined by this SEI message, pfg_num_filters_minus2+2 indicates the number of postfilters in the group of postfilters that this SEI message refers to, pfg_filter_id[i] indicates an identifier that identifies an i-th filter whose characteristics are indicated by an NNPFC SEI message (where the identifier is to be matched to nnpfc_id in the NNPFC SEI message), pfg_gain[i] indicates a gain that is brought by the i-th postfilter identified by pfg_filter_id[i], pfg_order[i] indicates an order for the i-th postfilter identified by pfg_filter_id[i].

In another embodiment, a new mode indicator value is defined for the NNPFC SEI message, which is used to refer to a filter group through a filter group identifier. A filter group may be specified with any other embodiment, for example with a post-filter group SEI message. Syntax elements or groups of syntax elements that are present for the NNPFC SEI message may be used to indicate the properties for the filter group. For example, syntax elements related to complexity may be used to indicate the total complexity of the filter group. The filter group may be activated by an NNPFA SEI message with the nnpfa_target_id value equal to the nnpfc_id value of the NNPFC SEI message defining the filter group. In one example, the following syntax of the NNPFC SEI message may be used:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| if( nnpfc_mode_idc = = 2 ) | |
| nnpfc_group_id | ue(v) |
| . . . | |

Where nnpfc_group_id indicates that this SEI message refers to the filter group defined in the post-filter group SEI message with pfg_id equal to nnpfc_group_id, and the syntax elements and derived variables defined in this SEI message apply to the referenced filter group.

In another embodiment, a new mode indicator value is defined for the NNPFC SEI message, which is used to define a filter group. Syntax elements or groups of syntax elements that are present for the NNPFC SEI message may be used to indicate the properties for the filter group. For example, syntax elements related to complexity may be used to indicate the total complexity of the filter group. The filter group may be activated by an NNPFA SEI message with the nnpfa_target_id value equal to the nnpfc_id value of the NNPFC SEI message defining the filter group. In one example, the following syntax of the NNPFC SEI message may be used:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| if( nnpfc_mode_idc = = 2 ) { | |
| nnpfc_pfg_num_filters_minus2 | ue(v) |
| for( i = 0; i <= nnpfc_pfg_num_filters_minus2 + 1; i++ ) | |
| nnpfc_pfg_filter_id[ i ] | ue(v) |
| } | |
| . . . | |

Where nnpfc_pfg_num_filters_minus2+2 indicates the number of postfilters in the group of postfilters that this SEI message refers to, nnpfc_pfg_filter_id[i] indicates an identifier that identifies an i-th filter in this filter group whose nnpfc_id is equal to nnpfc_pfg_filter_id[i]. The postfilter with nnpfc_id equal to nnpfc_pfg_filter_id[i] is defined by one or more other NNPFC SEI messages.

Related to the above embodiments where the NNPFC SEI message is modified to have a new mode indicator value for defining or referring to a filter group, it is remarked that certain syntax elements, according to some of the embodiments, such as information about the order of filters and/or the gain that is brought by the filter group may be included in the NNPFC SEI message.

Related to the above embodiments where the NNPFC SEI message is modified to have a new mode indicator value for defining or referring to a filter group, it is remarked that certain syntax elements, such as those related to input tensor generation or output tensor interpretation, may be excluded from the NNPFC SEI message under the condition that the new mode is in use. The input tensor generation for the filter group is available in the NNPFC SEI message for the first filter in execution order, and the output tensor interpretation for the filter group is available in the NNPFC SEI message for the last filter in execution order. In one example, the following syntax of the NNPFC SEI message may be used where the input and output formatting related syntax elements are present when the nnpfc_mode_idc is equal to 0 or 1 but not present for the new mode indicator value:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| if( nnpfc_mode_idc = = 2 ) { | |
| nnpfc_pfg_num_filters_minus2 | ue(v) |
| for( i= 0; i <= nnpfc_pfg_num_filters_minus2 + 1; i++ ) | |
| nnpfc_pfg_filter_id[ i ] | ue(v) |
| } | |
| nnpfc_property_present_flag | u(1) |
| if( nnpfc_property_present_flag ) { | |
| nnpfc_base_flag | u(1) |
| if( nnpfc_mode_idc = = 0 \|\| nnpfc_mode_idc = = 1 ) { | |
| /* input and output formatting */ | |
| nnpfc_num_input_pics_minus1 | ue(v) |
| . . . | |
| } | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| } | |
| . . . | |

In another embodiment, new mode indicator value(s) are defined for the NNPFC SEI message, which are used to indicate that the input picture(s) to the post-filter are output picture(s) resulting from an indicated post-filter. The filter group may be activated by an NNPFA SEI message with the nnpfa_target_id value equal to the nnpfc_id value of the NNPFC SEI message of the last post-filter in the processing order. The NNPFC SEI messages that are linked with each other form a filter group. In one example, the following syntax of the NNPFC SEI message may be used:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 2 \|\| nnpfc_mode_idc = = 3 ) { | |
| nnpfc_num_source_filters_minus1 | ue(v) |
| for( i = 0; i <= nnpfc_num_source_filters_minus1; i++ ) | |
| nnpfc_source_filter_id[ i ] | ue(v) |
| } | |
| if( nnpfc_mode_idc = = 1 \|\| nnpfc_mode_idc = = 3 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| . . . | |
| /* ISO/IEC 15938-17 bitstream */ | |
| if( nnpfc_mode_idc = = 0 \|\| nnpfc_mode_idc = = 2 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

Where nnpfc_mode_idc equal to 2 and 3 have the semantics of nnpfc_mode_idc equal to 0 and 1, respectively, and additionally indicate that this SEI message specifies an NNPF for which the input picture results from the NNPFs indicated by nnpfc_source_filter_id[i] values. nnpfc_num_source_filters_minus1+1 indicates the count of the NNPFs from which input picture(s) to the NNPF defined by this NNPFC SEI message are obtained. nnpfc_source_filter_id[i] indicates the nnpfc_id value of the i-th NNPF used to obtain input picture(s) to the NNPF defined by this NNPFC SEI message.

### Indicating how to Use the Filters in a Group

In one embodiment, the signalled information may comprise indicating how two or more post-processing filters comprised in the group of one or more post-processing filters are to be used.

### Cascaded Filters

In one embodiment, the signalled information may comprise indicating that the two or more post-processing filters are to be used in cascade, for at least one picture of the video sequence. Furthermore, in an additional embodiment, the signalled information may comprise an order for the two or more post-processing filters to be used in cascade.

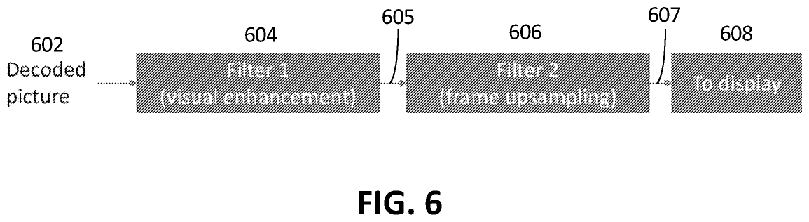

FIG. 6 shows an illustrative example, where two postfilters “Filter 1” (604) and “Filter 2” (606) are to be used in cascade, where “Filter 1” (604) performs visual enhancement and “Filter 2” (606) performs frame upsampling (for example, as specified by the respective NNPFC SEI messages that describe the characteristics of the two filters, including their purpose). The “Decoded picture” 602 refers to a cropped decoded picture that is output by a video decoder. The cropped decoded picture 602 represents one of the inputs to the “Filter 1” (604). At least one of the outputs (605) of “Filter 1” (604) represents an input (605) to “Filter 2” (606). At least one of the outputs 607 of “Filter 2” (606) represents the final output 607 of the postprocessing stage and may be used for displaying 608.

The following is an example syntax table for signalling information for this embodiment:

| postfilter_group( payloadSize ) { | Descriptor |
|---|---|
| pfg_num_filters_minus2 | ue(v) |
| pfg_cascade_flag | u(1) |
| for( i = 0; i <= pfg_num_filters_minus2 + 1; i++ ) { | |
| pfg_filter_id[ i ] | ue(v) |
| if(pfg_cascade_flag) | |
| pfg_order[ i ] | ue(v) |
| } | |
| . . . | |
| } | |

Where pfg_cascade_flag indicates whether the filters identified by pfg_filter_id are to be used in cascade for at least one picture of the video sequence, pfg_order[i] indicates the order of the i-th filter identified by pfg_filter_id[i]. For example, the order may be indicated as an integer number, where 0 represents the first position in the cascaded filter chain, 1 represents the second position, etc.

In another example syntax table, the postfilters that are to be used in cascade may be a subset with respect to the postfilters belonging to the group of postfilters that this SEI message refers to, as follows:

| postfilter_group( payloadSize ) { | Descriptor |
|---|---|
| pfg_num_filters_minus2 | ue(v) |
| for( i = 0; i <= pfg_num_filters_minus2 + 1; i++ ) { | |
| pfg_filter_id[ i ] | ue(v) |
| pfg_cascade_flag[ i ] | u(1) |
| if(pfg_cascade_flag[ i ]) | |
| pfg_order[ i ] | ue(v) |
| } | |
| . . . | |
| } | |

Where pfg_cascade_flag[i] indicates whether the filter identified by pfg_filter_id[i] is to be used in cascade for at least one picture of the video sequence.

This last example may be useful, for example, when information that is common to a group of postfilters is to be signalled, while only a subset of those postfilters will be used in cascade for at least one picture of the video sequence.

In an alternative embodiment, there may not be a flag indicating that the postfilters in the group of postfilters are to be used in cascade. Instead, the order indication for a certain postfilter (e.g., as indicating by pfg_order[i]) would implicitly comprise the information that the corresponding postfilter is to be used in cascade. For example, if the values of pfg_order[m] and pfg_order[n] are different and pfg_order[m] is greater than pfg_order[n], then the m-th filter is to be used before the n-th filter, and at least one of the inputs to the n-th filter is at least one of the outputs of the m-th filter.

In an embodiment, an activation SEI message may be used to indicate that, for a certain picture, two or more postfilters are to be used. The way that the multiple postfilters are to be used (e.g., in cascade) and the order of the postfilters in the cascade are as indicated by the postfilter group SEI message. The following is an example of an SEI message for activating multiple postfilters for a certain picture.

| nn_multi_post_filter_activation( payloadSize ) { | Descriptor |
|---|---|
| nnmpfa_num_filters_minus1 | ue(v) |
| for( i = 0; i <= nnmpfa_num_filters_minus1; i++ ) | |
| nnmpfa_target_id[ i ] | ue(v) |
| nnmpfa_cancel_flag | u(1) |
| if( !nnmpfa_cancel_flag ) { | |
| nnmpfa_persistence_flag | u(1) |
| . . . | |
| } | |

Where nnmpfa_num_filters_minus1 plus 1 indicates the number of postfilters that are activated for the current picture, nnmpfa_target_id[i] identifies the i-th postfilter that is part of a group of postfilters as indicated in a postfilter group SEI message (for example by pfg_filter_id[i]), nnmpfa_cancel_flag indicates whether this SEI message cancels the persistence of the multiple postfilters identified by nnmpfa_target_id, nnmpfa_persistence_flag indicates the persistence of the multiple postfilters identified by nnmpfa_target_id.

In an embodiment, an activation SEI message may be used to indicate that, for a certain picture, the NNPF activated by this SEI message follows in cascaded processing order the one or more NNPFs indicated in this SEI message.

The following is an example of an SEI message for activating a postfilter that follows in cascaded processing order the NNPF indicated in this SEI message.

| nn_cascaded_post_filter_activation( payloadSize ) { | Descriptor |
|---|---|
| nncpfa_target_id | ue(v) |
| nncpfa_cancel_flag | u(1) |
| if( !nncpfa_cancel_flag ) { | |
| nncpfa_persistence_flag | u(1) |
| nncpfa_source_id | ue(v) |
| . . . | |
| } | |

Where nncpfa_target_id identifies that the postfilter with nnpfc_id equal to nncpfa_target_id is activated by this SEI message, nncpfa_source_id identifies the postfilter that precedes the postfilter activated by this SEI message in cascaded processing order, nncpfa_cancel_flag indicates whether this SEI message cancels the persistence of the postfilter identified by nncpfa_target_id, nncpfa_persistence_flag indicates the persistence of the postfilter identified by nncpfa_target_id. The output tensors of the postfilter identified by the nncpfa_source_id may be used to derive an input tensor for the postfilter identified by nncpfa_target_id.

The following is an example of an SEI message for activating a postfilter that follows in cascaded processing order the one or more NNPFs indicated in this SEI message.

| nn_cascaded_post_filter_activation( payloadSize ) { | Descriptor |
|---|---|
| nncpfa_target_id | ue(v) |
| nncpfa_cancel_flag | u(1) |
| if( !nncpfa_cancel_flag ) { | |
| nncpfa_persistence_flag | u(1) |
| nncpfa_num_filters_minus1 | ue(v) |
| for( i = 0; i <= nncpfa_num_filters_minus1; i++ ) | |
| nncpfa_source_id[ i ] | ue(v) |
| . . . | |
| } | |

Where nncpfa_target_id identifies that the postfilter with nnpfc_id equal to nncpfa_target_id is activated by this SEI message, nncpfa_num_filters_minus1 plus 1 indicates the number of postfilters that precede the postfilter activated by this SEI message in cascaded processing order, nncpfa_source_id[i] identifies the i-th postfilter that precedes the postfilter activated by this SEI message in cascaded processing order, nncpfa_cancel_flag indicates whether this SEI message cancels the persistence of the postfilters identified by nncpfa_target_id, nncpfa_persistence_flag indicates the persistence of the postfilter identified by nncpfa_target_id. The output tensors of one or more of the postfilters identified by the nncpfa_source_id[i] values may be used to derive an input tensor for the postfilter identified by nncpfa_target_id.

### Alternative Filters

In one embodiment, the signalled information may comprise indicating that two or more post-processing filters in a group are alternatives, for at least one picture of the video sequence. It is up to the receiver to choose among those, for example based on criteria such as complexity and availability of resources.

In one embodiment, the two or more postfilters are different with respect to at least one aspect or characteristic, such as complexity, gain, spatial and/or temporal upsampling factor, use of one or more auxiliary inputs, etc.

A typical use case is where the two or more postfilters have the same purpose, e.g., they perform the same or substantially the same task, for example both filters perform visual enhancement, or both filters perform frame-rate upsampling, etc.

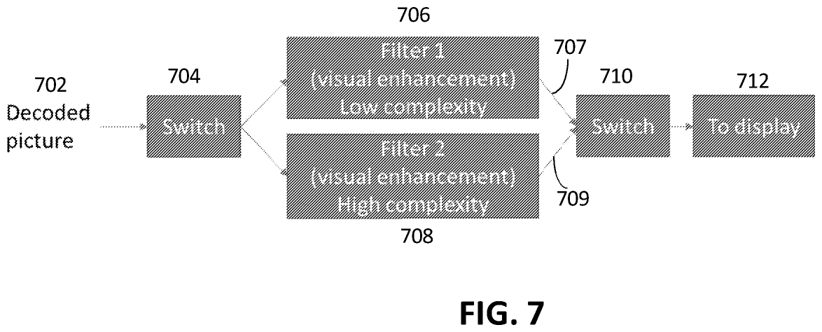

FIG. 7 an illustrative example, where two postfilters “Filter 1” (706) and “Filter 2” (708) are to be used as alternative filters, where both “Filter 1” (706) and “Filter 2” (708) perform visual enhancement (for example, as specified by the respective NNPFC SEI messages that describe the characteristics of the two filters, including their purpose). “Filter 1” (706) and “Filter 2” (708) have different complexity (for example, as specified by the respective NNPFC SEI messages that describe the characteristics of the two filters). “Decoded picture” (702) refers to a cropped decoded picture that is output by a video decoder. The cropped decoded picture 702 represents one of the inputs to the “Filter 1” (706) and “Filter 2” (708). “Switch” (704, 710) refers to an operation that may not be actually present in the post-processing stage, but that represents the choice between one of the two filters (706, 708) for a certain picture, i.e., only one filter is activated for a certain picture. In this example, for a certain picture for which one of these two filters (706, 708) may be activated, a receiver chooses (e.g. using switch 710) which of the two filters (706, 708) to actually use, based at least on the complexity of those two filters. The output 707 of filter 706 or the output 709 of filter 708 is used for display 712. In general, a receiver may choose based on one or more of the following aspects (1-10 as follows):
1. Complexity in terms of number of parameters of the postfilters.
2. Complexity in terms of type of parameters of the postfilters.
3. Complexity in terms of number of Multiply-Accumulate (MAC) operations per sample of the postfilters.
4. Complexity in terms of size required to store the uncompressed parameters of the postfilters.
5. Complexity in terms of size required to run or execute the postfilters, which may account for storing both the parameters and any intermediate and final outputs of the postfilters, into temporary memory such as a GPU RAM memory or CPU RAM memory. The required size of the input to the postfilters may influence the size required to run or execute the postfilters.
6. Available and/or predicted storage space (where predicted refers to the predicted storage space for the time when the postfilter will be used).
7. Available and/or predicted computational capability (e.g., in terms of supported number of MAC operations per sample).
8. Available and/or predicted temporary memory, such as GPU RAM memory and CPU RAM memory.
9. Available and/or predicted electrical power.
10. Gain provided by the postfilters, with respect to one or more quality metrics.

The following is an example syntax table:

| postfilter_group( payloadSize ) { | Descriptor |
|---|---|
| pfg_num_filters_minus2 | ue(v) |
| pfg_alternative_filters_flag | u(1) |
| for( i = 0; i <= pfg_num_filters_minus2 + 1; i++ ) | |
| pfg_filter_id[ i ] | ue(v) |
| . . . | |
| } | |

Where pfg_alternative_filters_flag indicates whether the filters identified by pfg_filter_id are alternative filters and thus a receiver can choose which filters to use.

In another example syntax table, the alternative postfilters may be a subset with respect to the postfilters belonging to the group of postfilters that this SEI message refers to, as follows:

| postfilter_group( payloadSize ) { | Descriptor |
|---|---|
| pfg_num_filters_minus2 | ue(v) |
| for( i = 0; i <= pfg_num_filters_minus2 + 1; i++ ) { | |
| pfg_filter_id[ i ] | ue(v) |
| pfg_alternative_filters_flag[ i ] | u(1) |
| } | |
| . . . | |
| } | |

This last example may be useful, for example, when information that is common to a group of postfilters is to be signalled, while only a subset of those postfilters are alternative filters for at least one picture of the video sequence.

In another example syntax table, the indication of the alternative filters is included in the NNPFC SEI message, for example as follows:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 2 \|\| nnpfc_mode_idc = = 3 ) { | |
| nnpfc_num_source_filters_minus1 | ue(v) |
| if( nnpfc_num_source_filters_minus1 > 0 ) | |
| nnpfc_alternative_filters_flag | u(1) |
| for( i = 0; i <= nnpfc_num_source_filters_minus1; i++ ) | |
| nnpfc_source_filter_id[ i ] | ue(v) |
| } | |
| . . . | |

Where nnpfc_alternative_filters_flag equal to 1 indicates that the filters identified by nnpfc_source_filter_id[i] are alternative filters, and the output picture(s) of any one of these alternative filters may be used as the input picture(s) for the NNPF defined by this NNPFC SEI message. In an additional embodiment, nnpfc_alternative_filters_flag equal to 0 indicates that the filters identified by nnpfc_source_filter_id[i] are a group of filters, and the output pictures of all the filters in the group of filters are used as the input pictures for the NNPF defined by this NNPFC SEI message.

In an alternative embodiment, there may not be a flag indicating that the postfilters in the group of postfilters are to be used as alternative filters. Instead, an order indication may be signaled (e.g., by using a syntax element pfg_order[i] for each i-th filter), where the order indication for a certain postfilter (e.g., as indicating by pfg_order[i]) would implicitly comprise the information that the corresponding postfilter is to be used as alternative filter. For example, if the values of pfg_order[m] and pfg_order[n] are same, then the m-th filter and the n-th filter are to be used as alternative filters.

In an embodiment, an activation SEI message may be used to indicate that, for a certain picture, two or more postfilters are available. The way that the multiple postfilters are to be used (e.g., as alternative filters) is as indicated by the postfilter group SEI message. The following is an example of an activation SEI message that considers multiple postfilters for a certain picture.

| nn_multi_post_filter_activation( payloadSize ) { | Descriptor |
|---|---|
| nnmpfa_num_filters_minus1 | ue(v) |
| for( i = 0; i <= nnmpfa_num_filters_minus1; i++ ) | |
| nnmpfa_target_id[ i ] | ue(v) |
| nnmpfa_cancel_flag | u(1) |
| if( !nnmpfa_cancel_flag ) { | |
| nnmpfa_persistence_flag | u(1) |
| . . . | |
| } | |

Where nnmpfa_num_filters_minus1 plus 1 indicates the number of postfilters that are alternatives to be activated for the current picture, nnmpfa_target_id[i] identifies the i-th postfilter that is part of a group of postfilters as indicated in a postfilter group SEI message, nnmpfa_cancel_flag indicates whether this SEI message cancels the persistence of the multiple postfilters identified by nnmpfa_target_id, nnmpfa_persistence_flag indicates the persistence of the multiple postfilters identified by nnmpfa_target_id.

In an embodiment, when two or more postfilters are indicated to be used as alternative filters, the signalled information may comprise an indication of one or more main differences among the two or more postfilters. In one example, the main difference between two postfilters that are indicated to be used as alternative filters is the complexity of the two postfilters. In another example, the main difference between two postfilters that are indicated to be used as alternative filters is that one postfilter may improve subjective visual quality and another postfilter may improve objective visual quality. In yet another example, the main differences between two postfilters that are indicated to be used as alternative filters is their complexity and the expected or actual gain that they may provide. In yet another example, the main difference between two postfilters that are indicated to be used as alternative filters is that one postfilter takes data derived from a quantization parameter as an auxiliary input, and another postfilter does not take data derived from a quantization parameter as an auxiliary input.

### Parallel Filters

In one embodiment, the signalled information may comprise indicating that at least one of the inputs to two or more post-processing filters in the group comprises the same data or substantially the same data, for at least one picture of the video sequence.

Such two or more postfilters may be referred to as parallel filters in this embodiment and related embodiments, or as filters that are run or executed in parallel. However, it is to be understood that such two or more postfilters may be run or executed in any temporal order, either simultaneously (at same time) or sequentially (different times) or at overlapping times. Another possible term for filters for which at least part of their input is same or substantially same may be forking filters.

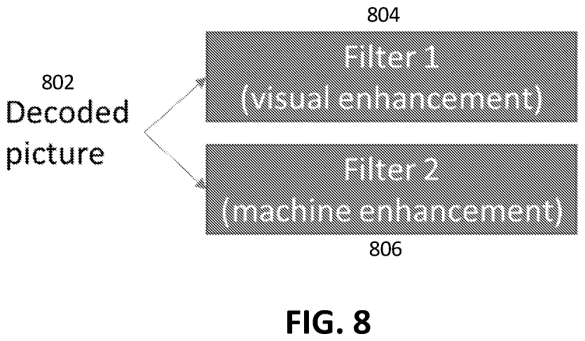

FIG. 8 is an illustrative example, where two filters “Filter 1” (804) and “Filter 2” (806) are used in parallel, i.e., they take in the same input data, which is the cropped decoded picture 802 that is output by a video decoder.

Parallel Filters with Combination

In one embodiment, the signalled information may comprise indicating that the two or more post-processing filters take the same data as input, and that their outputs are to be combined based at least on a combination operation, for at least one picture of the video sequence. In one embodiment, the signalled information may comprise an indication of the combination operation. In one embodiment, the combination operation may be performed based at least on one or more coefficients. In one embodiment, the one or more coefficients are predetermined. In another embodiment, the signalled information may comprise the one or more coefficients that may be used for performing the combination operation.

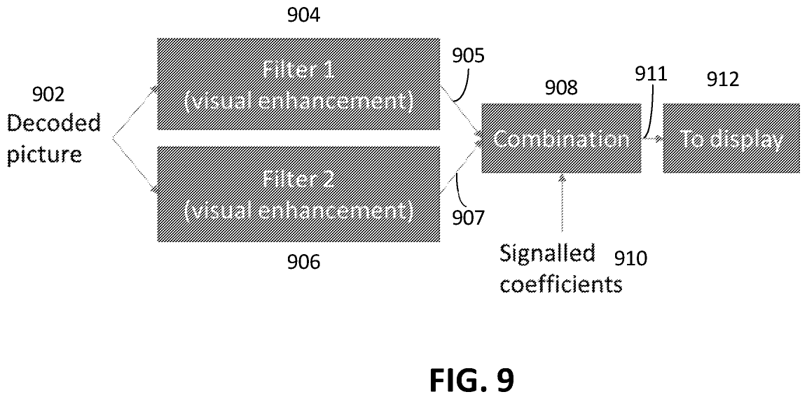

FIG. 9 is an illustrative example of this embodiment. “Filter 1” (904) and “Filter 2” (906) are two postfilters for the purpose of visual enhancement (for example, as specified by the respective NNPFC SEI messages that describe the characteristics of the two filters). One of the inputs to the two postfilters is a cropped decoded picture denoted as “Decoded picture” 902. The two outputs of the two postfilters, namely output 905 of filter 904 and output 907 of filter 906, are combined by the “Combination” block (908), based on one or more coefficients denoted as “Signalled coefficients” 910. The output 911 of the combination operation 908 is the final output 911 of the post-processing stage and may be used for displaying 912. The combination operation 908 may be a linear combination where the one or more coefficients 910 are used to weight the contribution of the output (905, 907) of each of the two postfilters (904, 906). The one or more coefficients (910) are signalled from an encoder to a decoder, for example as part of the postfilter group SEI message.

The following is an example syntax table:

| postfilter_group( payloadSize ) { | Descriptor |
|---|---|
| pfg_num_filters_minus2 | ue(v) |
| pfg_parallel_filters_comb_flag | u(1) |
| for( i = 0; i <= pfg_num_filters_minus2 + 1; i++ ) | |
| pfg_filter_id[ i ] | ue(v) |
| . . . | |
| } | |

Where pfg_parallel_filters_comb_flag indicates whether the filters identified by pfg_filter_id are to be run in parallel (i.e., same input) and by combining their output.

In this example, the combination and any combination coefficients may be predefined in a standard specification (e.g., VSEI), such as a weighted average with equal weights for all the postfilters to be run in parallel.

The following is another example syntax table:

| postfilter_group( payloadSize ) { | Descriptor |
|---|---|
| pfg_num_filters_minus2 | ue(v) |
| pfg_parallel_filters_comb_flag | u(1) |
| if(pfg_parallel_filters_comb_flag) | |
| pfg_comb_mode_idc | ue(v) |
| for( i = 0; i <= pfg_num_filters_minus2 + 1; i++ ) { | |
| pfg_filter_id[ i ] | ue(v) |
| if(pfg_parallel_filters_comb_flag) | |
| pfg_comb_coeff[ i ] | ue(v) |
| } | |
| . . . | |
| } | |

Where pfg_parallel_filters_comb_flag indicates whether the filters identified by pfg_filter_id are to be run in parallel (i.e., same input) and by combining their output, pfg_comb_mode_idc indicates a combination operation (or combination mode), such as linear combination, pfg_comb_coeff[i] indicates combination coefficients to be used for combining the output of the i-th filter indicated by pfg_filter_id[i] by means of the combination operation indicated by pfg_comb_mode_idc.

In another example, an additional flag is used to indicate whether the combination coefficients are present in the signalled information, as follows:

| postfilter_group( payloadSize ) { | Descriptor |
|---|---|
| pfg_num_filters_minus2 | ue(v) |
| pfg_parallel_filters_comb_flag | u(1) |
| pfg_comb_coeff_present_flag | u(1) |
| if(pfg_parallel_filters_comb_flag) | |
| pfg_comb_mode_idc | ue(v) |
| for( i = 0; i <= pfg_num_filters_minus2 + 1; i++ ) { | |
| pfg_filter_id[ i ] | ue(v) |
| if(pfg_parallel_filters_comb_flag && | |
| pfg_comb_coeff_present_flag) | |
| pfg_comb_coeff[ i ] | ue(v) |
| } | |
| . . . | |
| } | |

Where pfg_parallel_filters_comb_flag indicates whether the filters identified by pfg_filter_id are to be run in parallel (i.e., same input) and by combining their output, pfg_comb_coeff_present_flag indicates whether the combination coefficients are present, pfg_comb_mode_idc indicates a combination operation (or combination mode), such as linear combination, pfg_comb_coeff[i] indicates combination coefficients to be used for combining the output of the i-th filter indicated by pfg_filter_id[i] by means of the combination operation indicated by pfg_comb_mode_idc.

In an alternative embodiment, there may not be a flag indicating that the postfilters in the group of postfilters are to be used in parallel. Instead, the order indication for a certain postfilter (e.g., as indicating by pfg_order[i]) would implicitly comprise the information that the corresponding postfilter is to be used in parallel. For example, if the values of pfg_order[m] and pfg_order[n] are same, then the m-th filter and the n-th filter are to be used in parallel.

In one embodiment, the one or more coefficients or an update to the one or more coefficients are signalled for one or more pictures to which the group of postfilters is to be applied, such as within an activation SEI message.

The following is an example syntax table for an activation SEI message for activating multiple postfilters for a certain picture, demonstrating this embodiment.

| nn_multi_post_filter_activation( payloadSize ) { | Descriptor |
|---|---|
| nnmpfa_num_filters_minus1 | ue(v) |
| for( i = 0; i <= nnmpfa_num_filters_minus1; i++ ) { | |
| nnmpfa_target_id[ i ] | ue(v) |
| } | |
| nnmpfa_cancel_flag | u(1) |
| if( !nnmpfa_cancel_flag ) { | |
| nnmpfa_persistence_flag | u(1) |
| nnmpfa_comb_coeff[ i ] | ue(v) |
| . . . | |
| } | |

Where nnmpfa_num_filters_minus1 plus 1 indicates the number of postfilters that are activated in parallel for the current picture, nnmpfa_target_id[i] identifies the i-th postfilter that is part of a group of postfilters as indicated in a postfilter group SEI message and that are to be run in parallel with combination of their output, nnmpfa_comb_coeff[i] indicates one or more combination coefficients to be used for combining the output of the i-th filter indicated by nnmpfa_target_id[i] by means of the combination operation indicated by pfg_comb_mode_idc in the postfilter group SEI message or by means of a default combination operation (e.g., as specified in a standard specification), nnmpfa_cancel_flag indicates whether this SEI message cancels the persistence of the multiple postfilters identified by nnmpfa_target_id, nnmpfa_persistence_flag indicates the persistence of the multiple postfilters identified by nnmpfa_target_id.

In another example embodiment for an activation SEI message syntax, a cascaded post-filter activation SEI message comprises the one or more coefficients for the combination as follows:

| nn_cascaded_post_filter_activation( payloadSize ) { | Descriptor |
|---|---|
| nncpfa_target_id | ue(v) |
| nncpfa_cancel_flag | u(1) |
| if( !nncpfa_cancel_flag ) { | |
| nncpfa_persistence_flag | u(1) |
| nncpfa_num_filters_minus1 | ue(v) |
| if( nncpfa_num_filters_minus1 > 0 ) | |
| nncpfa_comb_mode_idc | ue(v) |
| for( i = 0; i <= nncpfa_num_filters_minus1; i++ ) { | |
| nncpfa_source_id[ i ] | ue(v) |
| if( nncpfa_num_filters_minus1 > 0 ) | |
| nncpfa_comb_coeff[ i ] | ue(v) |
| } | |
| . . . | |
| } | |

Where nncpfa_comb_mode_idc indicates a combination operation (or combination mode), such as linear combination. nncpfa_comb_coeff[i] indicates combination coefficients to be used for combining the output of the i-th filter indicated by nncpfa_source_id[i] by means of the combination operation indicated by nncpfa_comb_mode_idc. The presence of nncpfa_comb_coeff[i] may be conditional on the combination mode, i.e., nncpfa_comb_mode_idc value.

Parallel Filters without Combination

In one embodiment, the signalled information may comprise indicating that the two or more post-processing filters take the same data as input, and that their outputs may be used separately for different purposes or goals, for at least one picture of the video sequence.

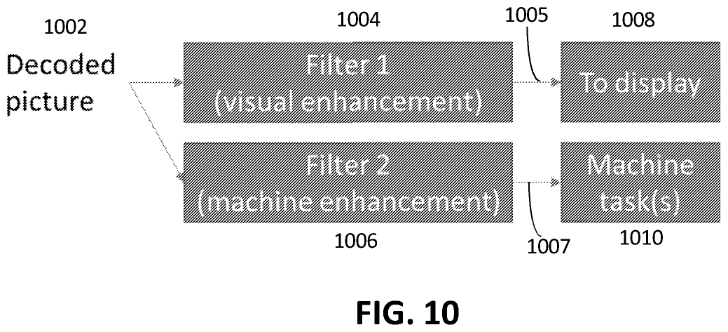

FIG. 10 illustrates an example of this embodiment, where a group of postfilters comprises two postfilters denoted as “Filter 1” (1004) and “Filter 2” (1006). “Filter 1” (1004) performs visual enhancement and “Filter 2” (1006) performs machine enhancement (i.e., enhancement of one or more machine analysis tasks), for example as specified by the respective NNPFC SEI messages that describe the characteristics of the two filters. The two postfilters (1004, 1006) take a cropped decoded picture denoted by “Decoded picture” 1002 as input. The output 1005 of “Filter 1” 1004 is used for displaying 1008 whereas the output 1007 of “Filter 2” 1006 is used as input to one or more machine analysis tasks 1010.

The following is an example syntax table for this embodiment:

| postfilter_group( payloadSize ) { | Descriptor |
|---|---|
| pfg_num_filters_minus2 | ue(v) |
| pfg_parallel_filters_nocomb_flag | u(1) |
| for( i = 0; i <= pfg_num_filters_minus2 + 1; i++ ) | |
| pfg_filter_id[ i ] | ue(v) |
| . . . | |
| } | |

Where pfg_parallel_filters_nocomb_flag indicates whether the filters identified by pfg_filter_id are to be run in parallel (i.e., same input) without combining their output.

### Alternating Filters

In one embodiment, the signalled information may comprise indicating that the two or more post-processing filters in a group are activated in an alternating manner so that at most one postfilter of the group is activated for any picture. The two or more post-processing filters may, for example, have the same purpose but be trained with a different data set. An encoder may select which of the two or more post-processing filters in the group is to be applied per each picture and indicate the applied filter with the NNPFA SEI message, for instance. The signalled information may be beneficial to conclude, for example, the complexity of the applied post-processing filters to be limited by the highest complexity of any of the filters in the group, instead of, for example, the cumulative complexity of all the filters in the group.

### Indicating an Identifier of a Group of Postfilters

In at least some of the previous embodiments, the signalled information may comprise indicating an identifier of a group of post-processing filters. The identifier of a group of post-processing filters may be used to identify which group and associated information should be applied to one or more pictures.

The following is an example syntax table for the postfilter group SEI message:

| postfilter_group( payloadSize ) { | Descriptor |
|---|---|
| pfg_id | ue(v) |
| pfg_num_filters_minus2 | ue(v) |
| . . . | |
| for( i = 0; i <= pfg_num_filters_minus2 + 1; i++ ) | |
| pfg_filter_id[ i ] | ue(v) |
| . . . | |
| } | |

Where pfg_id indicates an identifier for the group of postfilters that this SEI message refers to.

This identifier may be used or referred to by an activation SEI message, for identifying the group of postfilters to be activated or considered for activation for one or more pictures. The following is an example syntax table for the activation SEI message.

| nn_multi_post_filter_activation( payloadSize ) { | Descriptor |
|---|---|
| nnmpfa_group_id | ue(v) |
| nnmpfa_cancel_flag | u(1) |
| if( !nnmpfa_cancel_flag ) { | |
| nnmpfa_persistence_flag | u(1) |
| . . . | |
| } | |

Where nnmpfa_group_id indicates an identifier for the group of postfilters that this SEI message refers to, which is to be matched to the value of the syntax element pfg_id of a postfilter group SEI message.

In one example, two postfilters are part of two groups (a first group and a second group), where the first group is represented by a first PFG SEI message and the second group is represented by a second PFG SEI message. The first PFG SEI message indicates that the two postfilters in the first group are to be used in cascade, whereas the second PFG SEI message indicates that the two postfilters in the second group are to be used as alternative filters.

In an embodiment, an encoder selects an identifier of a group of post-processing filters (e.g., pfg_id) in a manner that it does not overlap with any of NNPF identifiers (e.g., nnpfc_id).

In an embodiment, an activation SEI message, such as an NNPFA SEI message, activates a group of post-processing filters when its identifier (e.g., nnpfa_target_id) is equal to an identifier of a group of post-processing filters and activates a single postfilter when its identifier (e.g., nnpfa_target_id) is equal to an NNPF identifier (e.g., nnpfc_id).

### Pre-Defined Post-Processing

In an embodiment for encoding or decoding, one or more filter identifier values, such as certain nnpfc_id, nnpfa_target_id, pfg_filter_id[i] and/or nnmpfa_target_id[i] values, indicate operations from a pre-defined set of operations. The pre-defined set of operations may comprise, but might not be limited to, one or more of the following: sample-wise combination with averaging, sample-wise weighted combination, sample-wise multiplicative weighting, horizontal flipping (a.k.a. horizontal mirroring), vertical flipping (a.k.a. vertical mirroring), color space transformation, or resampling (wherein the target spatial resolution may be inferred or indicated). This embodiment may be used together with other embodiments to include pre-defined post-processing with neural-network post-filter(s) in an indicated processing order.

### Combining Different Embodiments on how to Use Filters in a Group-Separate Usages

One embodiment may comprise aspects of several of the previous embodiments on how to use filters in a group, where only one type of usage of multiple filters is allowed. The signalled information may comprise indicating how the two or more postfilters are to be used, at least for one picture of the video sequence.

The following is an example syntax table for this embodiment:

| postfilter_group( payloadSize ) { | Descriptor |
|---|---|
| pfg_num_filters_minus2 | ue(v) |
| pfg_usage_idc | ue(v) |
| for( i = 0; i <= pfg_num_filters_minus2 + 1; i++ ) { | |
| pfg_filter_id[ i ] | ue(v) |
| if(pfg_usage_idc = = 0) /* cascaded filters */ | |
| pfg_order[ i ] | ue(v) |
| else if(pfg_usage_idc = = 2) /* parallel filters with | |
| combined outputs */ | |
| pfg_comb_coeff[ i ] | ue(v) |
| } | |
| . . . | |
| } | |

Where pfg_usage_idc indicates how the filters identified by pfg_filter_id are to be used. Different values of pfg_usage_idc may indicate that the filters are to be used in cascade, or as alternative, or in parallel with combination, or in parallel without combination. For example, the meaning of different values for pfg_usage_idc may be as in the following table:

| pfg_usage_idc | Interpretation |
|---|---|
| 0 | Cascaded filters |
| 1 | Alternative filters |
| 2 | Parallel filters with combined outputs |
| 3 | Parallel filters without combination of outputs |

In another example embodiment, the usage indicator is added conditioned on a new mode indicator value defined for the NNPFC SEI message, which is used to define a filter group. In one example, the following syntax of the NNPFC SEI message may be used:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| if( nnpfc_mode_idc = = 2 ) { | |
| nnpfc_pfg_usage_idc | ue(v) |
| nnpfc_pfg_num_filters_minus2 | ue(v) |
| for( i = 0; i <= nnpfc_pfg_num_filters_minus2 + 1; i++ ) | |
| nnpfc_pfg_filter_id[ i ] | ue(v) |
| } | |
| . . . | |

Where nnpfc_pfg_usage_idc is defined like pfc_usage_idc above.

In another embodiment, an indicator indicates how two or more post-filters or other post-processing operations are combined to form a set of input pictures for an NNPF. The indicator may be indicative of, but might not be limited to, one or more of the following (where the value in parenthesis is assumed in the syntax example below): (0) alternative filters, (1) sample-wise combination of the output picture(s) of the filters with averaging, (2) sample-wise weighted combination of the output picture(s) of the filters, (3) sample-wise multiplicative weighting of the output picture(s) of the filters, (4) concatenating the output picture(s) of the filters. In one example, the following syntax of the NNPFC SEI message may be used:

| nn_post_filter_characteristics( payloadSize ) { | Descriptor |
|---|---|
| nnpfc_purpose | u(16) |
| nnpfc_id | ue(v) |
| nnpfc_mode_idc | ue(v) |
| if( nnpfc_mode_idc = = 2 \|\| nnpfc_mode_idc = = 3 ) { | |
| nnpfc_num_source_filters_minus1 | ue(v) |
| if( nnpfc_num_source_filters_minus1 > 0 ) { | |
| nnpfc_filter_usage_idc | ue(v) |
| if( nnpfc_filter_usage_idc = = 2 ) | |
| nnpfc_comb_divisor_minus1 | ue(v) |
| } | |
| for( i = 0; i <= nnpfc_num_source_filters_minus1; i++ ) { | |
| nnpfc_source_filter_id[ i ] | ue(v) |
| if( nnpfc_filter_usage_idc = = 2 ) | |
| nnpfc_comb_weight_minus1 [ i ] | ue(v) |
| } | |
| } | |
| . . . | |

Where nnpfc_filter_usage_idc indicates the method to combine the output pictures of two or more post-filters or other post-processing operations to form a set of input pictures to the NNPF defined by this NNPFC SEI message. nnpfc_filter_usage_idc equal to 0 indicates that the output picture(s) of the NNPF with nnpfc_id equal to nnpfc_source_filter_id[i] with any value of i may be used as the input picture(s) to the NNPF defined by this NNPFC SEI message. nnpfc_filter_usage_idc equal to 1 indicates that each sample in location (x,y) in the cIdx-th sample array of the picIdx-th input picture inputPic[picIdx][cIdx][y][x] is an average of the respective sample of the output picture outputPic[i][picIdx][cIdx][y][x] of all the NNPFs identified by nnpfc_id equal to nnpfc_source_filter_id[i] for all values of i. nnpfc_filter_usage_idc equal to 2 indicates that each sample in location (x,y) in the cIdx-th sample array of the picIdx-th input picture inputPic[picIdx][cldx][y][x] is equal to Σ(outputPic[i][picIdx][cIdx][y][x]*(nnpfc_comb_weight_minus1[i]+1))=(nnpfc_comb_divisor_minus1+1). nnpfc_filter_usage_idc equal to 3 indicates that each sample in location (x,y) in the cIdx-th sample array of the picIdx-th input picture inputPic[picIdx][cldx][y][x] is equal to the product of outputPic[i][picIdx][cldx][y][x] for all values of i. nnpfc_filter_usage_idc equal to 3 indicates that the number of input pictures to the NNPF defined by this NNPFC SEI message is equal to the sum of the number of output pictures in the NNPFs identified by nnpfc_id equal to nnpfc_source_filter_id[i] for all values of i, and the output pictures are ordered in increasing order of the filter index i to form the input pictures to the NNPF defined by this NNPFC SEI message.

In one embodiment, the signalled information may comprise indicating that, for at least one picture of the video sequence, some of two or more post-processing filters are to be used in cascade, some other of the two or more postfilters are alternatives, some other of the two or more postfilters are to be used in parallel with combination of their outputs, some other of the two or more postfilters are to be used in parallel without combining their outputs.

### Number of Post-Filter Inferences

In one embodiment, an encoder may encode, or a decoder may decode, an indication indicative of the number of inferences of an NNPF when the NNPF is applied as one filter among a single invocation or execution of a group of filters. As a response to the indication, the encoder or the decoder may perform the indicated number of inferences of the NNPF for consecutive sets of input pictures. In an additional embodiment, the output pictures resulting from these inferences of the NNPF are provided in output order as input pictures to the subsequent filter(s) in the processing order of the group of filters. In an alternative additional embodiment, the output pictures and the unfiltered input pictures of the NNPF are provided in output order as input pictures to the subsequent filter(s) in the processing order of the group of filters. In one example, the following syntax may be used:

| postfilter_group( payloadSize ) { | Descriptor |
|---|---|
| pfg_id | ue(v) |
| pfg_num_filters_minus2 | ue(v) |
| for( i = 0; i <= pfg_num filters_minus2 + 1; i++ ) { | |
| pfg_filter_id[ i ] | ue(v) |
| pfg_num_inferences_minus1[ i ] | ue(v) |
| pfg_order[ i ] | ue(v) |
| } | |
| } | |

Where pfg_num_inferences_minus1[i]+1 indicates the number of inferences for the i-th filter in this post-filter group for a single execution of the post-filter group.

In an alternative embodiment, an encoder or a decoder may infer the number of inferences of an NNPF per a single inference of another NNPF of the same processing chain.

In an additional embodiment, when a first NNPF precedes a second NNPF in a cascaded processing order and the number of input pictures for the second NNPF (denoted numInputPicsNnpf2) is greater than the number of output pictures of the first NNPF (denoted numOutputPicsNnpf1), it may be required that numInputPicsNnpf2 is an integer multiple of numOutputPicsNnpf1 and the number of inferences for the first NNPF may be derived to be equal to numInputPicsNnpf2/numOutputPicsNnpf1 per each inference of the second NNPF. In an additional embodiment, when a first NNPF precedes a second NNPF in a cascaded processing order and the number of input pictures for the second NNPF (denoted numInputPicsNnpf2) is less than the number of output pictures of the first NNPF (denoted numOutputPicsNnpf1), it may be required that numOutputPicsNnpf1 is an integer multiple of numInputPicsNnpf2 and the number of inferences for the second NNPF may be derived to be equal to numOutputPicsNnpf1/numInputPicsNnpf2 per each inference of the first NNPF.

In an additional embodiment, a first NNPF takes multiple input pictures for a single inference, the first NNPF carries out picture rate upsampling (i.e., creates intermediate pictures in between at least one pair of consecutive input pictures in output order) and may additionally filter zero or more of the input pictures (e.g., by enhancing visual quality). Let processedPicsNnpf1 be the sequence of pictures, in output or display order, comprising the input pictures of the first NNPF that are not filtered by the first NNPF, the pictures filtered by the first NNPF (if any), and the intermediate pictures created by the first NNPF by a single inference of the first NNPF for a single set of input pictures. A second NNPF follows the first NNPF in a cascaded processing order. The pictures of processedPicsNnpf1 are used as the input pictures to the second NNPF. Let numProcessedPicsNnpf1 be the number of pictures processedPicsNnpf1. In an additional embodiment, the number of input pictures to the second NNPF (denoted numInputPicsNnpf2) is equal to numProcessedPicsNnpf1, and the number of inferences for the second NNPF is derived to be equal to 1 per each inference of the first NNPF. In an alternative additional embodiment, it may be required that the number of input pictures to the second NNPF (denoted numInputPicsNnpf2) is an integer multiple of numProcessedPicsNnpf1, and the number of inferences for the first NNPF is derived to be equal to numInputPicsNnpf2/numProcessedPicsNnpf1 per each inference of the second NNPF. In an alternative additional embodiment, it may be required that numProcessedPicsNnpf1 is an integer multiple of the number of input pictures to the second NNPF (denoted numInputPicsNnpf2), and the number of inferences for the second NNPF is derived to be equal to numProcessedPicsNnpf1/numInputPicsNnpf2 per each inference of the first NNPF.

### Combining Different Embodiments on how to Use Filters in a Group-Combined Usages

One embodiment may comprise aspects of several of the previous embodiments on how to use filters in a group, where two or more types of usage of multiple filters are supported. The signalled information may comprise indicating how the two or more postfilters are to be used, at least for one picture of the video sequence. For example, a first group of postfilters is to be used in cascade, a second group of postfilters is to be used in cascade, where the first group and second group are to be used as alternatives.

In one example, the signalling information comprises indicating whether a certain element of the group specified in a postfilter group SEI message is a postfilter (e.g., as specified by an NNPFC SEI message) or another group of postfilters. The following is an example syntax table:

| postfilter_group( payloadSize ) { | Descriptor |
|---|---|
| pfg_id | ue(v) |
| pfg_num_elements_minus2 | ue(v) |
| pfg_usage_idc | ue(v) |
| for( i = 0; i <= pfg_num_elements_minus2 + 1; i++ ) { | |
| pfg_group_element_type[ i ] | u(1) |
| if(pfg_group_element_type[ i ] = = 0) | |
| pfg_filter_id[ i ] | ue(v) |
| else | |
| pfg_group_id[ i ] | ue(v) |
| if(pfg_usage_idc = = 0) /* cascaded filters */ | |
| pfg_order[ i ] | ue(v) |
| if(pfg_usage_idc == 2) /* parallel filters with combined | |
| outputs */ | |
| pfg_comb_coeff[ i ] | ue(v) |
| } | |
| . . . | |
| } | |

Where pfg_num_elements_minus2+2 indicates the number of elements in the group specified in this postfilter group SEI message, pfg_group_element_type[i] indicates a type of an i-th element in the group specified in this postfilter group SEI message, pfg_filter_id[i] indicates an identifier for a postfilter (for example, an identifier of a NNPFC SEI message), pfg_group_id[i] indicates an identifier of a postfilter group SEI message (to be matched with pfg_id of another PFG SEI message). For example, the meaning of different values for pfg_group_element_type may be as in the following table:

| pfg_group_element_type | Interpretation |
|---|---|
| 0 | A postfilter |
| 1 | A group of postfilters |

Another example of syntax table that indicates the elements based on SEI messages (e.g., NNPFC SEI messages and PFG SEI messages) is as follows:

| postfilter_group( payloadSize ) { | Descriptor |
|---|---|
| pfg_id | ue(v) |
| pfg_num_elements_minus2 | ue(v) |
| pfg_usage_idc | ue(v) |
| for( i = 0; i <= pfg_num_elements_minus2 + 1; i++ ) { | |
| pfg_group_element_type[ i ] | u(1) |
| if(pfg_group_element_type[ i ] = = 0) | |
| nn_post_filter_characteristics( ) | ue(v) |
| else | |
| post_filter_group( ) | ue(v) |
| if(pfg_usage_idc = = 0) /* cascaded filters */ | |
| pfg_order[ i ] | ue(v) |
| if(pfg_usage_idc = = 1) /* parallel filters with combined | |
| outputs */ | |
| pfg_comb_coeff[ i ] | ue(v) |
| . . . | |
| } | |

Where nn_post_filter_characteristics( ) indicates an NNPFC SEI message, post_filter_group( ) indicates a postfilter group SEI message.

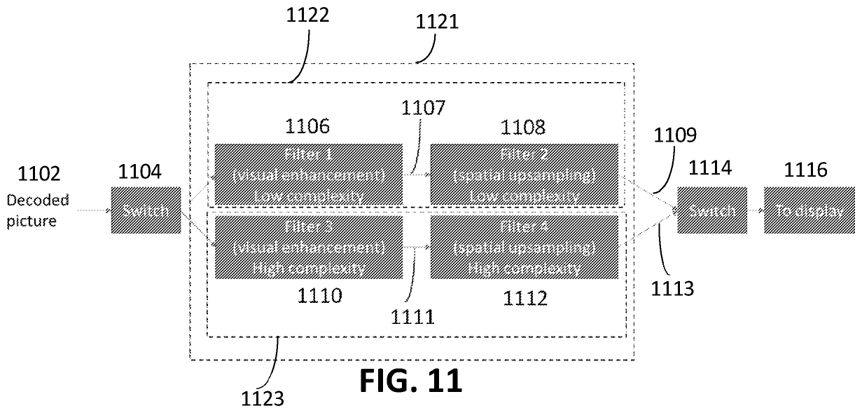

FIG. 11 illustrates an example. In this example, “Filter 1” (1106) performs visual enhancement and has low complexity, “Filter 2” (1108) performs spatial upsampling and has low complexity, “Filter 3” (1110) performs visual enhancement and has high complexity, “Filter 4” (1112) performs spatial upsampling and has high complexity. A first group 1121 comprises a second group 1122 and a third group 1123 and indicates that the second group 1122 is to be used as alternative with respect to the third group 1123. The second group 1122 comprises the filters “Filter 1” (1106) and “Filter 2” (1108) and indicates that those filters (1106, 1108) are to be used in cascade. The third group 1123 comprises the filters “Filter 3” (1110) and “Filter 4” (1112) and indicates that those filters (1110, 1112) are to be used in cascade. Referring to the syntax table of the PFG SEI message above, a first PFG SEI message may comprise the following content (1-5 as follows):
1. npfg_num_elements_minus2+2 would be equal to 2.
2. pfg_usage_idc would be equal to 1 (indicating alternative filters).
3. pfg_group_element_type[0] would be equal to 1.
4. pfg_group_element_type[1] would be equal to 1.
5. A second and a third PFG SEI messages would be present, where the second PFG SEI message comprises signalling information for the second group 1122 and a third PFG SEI message comprises signalling information for the third group 1123.

The second PFG SEI message may comprise the following content (1-5 as follows):
1. npfg_num_elements_minus2+2 would be equal to 2.
2. pfg_usage_idc would be equal to 0 (indicating cascaded filters).
3. pfg_group_element_type[0] would be equal to 0.
4. pfg_group_element_type[1] would be equal to 0.
5. Two NNPFC SEI messages would be present, indicating characteristics for “Filter 1” (1106) and “Filter 2” (1108).

The third PFG SEI message may comprise the following content (1-5 as follows):
1. npfg_num_elements_minus2+2 would be equal to 2.
2. pfg_usage_idc would be equal to 0 (indicating cascaded filters).
3. pfg_group_element_type[0] would be equal to 0.
4. pfg_group_element_type[1] would be equal to 0.
5. Two NNPFC SEI messages would be present, indicating characteristics for “Filter 3” (1110) and “Filter 4” (1112).

In FIG. 11, “Decoded picture” (1102) refers to a decoded picture that is output by a video decoder or video codec. The cropped decoded picture 1102 represents one of the inputs to filter 1106 and filter 1110. The output 1107 of filter 1106 is used as an input to filter 1108. The output 1111 of filter 1110 is used as an input to filter 1112. “Switch” (1104, 1114) refers to an operation that may not be actually present in the post-processing stage, but that represents the choice between the second group 1122 comprising filter 1106 and filter 1108 and the third group 1123 comprising filter 1110 and filter 1112 for a certain picture, e.g., only one group of filters is activated for a certain picture. In this example, for a certain picture for which one of these two groups may be activated, a receiver chooses (e.g. using switch 1114) which of the second group 1122 or the third group 1123 to actually use, for example based on complexity. The output 1109 of the second group 1122 comprising filter 1106 and filter 1108 or the output 1113 of the third group 1123 comprising filter 1110 and filter 1112 is used for display 1116.

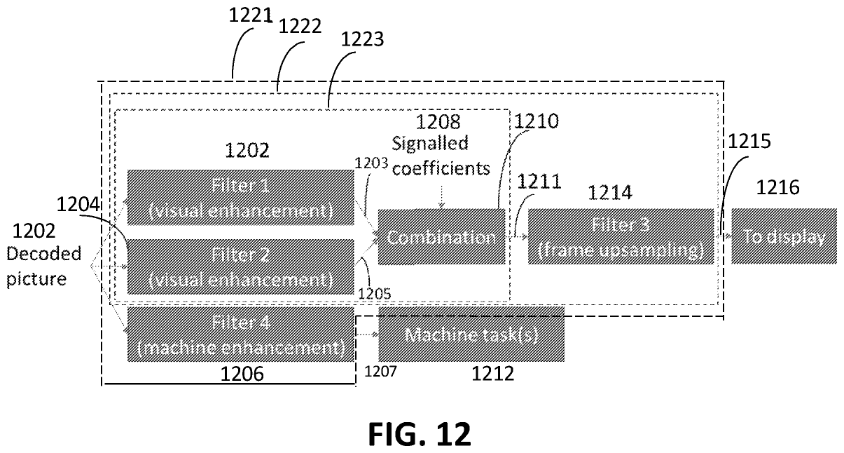

FIG. 12 illustrates another example. In this example, using as input decoded picture 1202, “Filter 1” (1202) and “Filter 2” (1204) perform visual enhancement and are to be used in parallel with combination of their outputs. “Combination” 1210 performs a combination operation of the output 1203 of “Filter 1” (1202) and the output 1205 of “Filter 2” (1204). “Filter 3” (1214) performs frame-rate upsampling based on the output 1211 of the combination operation 1210. The output 1215 of “Filter 3” (1214) is used for displaying 1216. “Filter 4” (1206) performs enhancement for one or more machine analysis tasks (1212). The output 1207 of “Filter 4” (1206) is used as input to one or more machine analysis tasks (1212).

The two outputs of the two postfilters, namely output 1203 of filter 1202 and output 1205 of filter 1204, are combined by the “Combination” block (1210), based on one or more coefficients denoted as “Signalled coefficients” 1208. The combination operation 1210 may be a linear combination where the one or more coefficients 1208 are used to weight the contribution of the output (1203, 1205) of each of the two postfilters (1202, 1204). The one or more coefficients (1208) are signalled from an encoder to a decoder, for example as part of a postfilter group SEI message.

A first group 1221 comprises a second group 1222 and the postfilter “Filter 4” (1206), and indicates that they are to be used in parallel without combination. The second group 1222 comprises a third group 1223 and the postfilter “Filter 3” (1214), and indicates that they are to be used in cascade. The third group 1223 comprises the two postfilters “Filter 1” (1202) and “Filter 2” (1204), and indicates that they are to be used in parallel with combination 1210 of their outputs.

Referring to the syntax table of the PFG SEI message above, a first PFG SEI message may comprise the following content (1-6 as follows):
1. npfg_num_elements_minus2+2 would be equal to 2.
2. pfg_usage_idc would be equal to 3 (indicating parallel filters without combination).
3. pfg_group_element_type[0] would be equal to 1 (indicating a group)
4. pfg_group_element_type[1] would be equal to 0 (indicating a postfilter)
5. A second PFG SEI message would be present, that comprises signalling information for the second group 1222.
6. An NNPFC SEI message would be present, indicating characteristics for “Filter 4” (1206).

The second PFG SEI message may comprise the following content (1-6 as follows):
1. npfg_num_elements_minus2+2 would be equal to 2.
2. pfg_usage_idc would be equal to 0 (indicating cascaded filters or groups).
3. pfg_group_element_type[0] would be equal to 1 (indicating a group).
4. pfg_group_element_type[1] would be equal to 0 (indicating a postfilter).
5. A third PFG SEI message would be present, that comprises signalling information for the third group 1223.
6. An NNPFC SEI message would be present, indicating characteristics for “Filter 3” (1214).

The third PFG SEI message may comprise the following content (1-5 as follows):
1. npfg_num_elements_minus2+2 would be equal to 2.
2. pfg_usage_idc would be equal to 2 (indicating parallel filters with combination of their outputs).
3. pfg_group_element_type[0] would be equal to 0 (indicating a postfilter).
4. pfg_group_element_type[1] would be equal to 0 (indicating a postfilter).
5. Two NNPFC SEI messages would be present, indicating characteristics for “Filter 1” (1202) and “Filter 2” (1204).

In an embodiment, all filter group identifiers and filter identifiers are unique. A target identifier, such as nnpfa_target_id or nnpfc_pfg_filter_id[i], may refer to a post-filter or to a filter group. Consequently, an NNPFA SEI message may activate a filter group, an NNPFC SEI message extended with mode indicating a filter group may define a filter group that comprises another filter group.

In an embodiment, a postfilter group SEI message identifies a non-cyclic graph representation of filters. Any representation format for a non-cyclic graph may be used.

Indicating Processing Order of a Filter Group with Respect to Other SEI Messages

In an embodiment, an encoder includes, into or along a bitstream (e.g., in a SEI processing order SEI message), information indicative of the order of executing a filter group with respect to processing other SEI messages. In an embodiment, a decoder decodes, from or along a bitstream (e.g., from a SEI processing order SEI message), information indicative of the order of executing a filter group with respect to processing other SEI messages.

In an embodiment, an encoder includes, into or along a bitstream (e.g., in an SEI processing order SEI message), an indication, such as a flag, to indicate if a prefix of an SEI message is indicated with the SEI message type in relation to their processing order. The prefix of an SEI message may be defined as a selected number of initial bytes of an SEI message. In an embodiment, an encoder includes, within the prefix of an SEI message, a prefix of an SEI message described in any other embodiment, such as postfilter_group( ) nn_multi_post_filter_activation( ) or NNPFC SEI message with a new nnpfc_mode_idc value. The prefix of the another SEI message may comprise an identifier of a NNPF group, a purpose of the NNPF group, complexity of the NNPF group and/or gain of the NNPF group, as described in other embodiments. In an embodiment, a decoder decodes, from or along a bitstream (e.g., from an SEI processing order SEI message), an indication, such as a flag, indicating if a prefix of an SEI message is indicated with the SEI message type in relation to their processing order. In an embodiment, a decoder decodes, from the prefix of an SEI message, a prefix of an SEI message described in any other embodiment, such as postfilter_group( ), nn_multi_post_filter_activation( ), or NNPFC SEI message with a new nnpfc_mode_idc value.

For example, the following syntax and semantics or alike may be used, where po_prefix_included[i] equal to 0 indicates that no prefix of the SEI message is included in the SEI processing order SEI message, and equal to 1 indicates that a prefix of the SEI message is included in the SEI processing order SEI message. When an SEI message defines or activates a filter group, po_prefix_included[i] may be set equal to 1 and prefix of the SEI message may include the filter group ID.

| sei_processing_order( payloadSize ) { | Descriptor |
|---|---|
| i = 0 | |
| b = 0 | |
| do { | |
| po_prefix_included [ i ] | u(1) |
| po_sei_payload_type[ i ] | u(15) |
| po_sei_processing_order[ i ] | u(8) |
| b += 3 | |
| if( po_prefix_included[ i ] ) { | |
| po_num_bits_in_prefix_indication_minus1 [ i ] | u(16) |
| for( j = 0; j <= | |
| po_num_bits_in_prefix_indication_minus1[ i ]; j++ ) | |
| po_sei_prefix_data_bit[ i ][ j ] | u(1) |
| while( !byte_aligned( ) ) | |
| po_byte_alignment_bit_equal_to_one /* equal to 1 | f(1) |
| */ | |
| b += (po_num_bits_in_prefix_indication_minus1 | |
| [ i ] + 1 ) / 8 + | |
| (po_num_bits_in_prefix_indication_minus1 | |
| [ i ] + 1 ) % 8 | |
| } | |
| i++ | |
| } while( b < payloadSize ) | |
| } | |

Wherein poPayloadType[i] is set equal to po_sei_payload_type[i]. po_sei_processing_order[m] greater than 0 and less than po_sei_processing_order[n] indicates any SEI message with payloadType equal to poPayloadType[m], when present, should be processed before any SEI message with payloadType equal to poPayloadType[n], when present. po_sei_processing_order[i] equal to 0 specifies that the preferred order of processing SEI messages with payloadType equal to poPayloadType[i] is unknown or unspecified or determined by external means. po_sei_processing_order[m] greater than 0 and equal to po_sei_processing_order[n] indicates that the m-th SEI message with payloadType equal to poPayloadType[m], when present, has the same input data as the n-th SEI message with payloadType equal to poPayloadType[n]. po_num_bits_in_prefix_indication_minus1[i] plus 1 specifies the number of bits in the i-th SEI prefix indication. po_sei_prefix_data_bit[i][j] specifies the j-th bit of the i-th SEI prefix indication. The bits po_sei_prefix_data_bit[i][j] for j ranging from 0 to po_num_bits_in_prefix_indication_minus1[i], inclusive, follow the syntax of the SEI payload with payloadType equal to po_prefix_sei_payload_type[i], and contain a number of complete syntax elements starting from the first syntax element in the SEI payload syntax, and may or may not contain all the syntax elements in the SEI payload syntax. The last bit of the these bits (i.e., bit sei_prefix_data_bit[i][num_bits_in_prefix_indication_minus1[i]]) may be required to be the last bit of a syntax element in the SEI payload syntax. byte_alignment_bit_equal_to_one may be required to be equal to 1. Other syntax elements are like described above.

### Activating Base Post-Processing Filter(s)

As described earlier, the NNPFA SEI message as specified in JVET-AC2032 activates the latest updated NNPF with nnpfc_id equal to nnpa_target_id. In an embodiment, the NNPFA SEI message is amended with an indication whether it activates the base NNPF or the latest updated NNPF having nnpfc_id equal to nnpfa_target_id. The activation of the base NNPF could be advantageous, for example, when an update is derived from a first group of pictures of a segment of pictures, where the segment is longer than the first group of pictures, and the picture content of the segment changes later considerably. It is therefore beneficial to enable activation of the base NNPF in the NNPFA SEI message.

In an embodiment, an encoder detects whether the base NNPF and an updated NNPF is beneficial for one or more consecutive pictures. For example, the encoder may filter the one or more consecutive pictures with the base NNPF and separately with updated NNPF and select the base or updated NNPF based on which one performs better with one or more quality metrics, such as those discussed in the gain-related embodiments below. The encoder activates the base NNPF or the updated NNPF for the group of one or more consecutive pictures with an NNPFA SEI message.

In an embodiment, a decoder decodes, from an NNPFA SEI message, whether the base NNPF or an updated NNPF is to be activated, and accordingly activates the base NNPF or the updated NNPF. It is noted that the base NNPF is available in the decoder side, since it is kept as the basis for potential filter updates.

In one example, the following syntax may be used in the above-described embodiments:

| nn_post_filter_activation( payloadSize ) { | Descriptor |
|---|---|
| nnpfa_target_id | ue(v) |
| nnpfa_cancel_flag | u(1) |
| if( !nnpfa_cancel_flag ) { | |
| nnpfa_base_flag | u(1) |
| nnpfa_persistence_flag | u(1) |
| } | |
| } | |

Where nnpfa_base_flag equal to 1 specifies that the target NNPF is the base NNPF with nnpfc_id equal to nnpfa_target_id. nnpfa_base_flag equal to 0 specifies that the target NNPF is the NNPF specified by the last NNPFC SEI message with nnpfc_id equal to nnpfa_target_id, that precedes the first VCL NAL unit of the current picture in decoding order that is not a repetition of the NNPFC SEI message that contains the base NNPF. The other syntax elements have been described earlier or in JVET-AC2032.

In this example, the neural-network post-filter activation (NNPFA) SEI message activates or de-activates the possible use of the target neural-network post-processing filter (NNPF), identified by nnpfa_target_id, for post-processing filtering of a set of pictures. For a particular picture for which the NNPF is activated, the target NNPF is derived as follows: If nnpfa_base_flag is equal to 1, the target NNPF is the base NNPF with nnpfc_id equal to nnpfa_target_id. Otherwise (nnpfa_base_flag is equal to 0), the target NNPF is the NNPF specified by the last NNPFC SEI message with nnpfc_id equal to nnpfa_target_id, that precedes the first VCL NAL unit of the current picture in decoding order that is not a repetition of the NNPFC SEI message that contains the base NNPF.

In an embodiment, an activation SEI message that activates a group of postfilters is amended with an indication whether it activates the base NNPFs or the latest updated NNPFs of the group of postfilters. The above-described embodiments similarly apply for a group of postfilters. In one example, the following syntax may be used:

| | Descriptor |
|---|---|
| nn_multi_post_filter_activation( payloadSize ) { | |
| nnmpfa_group_id | ue(v) |
| nnmpfa_cancel_flag | u(1) |
| if( !nnmpfa_cancel_flag ) { | |
| nnmpfa_base_flag | u(1) |
| nnmpfa_persistence_flag | u(1) |
| } | |
| } | |

Where nnmpfa_base_flag equal to 1 specifies that the target NNPF group comprises the base NNPFs in the NNPF group with identifier nnmpfa_group_id. nnmpfa_base_flag equal to 0 specifies that the target NNPF group is the NNPF group where each postfilter is specified by the last NNPFC SEI message with nnpfc_id equal to identifiers belonging to the NNPF group, that precedes the first VCL NAL unit of the current picture in decoding order that is not a repetition of the NNPFC SEI message that contains the base NNPF.

In an embodiment, an activation SEI message that activates a group of postfilters is amended, for each NNPF in the group of postfilters, with an indication whether the SEI activation message activates the base NNPF or the latest updated NNPF. The above-described embodiments similarly apply for a group of postfilters.

### Gain-Related Embodiments

### Expected Gain

In one embodiment, the signalled information comprises one or more sets of expected gains associated to respective one or more post-processing filters in the group of post-processing filters, or comprises one set of expected gains associated to all the postfilters in the group of postfilters, for the case where a purpose of the one or more post-processing filters or all the postfilters, respectively, is visual enhancement, or enhancement of machine analysis task(s), or any other purpose where the goal is to obtain a gain in terms of one or more metrics. Such an expected gain may have been determined during or after a development stage of the postfilter, based at least on the performance of the postfilter on a validation dataset. In the set of expected gains associated to a certain postfilter or to the postfilters in a certain group of postfilters, there may be one or more expected gains associated to that postfilter or to the postfilters in that group of postfilters, where different expected gains may be expressed in terms of different metrics.

In one example, the expected gain is determined by another entity (usually a human being via a computer code, but may be an AI system or any other automated system) with respect to the encoder and decoder, such as during a development phase of the codec or after the codec has been developed. In another example, the expected gain may be determined by the encoder or a transmitter, where the encoder or the transmitter may evaluate the performance or gain of the postfilter(s) on a dataset that is available at the encoder side or transmitter side, respectively. In yet another example, the expected gain may be determined by the decoder or a receiver, where the decoder or the receiver may evaluate the performance or gain of the postfilter(s) on a dataset which is available at the decoder side or transmitter side, respectively. In this latter example, the signalled information may not comprise indications about the expected gain.

When the signalled information comprises one or more expected gains associated to all the postfilters in the group of postfilters, each of the one or more expected gains may be referred to also as a combined expected gain or an expected group gain, and it indicates the expected gain of using all the associated post-processing filters.

In one embodiment, an expected gain represents a gain that is expected to be obtained (although not necessarily precisely) for one or more data units (such as one or more pictures, or one or more CTUs) when using the associated post-processing filters on those one or more data units.

In one embodiment, an expected gain represents a gain that is expected to be obtained (although not necessarily precisely) for a portion of the video sequence when using the associated post-processing filters on at least a subset of that portion. The portion may be the whole video sequence, or may be expressed as a predetermined length of video sequence, or may be expressed as a number of frames, or may be expressed as a number of Groups Of Pictures (GOPs), and the like.

The signalled information may comprise an indication of whether the expected gain is a gain that is expected to be obtained for the one or more data units on which the postfilters are applied or a gain that is expected to be obtained for a portion of the video sequence (as for the two embodiments above), and what portion.

In one example, a postfilter has a purpose of objective visual enhancement in terms of PSNR; the expected gain is expressed in terms of expected PSNR gain, i.e., the expected difference between the PSNR of the data to be filtered by the postfilter and the PSNR of the data filtered by the postfilter.

In another example, a postfilter has a purpose of objective visual enhancement in terms of MS-SSIM; the expected gain is expressed in terms of expected MS-SSIM gain, i.e., the expected difference between the MS-SSIM of the data to be filtered by the postfilter and the MS-SSIM of the data filtered by the postfilter.

In another example, a postfilter has a purpose of subjective visual enhancement in terms of MOS (mean opinion score); the expected gain is expressed in terms of expected MOS gain, i.e., the expected difference between the MOS of the data to be filtered by the postfilter and the MOS of the data filtered by the postfilter.

In another example, a postfilter has a purpose of enhancement for an object detection task in terms of mAP (mean average precision); the expected gain is expressed in terms of expected mAP gain, i.e., the expected difference between the mAP obtained based at least on the data to be filtered by the postfilter and the mAP obtained based at least on the data filtered by the postfilter.

An example syntax table is as follows:

| | Descriptor |
|---|---|
| postfilter_group( payloadSize ) { | |
| pfg_id | ue(v) |
| pfg_num_elements_minus2 | ue(v) |
| pfg_usage_idc | ue(v) |
| for( i = 0; i <= pfg_num_elements_minus2 + 1; i++ ) { | |
| pfg_expected_gain_present_flag[ i ] | u(1) |
| if( pfg_expected_gain_present_flag[ i ] ) { | |
| pfg_expected_gain_type_idc[ i ] | ue(v) |
| pfg_expected_gain[ i ] | ue(v) |
| } | |
| pfg_group_element_type[ i ] | u(1) |
| if(pfg_group_element_type[ i ] = = 0) | |
| nn_post_filter_characteristics( ) | ue(v) |
| else | |
| post_filter_group( ) | ue(v) |
| if(pfg_usage_idc = = 0) /* cascaded filters */ | |
| pfg_order[ i ] | ue(v) |
| if(pfg_usage_idc = = 1) /* parallel filters with | |
| combined outputs */ | |
| pfg_comb_coeff[ i ] | ue(v) |
| } | |
| ... | |
| } | |

Where pfg_expected_gain_present_flag[i] indicates whether an expected gain is present for the i-th postfilter, pfg_expected_gain[i] indicates the expected gain for the i-th postfilter, pfg_expected_gain_type_idc[i] indicates the type of the expected gain information, i.e., whether the expected gain is a gain that is expected to be obtained for the one or more data units on which the postfilters are applied or a gain that is expected to be obtained for a portion of the video sequence (as for the two embodiments above), and what portion.

The metric in terms of which the expected gain is indicated may be predefined in a standard specification based on one or more syntax elements or derived variables for the postfilter. These one or more syntax elements or derived variables may, for example, comprise the purpose of the postfilter. For example, one or more of the metric associations based on the purpose as in the following table may be predefined, where it needs to be understood that the presented nnpfc_purpose values are merely examples, and any other values could likewise be specified for these purposes:

| nnpfc_purpose | Purpose | Metric for expected gain |
|---|---|---|
| (nnpfc_purpose | Objective visual quality | PSNR |
| & 0x40) != 0 | improvement | |
| (nnpfc_purpose | Subjective visual quality | MOS |
| & 0x80) != 0 | improvement | |
| (nnpfc_purpose | Object detection | mAP |
| & 0x100) != 0 | | |
| (nnpfc_purpose | Instance segmentation | mAP |
| & 0x200) != 0 | | |
| (nnpfc_purpose | Object tracking | MOTA |
| & 0x400) != 0 | | |

Values of pfg_expected_gain_type_idc may be as in the following table:

| pfg_expected_gain_type_idc | Interpretation |
|---|---|
| 0 | The expected gain is a gain that is expected to be |
| | obtained for the data units on which the postfilters are |
| | applied. |
| 1 | The expected gain is a gain that is expected to be |
| | obtained for the whole video sequence. |
| 1 | The expected gain is a gain that is expected to be |
| | obtained for each GOP |
| 2 | The expected gain is a gain that is expected to be |
| | obtained for each RA segment. |
| 3 | The expected gain is a gain that is expected to be |
| | obtained for unspecified data unit type |
| 4 | The expected gain is a gain that is expected to be |
| | obtained for intra-coded slices |
| 5 | The expected gain is a gain that is expected to be |
| | obtained for inter-coded slices |
| 6 | The expected gain is a gain that is expected to be |
| | obtained for pictures in temporal layer ID 0 |
| 7 | The expected gain is a gain that is expected to be |
| | obtained for pictures in temporal layer ID 1 |
| 8 | The expected gain is a gain that is expected to be |
| | obtained for pictures in temporal layer ID 2 |
| 9 | The expected gain is a gain that is expected to be |
| | obtained for pictures in temporal layer ID 3 |
| 10 | The expected gain is a gain that is expected to be |
| | obtained for pictures in temporal layer ID 4 |
| 11 | The expected gain is a gain that is expected to be |
| | obtained for pictures in temporal layer ID 5 |

Other types may be defined, for example based on resolution, based on content nature (e.g., screen content, natural content, man-made structures, indoors, outdoors, etc.).

Another example syntax table, where the metrics are not predefined in a standard, is as follows:

| | Descriptor |
|---|---|
| postfilter_group( payloadSize ) { | |
| pfg_id | ue(v) |
| pfg_num_elements_minus2 | ue(v) |
| pfg_usage_idc | ue(v) |
| for( i = 0; i <= pfg_num_elements_minus2 + 1; i++ ) | |
| pfg_expected_gain_present_flag[ i ] | u(1) |
| if(pfg_expected_gain_present_flag[ i ] ) | |
| pfg_expected_gain_type_idc[ i ] | ue(v) |
| pfg_expected_gain_metric[ i ] | ue(v) |
| pfg_expected_gain[ i ] | ue(v) |
| pfg_group_element_type[ i ] | u(1) |
| if(pfg_group_element_type[ i ] = = 0) | |
| nn_post_filter_characteristics( ) | ue(v) |
| else | |
| post_filter_group( ) | ue(v) |
| if(pfg_usage_idc = = 0) /* cascaded filters */ | |
| pfg_order[ i ] | ue(v) |
| if(pfg_usage_idc = = 1) /* parallel filters | |
| with combined outputs */ | |
| pfg_comb_coef[ i ] | ue(v) |
| ... | |
| } | |

Where pfg_expected_gain_metric[i] indicates the metric in terms of which the expected gain indicated by pfg_expected_gain[i] is expressed. For example, the possible values and interpretations of pfg_expected_gain_metric[i] may be as follows:

| pfg_expected_gain_metric | Interpretation |
|---|---|
| 0 | PSNR |
| 1 | MS-SSIM |
| 2 | MOS |
| 3 | mAP |
| 4 | MOTA |
| 5 | BD-rate with PSNR as quality |
| | metric |
| 6 | BD-rate with MS-SSIM as |
| | quality metric |
| 7 | BD-rate with MOS as quality |
| | metric |
| 8 | BD-rate with mAP as quality |
| | metric |
| 9 | BD-rate with MOTA as quality |
| | metric |
| 10 | BD-PSNR |
| 11 | BD-MOS |
| 12 | BD-mAP |
| 13 | BD-MOTA |

The information above may be alternatively signalled in a NNPFC SEI message, for example as follows:

| | Descriptor |
|---|---|
| nn_post_filter_characteristics( payloadSize ) { | |
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_expected_gain_present_flag | u(1) |
| if( nnpfc_expected_gain_present_flag ) { | |
| nnpfc_expected_gain_type_idc | ue(v) |
| nnpfc_expected_gain_metric | ue(v) |
| nnpfc_expected_gain | ue(v) |
| } | |
| ... | |

The following is an example syntax table for the case where the signalled information comprises one set of expected gains associated to all the postfilters in the group of postfilters. In this example, the set comprises one combined expected gain (or, using a different terminology, one expected group gain):

| | Descriptor |
|---|---|
| postfilter_group( payloadSize ) { | |
| pfg_id | ue(v) |
| pfg_num_elements_minus2 | ue(v) |
| pfg_usage_idc | ue(v) |
| pfg_expected_group_gain_present_flag | u(1) |
| if(pfg_expected_group_gain_present_flag ) | |
| pfg_expected_group_gain_type_idc | ue(v) |
| pfg_expected_group_gain_metric | ue(v) |
| pfg_expected_group_gain | ue(v) |
| for( i= 0; i <= pfg_num_elements_minus2 + 1; i++ ) | |
| pfg_group_element_type[ i ] | u(1) |
| if(pfg_group_element_type[ i ] = = 0) | |
| nn_post_filter_characteristics( ) | ue(v) |
| else | |
| post_filter_group( ) | ue(v) |
| if(pfg_usage_idc = = 0) /* cascaded filters */ | |
| pfg_order[ i ] | ue(v) |
| if(pfg_usage_idc = = 1) /* parallel filters with combined | |
| outputs */ | |
| pfg_comb_coeff[ i ] | ue(v) |
| ... | |
| } | |

Where pfg_expected_group_gain_present_flag indicates whether a combined expected gain is present for the group of postfilters comprised or referred to in this PFG SEI message, pfg_expected_group_gain_metric indicates the metric in terms of which the combined expected gain is expressed, pfg_expected_group_gain indicates the combined expected gain for the group of postfilters comprised or referred to in this PFG SEI message. pfg_expected_group_gain_type_idc is defined similarly as for pfg_expected_gain_type_idc.

In one example, a PFG SEI message indicates that two postfilters whose purpose is objective visual enhancement are to be used in cascade. The following information would be contained in a PFG SEI message in order to signal a combined expected gain that is obtainable by the cascade of postfilters for the data units (e.g., pictures) on which it is applied (1-4 as follows):
1. pfg_expected_group_gain_present_flag equal to 1.
2. pfg_expected_group_gain_type_idc equal to 0.
3. pfg_expected_group_gain_metric equal to 0 (indicating PSNR metric).
4. pfg_expected_group_gain equal to (for example) 0.5, where 0.5 represents an expected increase of 0.5 dB in PSNR when using the postfilter on one or more pictures.

In an embodiment, an expected post-filter gain SEI message is defined for indicating a filter group ID or a filter ID and syntax elements for the expected gain. An example syntax table is as follows:

| | Descriptor |
|---|---|
| expected_postfilter_gain( payloadSize ) { | |
| epfg_id | ue(v) |
| epfg_expected_gain_type_idc | ue(v) |
| epfg_expected_gain | ue(v) |
| } | |

Where epfg_expected_gain indicates the expected gain for the post-filter or post-filter group with ID equal to epfg_id (however, epfg_id may not be present in this SEI message, if this SEI message is contained in a nesting postfilter group SEI message), and epfg_expected_gain_type_idc indicates the type of the expected gain information, i.e., whether the expected gain is a gain that is expected to be obtained for the one or more data units on which the postfilters are applied or a gain that is expected to be obtained for a portion of the video sequence (as for the two embodiments above), and what portion.

The metric in terms of which the expected gain is indicated may be predefined in a standard specification based on the purpose of the postfilter.

In an embodiment, an expected post-filter gain SEI message is intended to be used within a nesting SEI message that defines a filter group and hence its syntax need not include a filter group ID.

In an embodiment, a post-filter activation SEI message or a post-filter group activation SEI message is appended with expected gain information indicating the expected gain for the frames that the SEI message activates the filter or filter group.

An example syntax for extending a post-filter group activation SEI message is as follows, where the semantics of syntax elements is similar to what has been defined above.

| | Descriptor |
|---|---|
| nn_multi_post_filter_activation( payloadSize ) { | |
| nnmpfa_num_filters_minus1 | ue(v) |
| for( i = 0; i <= nnmpfa_num_filters_minus1; i++ ) | |
| nnmpfa_target_id[ i ] | ue(v) |
| nnmpfa_cancel_flag | u(1) |
| if( !nnmpfa_cancel_flag ) { | |
| nnmpfa_persistence_flag | u(1) |
| nnmpfa_expected_gain_type_idc | ue(v) |
| nnmpfa_expected_gain | ue(v) |
| ... | |
| } | |

An example syntax for extending a post-filter activation SEI message is as follows, where the semantics of syntax elements is similar to what has been defined above, and the syntax function more_data_in_payload( ) returns TRUE if the SEI message contains more data and FALSE if the SEI message does not contain more data.

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) | |
| nnpfa_persistence_flag | u(1) |
| if( more_data_in_payload( ) && !nnpfa_cancel_flag ) { | |
| nnmpfa_expected_gain_type_idc | ue(v) |
| nnmpfa_expected_gain | ue(v) |
| } | |
| } | |

In an embodiment, a post-filter characteristics SEI message may be extended with expected gain syntax conditioned on a new mode indicator value defined for the NNPFC SEI message, which is used to define a filter group. In one example, the following syntax of the NNPFC SEI message may be used where the semantics of the additional syntax elements may be defined as above.

| | Descriptor |
|---|---|
| nn_post_filter_characteristics( payloadSize ) { | |
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| if( nnpfc_mode_idc = = 2 ) { | |
| nnpfc_pfg_usage_idc | ue(v) |
| nnpfc_pfg_num_filters_minus2 | ue(v) |
| for( i = 0; i <= nnpfc_pfg_num_filters_minus2 + 1; i++ ) | |
| nnpfc_pfg_filter_id[ i ] | ue(v) |
| pfg_expected_gain_type_idc | ue(v) |
| pfg_expected_gain | ue(v) |
| } | |
| ... | |

In one embodiment, an extension mechanism is included in an NNPFC SEI message, where the number of bits for an extension is indicated and where the extension may be skipped and ignored by a decoder. For example, the following syntax may be used:

| | Descriptor |
|---|---|
| nn_post_filter_characteristics( payloadSize ) { | |
| ... | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| nnpfc_metadata_extension_num_bits | ue(v) |
| if( nnpfc_metadata_extension_num_bits > 0 ) | |
| nnpfc_reserved_metadata_extension | u(v) |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

Where nnpfc_metadata_extension_num_bits equal to 0 specifies that nnpfc_reserved_metadata_extension is not present. nnpfc_metadata_extension_num_bits greater than 0 specifies the length, in bits, of nnpfc_reserved_metadata_extension. Decoders may ignore the presence and value of nnpfc_reserved_metadata_extension. It may be required that nnpfc_metadata_extension_num_bits is equal to 0 and nnpfc_reserved_metadata_extension is not present, until syntax and semantics have been specified for bits within nnpfc_reserved_metadata_extension.

In an embodiment, NNPFC metadata extension carries syntax elements for expected gain, which may apply to a single post-filter or a group of filters depending on the mode indicator value (nnpfc_mode_idc) as discussed in other embodiments. In one example, the following syntax of the NNPFC SEI message may be used where the semantics of the additional syntax elements may be defined as above:

| | Descriptor |
|---|---|
| nn_post_filter_characteristics( payloadSize ) { | |
| ... | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| nnpfc_metadata_extension_num_bits | ue(v) |
| if( nnpfc_metadata_extension_num_bits > 0 ) | |
| nnpfc_gain_info_present_flag | u(1) |
| if( nnpfc_gain_info_present_flag ) { | |
| nnpfc_expected_gain_type_idc | ue(v) |
| nnpfc_expected_gain | ue(v) |
| } | |
| if( nnpfc_metadata_extension_num_bits > | |
| nnpfcGainExtensionLength ) | |
| nnpfc_reserved_metadata_extension | u(v) |
| } | |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

Where nnpfc_metadata_extension_num_bits equal to 0 specifies that nnpfc_gain_info_present_flag and nnpfc_reserved_metadata_extension are not present. nnpfc_metadata_extension_num_bits greater than 0 specifies the joint length, in bits, of nnpfc_gain_info_present_flag, nnpfc_expected_gain_type_idc (when present), nnpfc_expected_gain (when present), and nnpfc_reserved_metadata_extension. Decoders may ignore the presence and value of nnpfc_reserved_metadata_extension. nnpfc_expected_gain_type_idc (when present) and nnpfc_exptected_gain (when present) are specified like in other embodiments. Let nnpfcGainExtensionLength be the joint length, in bits, of nnpfc_gain_info_present_flag, nnpfc_expected_gain_type_idc (when present), and nnpfc_exptected_gain (when present). When present, the length, in bits, of nnpfc_reserved_metadata_extension is nnpfc_metadata_extension_num_bits nnpfcGainExtensionLength. It may be required that nnpfc_metadata_extension_num_bits-nnpfcGainExtensionLength is equal to 0 and nnpfc_reserved_metadata_extension is not present, until syntax and semantics have been specified for bits within nnpfc_reserved_metadata_extension.

### Actual Gain

In one embodiment, the signalled information comprises one or more sets of actual gains associated to respective one or more post-processing filters in the group of post-processing filters, or comprises one set of actual gains associated to all the postfilters in the group of postfilters, for the case where a purpose of the one or more post-processing filters or all the postfilters, respectively, is visual enhancement, or enhancement of machine analysis task(s), or any other purpose where the goal is to obtain a gain in terms of one or more metrics. In the set of actual gains associated to a certain postfilter or to the postfilters in a certain group of postfilters, there may be one or more actual gains associated to that postfilter or to the postfilters in that group of postfilters, where different actual gains may be expressed in terms of different metrics.

When the signalled information comprises one or more actual gains associated to all the postfilters in the group of postfilters, each of the one or more actual gains may be referred to also as a combined actual gain or an actual group gain, and it indicates the actual gain of using all the associated post-processing filters.

An actual gain represents a gain which is actually obtained by a receiver when using the associated post-processing filter on at least one picture or other data unit (e.g., CTU) of the video sequence for which the postfilter is activated. However, as the actual gain may be computed at encoding side based on a slightly different process than at receiver side (e.g., using different size of the input to the postfilters), it is to be understood that there may be still some differences between the signalled actual gain and the gain which is obtained at receiver side.

At least some of the examples provided for the expected gain are applicable to the actual gain, such as the syntax tables and related semantics.

The following is an example syntax table for the case where the signalled information comprises one set of actual gains associated to all the postfilters in the group of postfilters, where the set comprises one combined actual gain (or, using a different terminology, one actual group gain):

| | Descriptor |
|---|---|
| postfilter_group( payloadSize ) { | |
| pfg_id | ue(v) |
| pfg_num_elements_minus2 | ue(v) |
| pfg_usage_idc | ue(v) |
| pfg_actual_group_gain_present_flag | u(1) |
| if(pfg_actual_group_gain_present_flag ) | |
| pfg_actual_group_gain_metric | ue(v) |
| pfg_actual_group_gain | ue(v) |
| for( i= 0; i <= pfg_num_elements_minus2 + 1; i++ ) | |
| pfg_group_element_type[ i ] | u(1) |
| if(pfg_group_element_type[ i ] = = 0) | |
| nn_post_filter_characteristics( ) | ue(v) |
| else | |
| post_filter_group() | ue(v) |
| if(pfg_usage_idc = = 0) /* cascaded filters */ | |
| pfg_order[ i ] | ue(v) |
| if(pfg_usage_idc == 1) /* parallel filters with | |
| combined outputs */ | |
| pfg_comb_coeff[ i ] | ue(v) |
| ... | |
| } | |

Where pfg_actual_group_gain_present_flag indicates whether a combined actual gain is present for the group of postfilters comprised or referred to in this PFG SEI message, pfg_actual_group_gain_metric indicates the metric in terms of which the combined actual gain is expressed, pfg_actual_group_gain indicates the combined actual gain for the group of postfilters comprised or referred to in this PFG SEI message.

The actual gain which is obtainable for the data units (e.g., CTU, or pictures, etc.) on which the postfilters are applied may be signalled in an activation SEI message. The following is an example syntax table.

| | Descriptor |
|---|---|
| nn_multi_post_filter_activation( payloadSize ) { | |
| nnmpfa_num_filters | ue(v) |
| nnmpfa_actual_gain_present_flag | u(1) |
| if(nnmpfa_actual_gain_present_flag ) { | |
| nnmpfa_actual_gain_metric | ue(v) |
| nnmpfa_actual_gain | ue(v) |
| } | |
| for( i = 0; i <= nnmpfa_num_filters + 1; i++ ) | |
| nnmpfa_target_id[ i ] | ue(v) |
| nnmpfa_cancel_flag | u(1) |
| if( !nnmpfa_cancel_flag ) { | |
| nnmpfa_persistence_flag | u(1) |
| ... | |
| } | |

Where nnmpfa_actual_gain_present_flag indicates whether an actual gain is present, nnmpfa_actual_gain indicates the actual gain, nnmpfa_actual_gain_metric indicates the metric in terms of which the actual gain indicated by nnmpfa_actual_gain is expressed, nnmpfa_target_id identifies a postfilter, nnmpfa_cancel_flag indicates whether this SEI message cancels the persistence of the multiple postfilters identified by nnmpfa_target_id, nnmpfa_persistence_flag indicates the persistence of the multiple postfilters identified by nnmpfa_target_id.

Indicating Two or More Postfilters with Same Purpose, Applied Separately

In one embodiment, the signalled information may comprise one or more filter identifiers (filter IDs) that identify respective one or more post-processing filters with the same purpose, where only one of the identified one or more post-processing filters is used or activated for any input picture. The signalled information may indicate or may be considered to imply for a decoder that either all of the identified one or more post-processing filters are intended to be applied as activated or none of them are intended to be applied. In an additional embodiment, the signalled information may comprise an indication that a portion of the properties of the identified one or more post-processing filters are shared (i.e., in common) for all of them.

In one embodiment, a postfilter group SEI message may comprise all the postfilters that are to be used for the video sequence associated to that PFG SEI message, even if two or more of those postfilters are not used for the same picture or same data unit. For example, for a video sequence, four different postfilters may be used for different pictures (i.e., a certain picture may be filtered only by one postfilter).

In this embodiment, the PFG SEI message may comprise signalling information that indicates an expected gain that is obtainable when using the postfilters for different data items.

The following is an example syntax table for this embodiment:

| | Descriptor |
|---|---|
| postfilter_group( payloadSize ) { | |
| pfg_num_filters_minus2 | ue(v) |
| pfg_usage_idc | ue(v) |
| pfg_expected_group_gain_present_flag | u(1) |
| if(pfg_expected_group_gain_present_flag ) | |
| pfg_expected_group_gain_type_idc | ue(v) |
| pfg_expected_group_gain_metric | ue(v) |
| pfg_expected_group_gain | ue(v) |
| for( i = 0; i <= pfg_num_filters_minus2 + 1; i++ ) | |
| pfg_filter_id[ i ] | ue(v) |
| } | |

A new value may be defined for pfg_usage_idc:

| pfg_usage_idc | Interpretation |
|---|---|
| 0 | Cascaded filters |
| 1 | Alternative filters |
| 2 | Parallel filters with combined outputs |
| 3 | Parallel filters without combination of outputs |
| 4 | Separately applied filters |

In one embodiment, a postfilter group SEI message may comprise all the postfilters that are to be used for the video sequence associated to that PFG SEI message, even if two or more of those postfilters are not used for the same picture or same data unit. For example, for a video sequence, four different postfilters may be used for different pictures (i.e., a certain picture may be filtered only by one postfilter).

In this embodiment, the PFG SEI message may comprise signalling information that indicates an actual gain that is obtainable when using the postfilters for different data items.

The following is an example syntax table for this embodiment:

| | Descriptor |
|---|---|
| postfilter_group( payloadSize ) { | |
| pfg_num_filters_minus2 | ue(v) |
| pfg_usage_idc | ue(v) |
| pfg_actual_group_gain_present_flag | u(1) |
| if(pfg_actual_group_gain_present_flag ) | |
| pfg_actual_group_gain_type_idc | ue(v) |
| pfg_actual_group_gain_metric | ue(v) |
| pfg_actual_group_gain | ue(v) |
| for( i = 0; i <= pfg_num filters_minus2 + 1; i++) | |
| pfg_filter_id[ i ] | ue(v) |
| } | |

A new value may be defined for pfg_usage_idc:

| pfg_usage_idc | Interpretation |
|---|---|
| 0 | Cascaded filters |
| 1 | Alternative filters |
| 2 | Parallel filters with combined outputs |
| 3 | Parallel filters without combination of outputs |
| 4 | Separately applied filters |

### Session Setup Related Embodiments

In an embodiment, an entity, such as an encoder, a file writer, a server, a media mixer, a conference control unit, or alike, creates one or more SEI prefix indications in or along a video bitstream, wherein the SEI prefix indication(s) comprise an initial part or an entire syntax structure of an SEI message that indicates characteristics of a group of postfilters. For example, the SEI prefix indication(s) may comprise an initial part of or an entire postfilter_group( ) syntax structure or an NNPFC SEI message that describes a group of postfilters according to any embodiment.

In an embodiment, a SEI prefix indication comprises a SEI manifest SEI message comprising one or more SEI prefix indication SEI messages.

In an embodiment, a SEI prefix indication comprises a SEI prefix indication SEI message.

In an embodiment, a SEI prefix indication comprises an indicated number of initial bytes of any SEI message. For example, it may be allowed that a sprop-sei parameter or alike contains a base64 string that represents either initial bytes or an entire SEI message.

In an additional embodiment, a SEI prefix indication comprises a SEI processing order SEI message, indicating a processing order for the group of postfilters in relation to processing related to other SEI messages.

In an embodiment, an entity creates one or more SEI prefix indications in or along a video bitstream to declare post-filter related properties of the bitstream. Such declarative indications may be used by clients or alike when selecting a bitstream to be received and/or decoded among bitstreams having different post-filter related properties.

In an embodiment, an entity (e.g., an encoder, a file writer, a sender, a server, a media mixer, or a conference control unit) creates one or more SEI prefix indications to indicate a capability to create a bitstream with the indicated post-filter related properties. Such capability indications may be interpreted to by clients or alike when selecting preferred capabilities for the bitstream to be received. For example, a capability of a sender may be indicated in an SDP offer to a receiver.

In an embodiment, an entity (e.g., a decoder, a file reader, a receiver, a media mixer, or a conference control unit) creates one or more SEI prefix indications to indicate a preference or a requirement on post-filter related properties for a bitstream to be received. Such preference or requirement indications may be interpreted to by senders or alike when encoding for the bitstream to be transmitted. For example, a capability of a receiver may be indicated in an SDP answer to a sender.

In an embodiment, an entity makes one or more SEI prefix indications available along a video bitstream, e.g., in a media description, such as SDP or DASH MPD. An SEI prefix indication may comprise a SEI prefix indication SEI message or may comprise an initial part or an entire syntax structure of one or more SEI messages, such as a post-filter related SEI messages. An SEI prefix indication may be, but is not limited to, one or more of the following:
One or more MIME media parameters. The MIME media parameter(s) may be encapsulated in an SDP parameter or in an attribute of a streaming manifest (e.g. DASH MPD) or alike. Separate or same MIME media parameter(s) may be used for declarative bitstream properties, encoding capabilities, and/or preferences or requirements for bitstream to be decoded.
One or more attributes, parameters, or alike of the media description. An attribute may for example be an attribute in DASH MPD.
One or more syntax elements or syntax structures in a file encapsulating a bitstream.

In an embodiment, a file writer or alike encapsulates a video bitstream that into a file that conforms to the ISO base media file format. File format storage options for storing SEI prefix indication that contain an initial part or an entire syntax structure of an SEI message that indicates characteristics of a group of postfilters may include one or more of the following:
Sample Entry. In this option, NN(s) are stored to metadata storage location of the file, e.g. in a MovieBox.
Non-VCL track samples. For enabling random access in playback, sync samples should be aligned among video track(s) containing data of the video bitstream and the non-VCL track. The same non-VCL track can be applied to different video tracks storing data of the same video bitstream or different video bitstreams via track referencing (‘tref’).
Samples of one or more video tracks containing data of the video bitstream.

In an embodiment, an entity (e.g., an encoder, a file writer, a sender, a server, a media mixer, or a conference control unit) includes one or more SEI prefix indications along a video bitstream, the SEI prefix indication(s) or alike comprising an SEI message that indicates characteristics of a group of postfilters. The characteristics comprise a purpose for the group of postfilters. Such SEI prefix indications enable clients or alike to determine the purpose of post-filtering and identify the neural network for post-filtering in order to determine whether the indicated purpose is preferred by the client or alike and whether the indicated neural network is supported by the client or alike.

In an embodiment, an entity (e.g., a decoder, a file reader, a receiver, a client, a media mixer, or a conference control unit) parses one or more SEI prefix indications along a video bitstream. SEI prefix indication(s) or alike may contain, and the entity parses, an SEI message that indicates characteristics of a group of postfilters, which comprise a description of complexity in terms of computational and/or other resources and/or a description of gain. The entity determines which group of postfilters can be executed by the entity (in terms of computational and/or other resources) and/or provides a highest gain and/or provides a suitable tradeoff between the complexity and gain. In an embodiment, the entity indicates its preference or requirement in a SEI prefix indication and transmits the indication.

In an embodiment, a client or alike (e.g., a decoder, a file reader, or a player) obtains a SEI prefix indication from or along a video bitstream, the SEI prefix indication comprising an SEI message that indicates characteristics of a group of postfilters. The client or alike decodes the SEI prefix indication. Based on the decoded SEI prefix indication, the client or alike decides one or more of the following: i) whether to fetch the video bitstream, ii) which NNPFC SEI messages are fetched (if any), iii) which NN(s) referenced by NNPFC SEI message(s) are fetched. For example, a SEI prefix indication may be obtained from an Initialization Segment of a Representation of a non-VCL track. If the purpose indicated in the SEI prefix indication matches the client's need or task, the client may determine to fetch the Representation of the non-VCL track that contains the respective NNPFC SEI messages for the group of postfilters.

In an example, there are resolution upsampling NNPFs and picture rate upsampling NNPFs that are trained to be applied in cascade for certain QP ranges: NNPF group 1: resolution upsampling NNPF 1 followed by picture rate upsampling NNPF 2, trained for QP range 1; NNPF group 2: resolution upsampling NNPF 3 followed by picture rate upsampling NNPF 4, trained for QP range 2. For any set of input pictures, only one of the above-described NNPF groups is activated. Consequently, it is asserted that with the above-described embodiments, the following can be achieved:
The complexity and/or gain of the NNPF group that is activated at the same time can be indicated in or along the bitstream. This may be important at session setup or negotiation for determining whether a bitstream with NNPFs can be processed or which one of the multiple alternative bitstreams with NNPFs is suitable for the computational and/or memory capability of the receiver. Moreover, it may be important for determining if an additional gain provided by a more complex second NNPF group justifies its usage compared to the gain of a first NNPF group.
When a second NNPF follows a first NNPF in the intended processing order, the embodiments enable signaling that the second NNPF is to be applied only when the first NNPF is applied first.

It is to be understood that, in this description, the terms “picture”, “image”, and “frame” may be used interchangeably.

It is to be understood that, in this description, the terms “machine vision”, “machine vision task”, “machine task”, “machine analysis”, “machine analysis task”, “computer vision”, “computer vision task”, “task network” and “task” may be used interchangeably.

It is to be understood that, in this description, the terms “machine consumption” and “machine analysis” may be used interchangeably.

It is to be understood that, in this description, the terms “machine-consumable” and “machine-targeted” may be used interchangeably.

It is to be understood that, in this description, the terms “user viewing”, “human observation”, “human perception”, “displaying”, “displaying to human beings”, “watching”, and “watching by human beings” may be used interchangeably.

It is to be understood that, in this description, the term “subjective” may imply “human perception”.

It is to be understood that, in this description, the terms “post-filter”, “post-processing filter” and “postprocessing filter” may be used interchangeably.

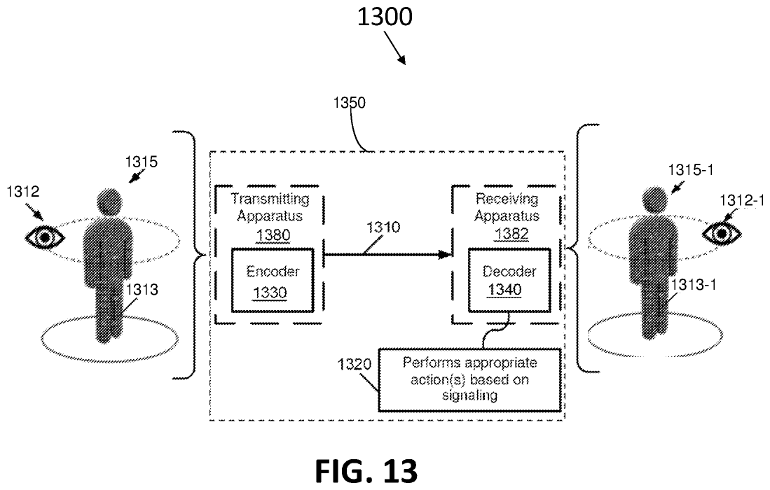

FIG. 13 is a block diagram illustrating a system 1300 in accordance with an example. In the example, the encoder 1330 is used to encode video from the scene 1315, and the encoder 1330 is implemented in a transmitting apparatus 1380. The encoder 1330 produces a bitstream 1310 comprising signaling that is received by the receiving apparatus 1382, which implements a decoder 1340. The encoder 1330 sends the bitstream 1310 that comprises the herein described signaling. The decoder 1340 forms the video for the scene 1315-1, and the receiving apparatus 1382 would present this to the user, e.g., via a smartphone, television, or projector among many other options.

In some examples, the transmitting apparatus 1380 and the receiving apparatus 1382 are at least partially within a common apparatus, and for example are located within a common housing 1350. In other examples the transmitting apparatus 1380 and the receiving apparatus 1382 are at least partially not within a common apparatus and have at least partially different housings. Therefore in some examples, the encoder 1330 and the decoder 1340 are at least partially within a common apparatus, and for example are located within a common housing 1350. For example the common apparatus comprising the encoder 1330 and decoder 1340 implements a codec. In other examples the encoder 1330 and the decoder 1340 are at least partially not within a common apparatus and have at least partially different housings, but when together still implement a codec.

3D media from the capture (e.g. volumetric capture) at a viewpoint 1312 of the scene 1315, which includes a human being 1313) is converted via projection to a series of 2D representations with occupancy, geometry, and attributes. Additional atlas information is also included in the bitstream to enable inverse reconstruction. For decoding, the received bitstream 1310 is separated into its components with atlas information; occupancy, geometry, and attribute 2D representations. A 3D reconstruction is performed to reconstruct the scene 1315-1 created looking at the viewpoint 1312-1 with a “reconstructed” human being 1313-1. The “−1” are used to indicate that these are reconstructions of the original. As indicated at 1320, the decoder 1340 performs an action or actions based on the received signaling.

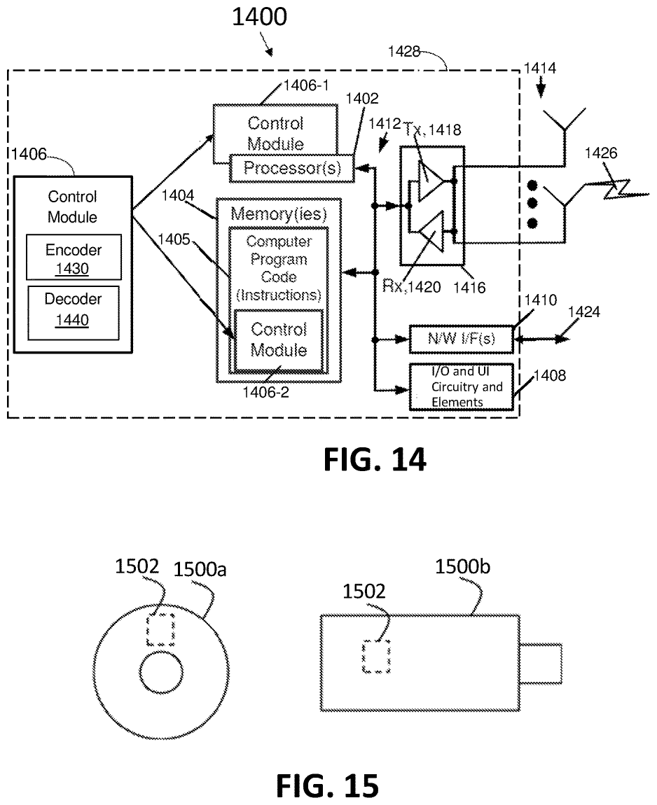

FIG. 14 is an example apparatus 1400, which may be implemented in hardware, configured to implement the examples described herein. The apparatus 1400 comprises at least one processor 1402 (e.g. an FPGA and/or CPU), one or more memories 1404 including computer program code 1405, the computer program code 1405 having instructions to carry out the methods described herein, wherein the at least one memory 1404 and the computer program code 1405 are configured to, with the at least one processor 1402, cause the apparatus 1400 to implement circuitry, a process, component, module, or function (implemented with control module 1406) to implement the examples described herein, including a method for negotiation of a conversational immersive audio session. Encoder 1430 of the control module 1406 performs encoding, and decoder 1440 implements decoding. The memory 1404 may be a non-transitory memory, a transitory memory, a volatile memory (e.g. RAM), or a non-volatile memory (e.g. ROM).

The apparatus 1400 includes a display and/or I/O interface 1408, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1400 includes one or more communication e.g. network (N/W) interfaces (I/F(s)) 1410. The communication I/F(s) 1410 may be wired and/or wireless and communicate over the Internet/other network(s) via any communication technique including via one or more links 1424. The communication I/F(s) 1410 may comprise one or more transmitters or one or more receivers.

The transceiver 1416 comprises one or more transmitters 1418 and one or more receivers 1420. The transceiver 1416 and/or communication I/F(s) 1410 may comprise standard well-known components such as an amplifier, filter, frequency-converter, (de) modulator, and encoder/decoder circuitries and one or more antennas, such as antennas 1414 used for communication over wireless link 1426.

The control module 1406 of the apparatus 1400 comprises one of or both parts 1406-1 and/or 1406-2, which may be implemented in a number of ways. The control module 1406 may be implemented in hardware as control module 1406-1, such as being implemented as part of the one or more processors 1402. The control module 1406-1 may be implemented also as an integrated circuit or through other hardware such as a programmable gate array. In another example, the control module 1406 may be implemented as control module 1406-2, which is implemented as computer program code (having corresponding instructions) 1405 and is executed by the one or more processors 1402. For instance, the one or more memories 1404 store instructions that, when executed by the one or more processors 1402, cause the apparatus 1400 to perform one or more of the operations as described herein. Furthermore, the one or more processors 1402, one or more memories 1404, and example algorithms (e.g., as flowcharts and/or signaling diagrams), encoded as instructions, programs, or code, are means for causing performance of the operations described herein.

The apparatus 1400 to implement the functionality of control 1406 may correspond to any of the apparatuses depicted herein. Alternatively, apparatus 1400 and its elements may not correspond to any of the other apparatuses depicted herein, as apparatus 1400 may be part of a self-organizing/optimizing network (SON) node or other node, such as a node in a cloud.

The apparatus 1400 may also be distributed throughout the network (e.g. internet 28) including within and between apparatus 1400 and any network element (such as a base station 24 and/or apparatus 50).

Interface 1412 enables data communication and signaling between the various items of apparatus 1400, as shown in FIG. 14. For example, the interface 1412 may be one or more buses such as address, data, or control buses, and may include any interconnection mechanism, such as a series of lines on a motherboard or integrated circuit, fiber optics or other optical communication equipment, and the like. Computer program code (e.g. instructions) 1405, including control 1406 may comprise object-oriented software configured to pass data or messages between objects within computer program code 1405. The apparatus 1400 need not comprise each of the features mentioned, or may comprise other features as well. The various components of apparatus 1400 may at least partially reside in a common housing 1428, or a subset of the various components of apparatus 1400 may at least partially be located in different housings, which different housings may include housing 1428.

FIG. 15 shows a schematic representation of non-volatile memory media 1500a (e.g. computer/compact disc (CD) or digital versatile disc (DVD)) and 1500b (e.g. universal serial bus (USB) memory stick) storing instructions and/or parameters 1502 which when executed by a processor allows the processor to perform one or more of the steps of the methods described herein.

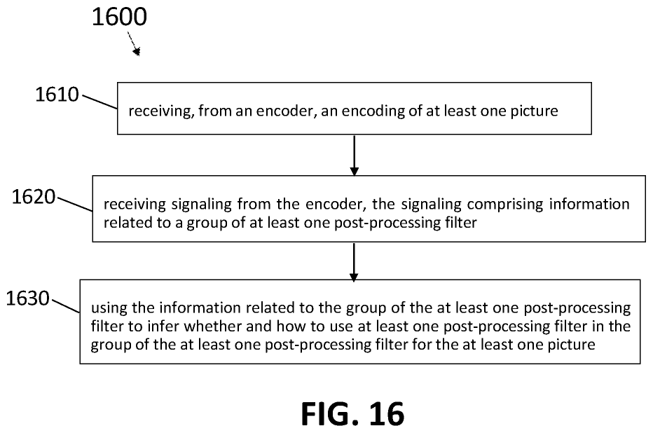

FIG. 16 is an example method 1600 performed with a decoder, based on the example embodiments described herein. At 1610, the method includes receiving, from an encoder, an encoding of at least one picture. At 1620, the method includes receiving signaling from the encoder, the signaling comprising information related to a group of at least one post-processing filter. At 1630, the method includes using the information related to the group of the at least one post-processing filter to infer whether and how to use at least one post-processing filter in the group of the at least one post-processing filter for the at least one picture. Method 1600 may be performed with a decoding apparatus, such as apparatus 50, apparatuses depicted in FIG. 3 and FIG. 4, receiving apparatus 1382 with decoder 1340, or apparatus 1400 with decoder 1440.

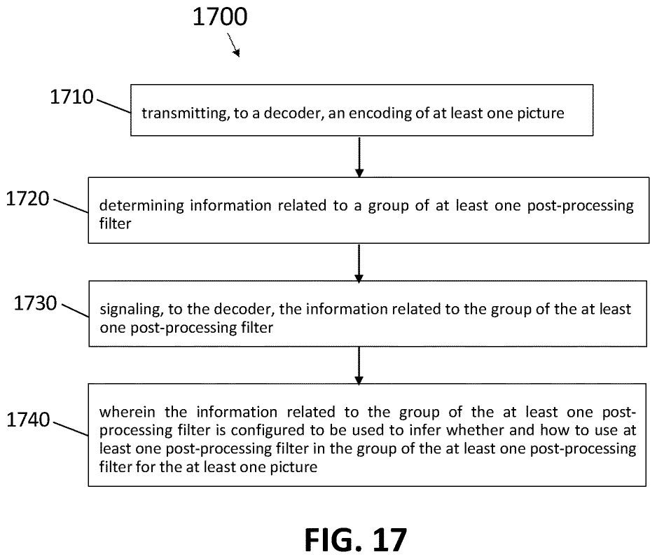

FIG. 17 is an example method 1700 performed with an encoder, based on the example embodiments described herein. At 1710, the method includes transmitting, to a decoder, an encoding of at least one picture. At 1720, the method includes determining information related to a group of at least one post-processing filter. At 1730, the method includes signaling, to the decoder, the information related to the group of the at least one post-processing filter. At 1740, the method includes wherein the information related to the group of the at least one post-processing filter is configured to be used to infer whether and how to use at least one post-processing filter in the group of the at least one post-processing filter for the at least one picture. Method 1700 may be performed with an encoding apparatus, such as apparatus 50, apparatuses depicted in FIG. 3 and FIG. 4, transmitting apparatus 1380 with encoder 1330, or apparatus 1400 with encoder 1430.

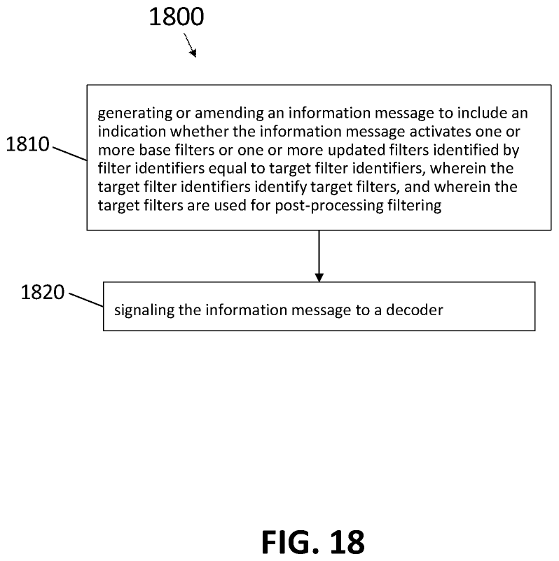

FIG. 18 is another example method 1800 performed with an encoder, based on the example embodiments described herein. At 1810, the method includes generating or amending an information message to include an indication whether the information message activates one or more base filters or one or more updated filters identified by filter identifiers equal to target filter identifiers, wherein the target filter identifiers identify target filters, and wherein the target filters are used for post-processing filtering. At 1820, the method includes signaling the information message to a decoder. Method 1800 may be performed with an encoding apparatus, such as apparatus 50, apparatuses depicted in FIG. 3 and FIG. 4, transmitting apparatus 1380 with encoder 1330, or apparatus 1400 with encoder 1430.

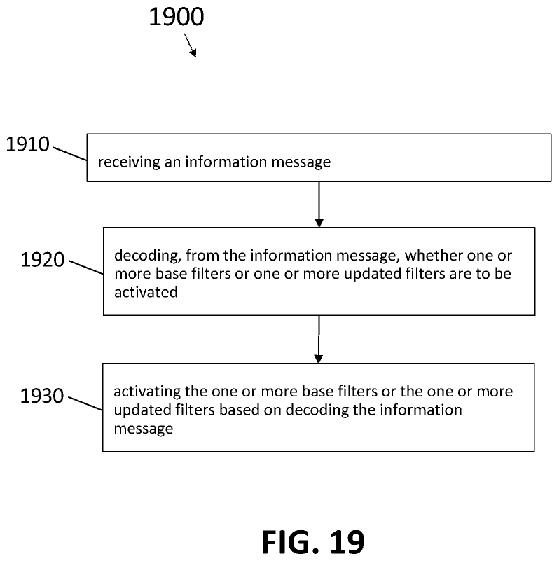

FIG. 19 is another example method 1900 performed with an decoder, based on the example embodiments described herein. At 1910, the method includes receiving an information message. At 1920, the method includes decoding, from the information message, whether one or more base filters or one or more updated filters are to be activated. At 1930, the method includes activating the one or more base filters or the one or more updated filters based on decoding the information message. Method 1900 may be performed with a decoding apparatus, such as apparatus 50, apparatuses depicted in FIG. 3 and FIG. 4, receiving apparatus 1382 with decoder 1340, or apparatus 1400 with decoder 1440.

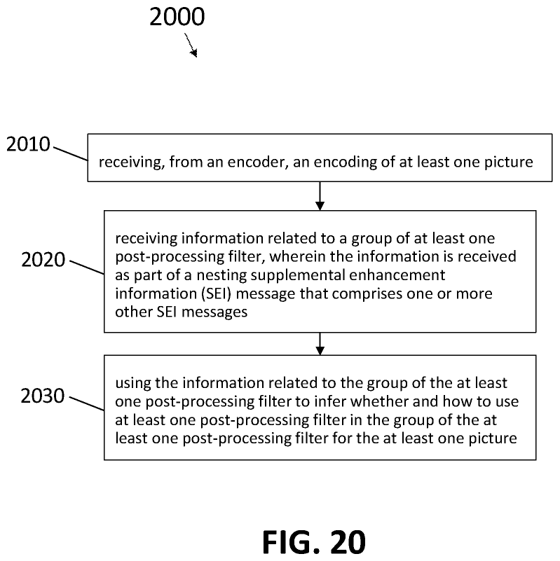

FIG. 20 is yet another example method 2000 performed with an decoder, based on the example embodiments described herein. At 2010, the method includes receiving, from an encoder, an encoding of at least one picture. At 2020, the method includes receiving information related to a group of at least one post-processing filter, wherein the information is received as part of a nesting supplemental enhancement information (SEI) message that comprises one or more other SEI messages. At 2030 the method includes using the information related to the group of the at least one post-processing filter to infer whether and how to use at least one post-processing filter in the group of the at least one post-processing filter for the at least one picture. Method 2000 may be performed with a decoding apparatus, such as apparatus 50, apparatuses depicted in FIG. 3 and FIG. 4, receiving apparatus 1382 with decoder 1340, or apparatus 1400 with decoder 1440.

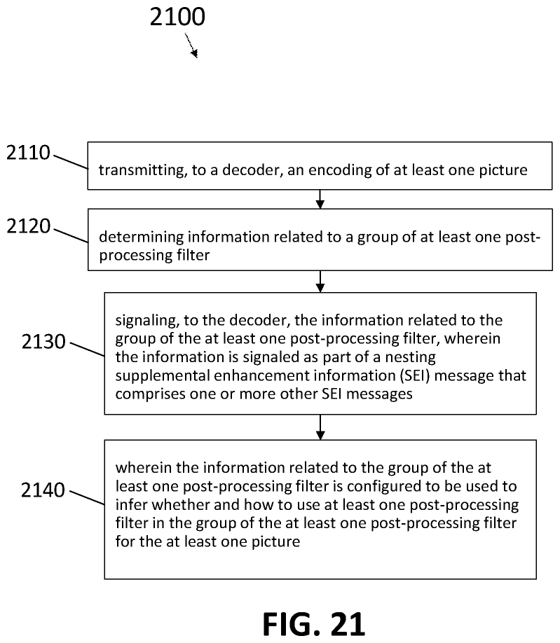

FIG. 21 is yet another example method 2100 performed with an encoder, based on the example embodiments described herein. At 2110, the method includes transmitting, to a decoder, an encoding of at least one picture. At 2120, the method includes determining information related to a group of at least one post-processing filter. At 2130, the method includes and signaling, to the decoder, the information related to the group of the at least one post-processing filter, wherein the information is signaled as part of a nesting supplemental enhancement information (SEI) message that comprises one or more other SEI messages. At 2140, the method includes wherein the information related to the group of the at least one post-processing filter is configured to be used to infer whether and how to use at least one post-processing filter in the group of the at least one post-processing filter for the at least one picture. Method 2100 may be performed with an encoding apparatus, such as apparatus 50, apparatuses depicted in FIG. 3 and FIG. 4, transmitting apparatus 1380 with encoder 1330, or apparatus 1400 with encoder 1430.

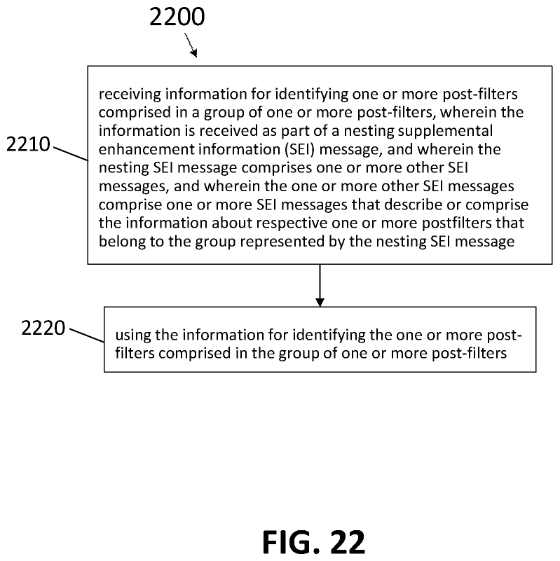

FIG. 22 is still another example method 2200 performed with an decoder, based on the example embodiments described herein. At 2210, the method includes receiving information for identifying one or more post-filters comprised in a group of one or more post-filters, wherein the information is received as part of a nesting supplemental enhancement information (SEI) message, and wherein the nesting SEI message comprises one or more other SEI messages, and wherein the one or more other SEI messages comprise one or more SEI messages that describe or comprise the information about respective one or more postfilters that belong to the group represented by the nesting SEI message. At 2220, the method includes using the information for identifying the one or more post-filters comprised in the group of one or more post-filters. Method 2000 may be performed with a decoding apparatus, such as apparatus 50, apparatuses depicted in FIG. 3 and FIG. 4, receiving apparatus 1382 with decoder 1340, or apparatus 1400 with decoder 1440.

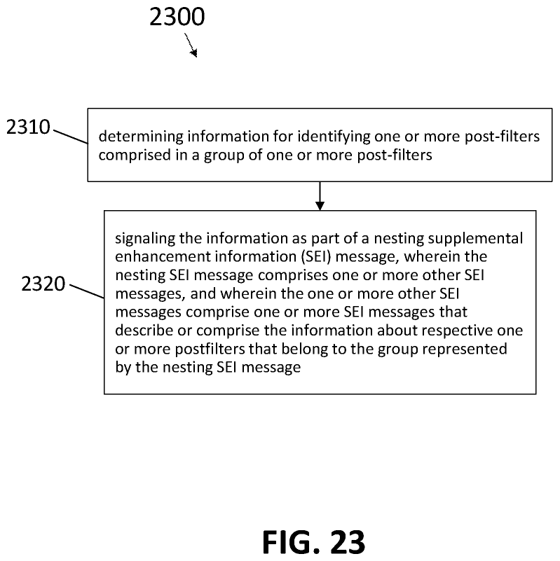

FIG. 23 is still another example method 2300 performed with an encoder, based on the example embodiments described herein. At 2310, the method includes determining information for identifying one or more post-filters comprised in a group of one or more post-filters. At 2320, the method includes and signaling the information as part of a nesting supplemental enhancement information (SEI) message, wherein the nesting SEI message comprises one or more other SEI messages, and wherein the one or more other SEI messages comprise one or more SEI messages that describe or comprise the information about respective one or more postfilters that belong to the group represented by the nesting SEI message. Method 2300 may be performed with an encoding apparatus, such as apparatus 50, apparatuses depicted in FIG. 3 and FIG. 4, transmitting apparatus 1380 with encoder 1330, or apparatus 1400 with encoder 1430.

The following examples are provided and described herein.

Example 1. An apparatus including: at least one processor; and at least one memory storing instructions that, when executed by the at least one processor, causes the apparatus at least to: receive, from an encoder, an encoding of at least one picture; receive signaling from the encoder, the signaling comprising information related to a group of at least one post-processing filter; and use the information related to the group of the at least one post-processing filter to infer whether and how to use at least one post-processing filter in the group of the at least one post-processing filter for the at least one picture.

Example 2. The apparatus of example 1, wherein the group of the at least one post-processing filter comprises a plurality of post-processing filters.

Example 3. The apparatus of any of examples 1 to 2, wherein the signaled information is part of a supplemental enhancement information message.

Example 4. The apparatus of example 3, wherein the supplemental enhancement information message comprises at least one other supplemental enhancement information message.

Example 5. The apparatus of example 4, wherein the at least one other supplemental enhancement information message comprises at least one neural network post-filter characteristics supplemental enhancement information message that describes at least one characteristic of the at least one post-processing filter comprised in the group of the at least one post-processing filter.

Example 6. The apparatus of any of examples 3 to 5, wherein the supplemental enhancement information message describes characteristics of the group of the at least one post-processing filter.

Example 7. The apparatus of example 6, wherein a mode indicator value in the supplemental enhancement information message indicates that the supplemental enhancement information message describes characteristics of the group of the at least one post-processing filter rather than a single post-processing filter.

Example 8. The apparatus of any of examples 3 to 7, wherein the supplemental enhancement information message activates the group of the at least one post-processing filter.

Example 9. The apparatus of any of examples 3 to 8, wherein the supplemental enhancement information message activates a second post-processing filter in the group of the at least one post-processing filter, identifies a first post-processing filter in the group of the at least one post-processing filter, and indicates that at least one input picture to the second post-processing filter comprises at least one output picture resulting from the first post-processing filter.

Example 10. The apparatus of any of examples 3 to 9, wherein the supplemental enhancement information message: describes a second post-processing filter in the group of the at least one post-processing filter, identifies a first post-processing filter in the group of the at least one post-processing filter, and indicates that at least one input picture to the second post-processing filter comprises at least one output picture resulting from the first post-processing filter.

Example 11. The apparatus of any of examples 1 to 10, wherein the signaled information comprises at least one filter identifier that identifies the at least one post-processing filter comprised in the group of the at least one post-processing filter.

Example 12. The apparatus of any of examples 1 to 11, wherein the signaled information indicates how two or more post-processing filters comprised in the group of the at least one post-processing filter are to be used.

Example 13. The apparatus of example 12, wherein the instructions, when executed by the at least one processor, cause the apparatus at least to: use the two or more post-processing filters in cascade for the at least one picture of a video sequence; wherein the signaled information indicates that the two or more post-processing filters are to be used in cascade, for the at least one picture of the video sequence.

Example 14. The apparatus of example 13, wherein the instructions, when executed by the at least one processor, cause the apparatus at least to: use the two or more post-processing filters in cascade in an order for the at least one picture of the video sequence; wherein the signaled information comprises an indication of the order for the two or more post-processing filters to be used in cascade.

Example 15. The apparatus of any of examples 12 to 14, wherein the instructions, when executed by the at least one processor, cause the apparatus at least to: select at least one of the two or more post-processing filters for use, based on at least one criterion and/or availability of at least one resource; wherein the at least one criterion comprises complexity of the two or more post-processing filters, expected gain, actual gain, spatial and/or temporal upsampling factor, or use of one or more auxiliary inputs; wherein the signaled information comprises an indication that the two or more post-processing filters are alternatives, for the at least one picture of a video sequence.

Example 16. The apparatus of example 15, wherein the signaled information comprises an indication of at least one difference among the two or more post-processing filters.

Example 17. The apparatus of example 16, wherein the at least one difference is based on at least one of: a complexity of the two or more post-processing filters, one of the two or more post-processing filters being used to improve subjective visual quality and another one of the two or more post-processing filters being used to improve objective visual quality, an expected or actual gain provided by the two or more post-processing filters, or one of the two or more post-processing filters taking a first set of auxiliary inputs and another one of the two or more post-processing filters taking a second set of auxiliary inputs.

Example 18. The apparatus of any of examples 12 to 17, wherein the instructions, when executed by the at least one processor, cause the apparatus at least to: use common data or substantially the same data as at least one input of the two or more post-processing filters, for the at least one picture of a video sequence; wherein the signaled information comprises an indication that the at least one input of the two or more post-processing filters comprises the common data or substantially the same data, for the at least one picture of the video sequence.

Example 19. The apparatus of any of examples 12 to 18, wherein the instructions, when executed by the at least one processor, cause the apparatus at least to: combine an output of one of the two or more post-processing filters with an output of another one of the two or more post-processing filters based at least on a combination operation, for the at least one picture of a video sequence; wherein the signaled information comprises an indication that the output of the one of the two or more post-processing filters is to be combined with the output of the another one of the two or more post-processing filters, for the at least one picture of the video sequence.

Example 20. The apparatus of example 19, wherein the signaled information comprises an indication of the combination operation.

Example 21. The apparatus of any of examples 19 to 20, wherein the instructions, when executed by the at least one processor, cause the apparatus at least to: use at least one coefficient for performing the combination operation; wherein the signaled information comprises an indication of the at least one coefficient for performing the combination operation.

Example 22. The apparatus of any of examples 19 to 21, wherein the signaled information comprises an indication that the output of the one of the two or more post-processing filters is to be combined with the output of the another one of the two or more post-processing filters based at least on the combination operation, for the at least one picture of the video sequence.

Example 23. The apparatus of any of examples 12 to 22, wherein the instructions, when executed by the at least one processor, cause the apparatus at least to: use, for the at least one picture of a video sequence, an output of one post-processing filter of the two or more post-processing filters for one purpose; use, for the at least one picture of the video sequence, an output of another post-processing filter of the two or more post-processing filters for another purpose; wherein the one post-processing filter and the another post-processing filter take common data as input; wherein the signaled information comprises an indication that, for the at least one picture of the video sequence, the one post-processing filter and the another post-processing filter take the common data as input, and that an output of the one post-processing filter is used for the one purpose, and that the output of the another post-processing filter is used for the another purpose.

Example 24. The apparatus of any of examples 1 to 23, wherein the instructions, when executed by the at least one processor, cause the apparatus at least to: use the at least one post-processing filter for a task comprising a goal to obtain a gain in terms of at least one metric; wherein the signaled information comprises at least one set of at least one expected gain associated to a respective at least one post-processing filter in the group of the at least one post-processing filter, or comprises one set of at least one expected gain associated to the at least one post-processing filter in the group of the at least one post-processing filter, when the at least one post-processing filter is used for the task comprising the goal to obtain the gain in terms of at least one metric.

Example 25. The apparatus of example 24, wherein the task comprises visual enhancement.

Example 26. The apparatus of any of examples 24 to 25, wherein the at least one expected gain is determined during or after a development stage of the at least one post-processing filter, based at least on a performance of the at least one post-processing filter on a validation dataset.

Example 27. The apparatus of any of examples 24 to 26, where different expected gains within the at least one set of the at least one expected gain or within the one set of the at least one expected gain are expressed within the signaled information in terms of different metrics.

Example 28. The apparatus of any of examples 24 to 27, wherein the task comprises enhancement of at least one machine analysis task.

Example 29. The apparatus of any of examples 1 to 28, wherein the instructions, when executed by the at least one processor, cause the apparatus at least to: use the at least one post-processing filter for a task comprising a goal to obtain a gain in terms of at least one metric; wherein the signaled information comprises at least one set of at least one actual gain associated to a respective at least one post-processing filter in the group of the at least one post-processing filter, or comprises one set of at least one actual gain associated to the at least one post-processing filter in the group of the at least one post-processing filter, when the at least one post-processing filter is used for the task comprising the goal to obtain the gain in terms of the at least one metric.

Example 30. The apparatus of example 29, wherein the task comprises visual enhancement.

Example 31. The apparatus of any of examples 29 to 30, where different actual gains within the at least one set of the at least one actual gain or within the one set of the at least one actual gain are expressed within the signaled information in terms of different metrics.

Example 32. The apparatus of any of examples 29 to 31, wherein the instructions, when executed by the at least one processor, cause the apparatus at least to: determine the at least one actual gain based on using the at least one post-processing filter on the at least one picture or other data unit of a video sequence for which the at least one post-processing filter is activated.

Example 33. The apparatus of any of examples 29 to 32, wherein the task comprises enhancement of at least one machine analysis task.

Example 34. The apparatus of any of examples 1 to 33, wherein the signaled information comprises at least one filter identifier that identifies two or more post-processing filters used for a common purpose.

Example 35. The apparatus of example 34, wherein the instructions, when executed by the at least one processor, cause the apparatus to: activate or use one of the two or more post-processing filters for the common purpose for the at least one picture; and deactivate or not use another one of the two or more post-processing filters for the common purpose for the at least one picture; wherein the signaled information comprises an indication that the one of the two or more post-processing filters are to be activated or used for the common purpose for the at least one picture, and that the another one of the two or more post-processing filters are to be deactivated or not used for the common purpose for the at least one picture.

Example 36. The apparatus of any of examples 34 to 35, wherein the signaled information explicitly or implicitly indicates to the decoder that one of: the two or more post-processing filters are activated or used for the common purpose for the at least one picture, or the two or more post-processing filters are deactivated or not used for the common purpose for the at least one picture.

Example 37. The apparatus of example 36, wherein the instructions, when executed by the at least one processor, cause the apparatus to: activate or use the two or more post-processing filters for the common purpose for the at least one picture, based on the explicit or implicit signaled information; or deactivate or not use the two or more post-processing filters for the common purpose for the at least one picture, based on the explicit or implicit signaled information.

Example 38. The apparatus of any of examples 34 to 37, wherein the signaled information indicates that a portion of at least one property of the two or more post-processing filters are shared or in common for the two or more post-processing filters.

Example 39. The apparatus of any of examples 1 to 38, wherein the at least one post-processing filter is a neural network based post-processing filter.

Example 40. The apparatus of any of examples 1 to 39, wherein the signaled information is signaled in-band with respect to encoded content.

Example 41. The apparatus of any of examples 1 to 40, wherein the signaled information is signaled out-of-band with respect to encoded content.

Example 42. The apparatus of any of examples 1 to 41, wherein the signaled information comprises at least one of: a flag that indicates whether combination coefficients are present in the signaled information, the combination coefficients used to combine two or more outputs of respective two or more post-processing filters; a flag that indicates whether two or more post-processing filters identified with a filter identifier are to be run in parallel and their output combined, or an array of combination coefficients indexed by a respective identifier of the at least one post-processing filter, the array of combination coefficients indicating at least one combination coefficient to be used for combining an output of the at least one post-processing filter based on a combination operation.

Example 43. An apparatus including: at least one processor; and at least one memory storing instructions that, when executed by the at least one processor, causes the apparatus at least to: transmit, to a decoder, an encoding of at least one picture; determine information related to a group of at least one post-processing filter; and signal, to the decoder, the information related to the group of the at least one post-processing filter; wherein the information related to the group of the at least one post-processing filter is configured to be used to infer whether and how to use at least one post-processing filter in the group of the at least one post-processing filter for the at least one picture.

Example 44. The apparatus of example 43, wherein the group of the at least one post-processing filter comprises a plurality of post-processing filters.

Example 45. The apparatus of any of examples 43 to 44, wherein the signaled information is part of a supplemental enhancement information message.

Example 46. The apparatus of example 45, wherein the supplemental enhancement information message comprises at least one other supplemental enhancement information message.

Example 47. The apparatus of example 46, wherein the at least one other supplemental enhancement information message comprises at least one neural network post-filter characteristics supplemental enhancement information message that describes at least one characteristic of the at least one post-processing filter comprised in the group of the at least one post-processing filter.

Example 48. The apparatus of any of examples 45 to 47, wherein the supplemental enhancement information message describes characteristics of the group of the at least one post-processing filter.

Example 49. The apparatus of example 48, wherein a mode indicator value in the supplemental enhancement information message indicates that the supplemental enhancement information message describes characteristics of the group of the at least one post-processing filter rather than a single post-processing filter.

Example 50. The apparatus of any of examples 45 to 49, wherein the supplemental enhancement information message activates the group of the at least one post-processing filter.

Example 51. The apparatus of any of examples 45 to 50, wherein the supplemental enhancement information message activates a second post-processing filter in the group of the at least one post-processing filter, identifies a first post-processing filter in the group of the at least one post-processing filter, and indicates that at least one input picture to the second post-processing filter comprises at least one output picture resulting from the first post-processing filter.

Example 52. The apparatus of any of examples 45 to 51, wherein the supplemental enhancement information message: describes a second post-processing filter in the group of the at least one post-processing filter, identifies a first post-processing filter in the group of the at least one post-processing filter, and indicates that at least one input picture to the second post-processing filter comprises at least one output picture resulting from the first post-processing filter.

Example 53. The apparatus of any of examples 43 to 52, wherein the signaled information comprises at least one filter identifier that identifies the at least one post-processing filter comprised in the group of the at least one post-processing filter.

Example 54. The apparatus of any of examples 43 to 53, wherein the signaled information indicates how two or more post-processing filters comprised in the group of the at least one post-processing filter are to be used.

Example 55. The apparatus of example 54, wherein the signaled information indicates that the two or more post-processing filters are to be used in cascade, for the at least one picture of a video sequence.

Example 56. The apparatus of example 55, wherein the signaled information comprises an indication of an order for the two or more post-processing filters to be used in cascade.

Example 57. The apparatus of any of examples 54 to 56, wherein: the signaled information comprises an indication that the two or more post-processing filters are alternatives, for the at least one picture of a video sequence; the signaled information is configured to cause the decoder to select at least one of the two or more post-processing filters for use, based on at least one criterion and/or availability of at least one resource; and the at least one criterion comprises complexity of the two or more post-processing filters, expected gain, actual gain, spatial and/or temporal upsampling factor, or use of one or more auxiliary inputs.

Example 58. The apparatus of example 57, wherein the signaled information comprises an indication of at least one difference among the two or more post-processing filters.

Example 59. The apparatus of example 58, wherein the at least one difference is based on at least one of: a complexity of the two or more post-processing filters, one of the two or more post-processing filters being used to improve subjective visual quality and another one of the two or more post-processing filters being used to improve objective visual quality, an expected or actual gain provided by the two or more post-processing filters, or one of the two or more post-processing filters taking a first set of auxiliary inputs and another one of the two or more post-processing filters taking a second set of auxiliary inputs.

Example 60. The apparatus of any of examples 54 to 59, wherein the signaled information comprises an indication that at least one input of the two or more post-processing filters comprises common data or substantially the same data, for the at least one picture of a video sequence.

Example 61. The apparatus of any of examples 54 to 60, wherein the signaled information comprises an indication that an output of one of the two or more post-processing filters is to be combined with an output of another one of the two or more post-processing filters, for the at least one picture of a video sequence.

Example 62. The apparatus of example 61, wherein the signaled information comprises an indication of a combination operation used to combine the output of the one of the two or more post-processing filters with the output of the another one of the two or more post-processing filters.

Example 63. The apparatus of example 62, wherein the signaled information comprises an indication of at least one coefficient for performing the combination operation.

Example 64. The apparatus of any of examples 61 to 63, wherein the signaled information comprises an indication that the output of the one of the two or more post-processing filters is to be combined with the output of the another one of the two or more post-processing filters based at least on a combination operation, for the at least one picture of a video sequence.

Example 65. The apparatus of any of examples 54 to 64, wherein the signaled information comprises an indication that, for the at least one picture of a video sequence, one post-processing filter of the two or more post-processing filters and another post-processing filter of the two or more post-processing filters take common data as input, and that an output of the one post-processing filter is used for one purpose, and that an output of the another post-processing filter is used for another purpose.

Example 66. The apparatus of any of examples 43 to 65, wherein the signaled information comprises at least one set of at least one expected gain associated to a respective at least one post-processing filter in the group of the at least one post-processing filter, or comprises one set of at least one expected gain associated to the at least one post-processing filter in the group of the at least one post-processing filter, when the at least one post-processing filter is used for a task comprising a goal to obtain a gain in terms of at least one metric.

Example 67. The apparatus of example 66, wherein the task comprises visual enhancement.

Example 68. The apparatus of any of examples 66 to 67, wherein the at least one expected gain is determined during or after a development stage of the at least one post-processing filter, based at least on a performance of the at least one post-processing filter on a validation dataset.

Example 69. The apparatus of any of examples 66 to 68, wherein the instructions, when executed by the at least one processor, cause the apparatus at least to: express, within the signaled information, different expected gains within the at least one set of the at least one expected gain or within the one set of the at least one expected gain in terms of different metrics.

Example 70. The apparatus of any of examples 66 to 69, wherein the task comprises enhancement of at least one machine analysis task.

Example 71. The apparatus of any of examples 43 to 70, wherein the signaled information comprises at least one set of at least one actual gain associated to a respective at least one post-processing filter in the group of the at least one post-processing filter, or comprises one set of at least one actual gain associated to the at least one post-processing filter in the group of the at least one post-processing filter, when the at least one post-processing filter is used for a task comprising a goal to obtain a gain in terms of at least one metric.

Example 72. The apparatus of example 71, wherein the task comprises visual enhancement.

Example 73. The apparatus of any of examples 71 to 72, wherein the instructions, when executed by the at least one processor, cause the apparatus at least to: express, within the signaled information, different actual gains within the at least one set of the at least one actual gain or within the one set of the at least one actual gain in terms of different metrics.

Example 74. The apparatus of any of examples 71 to 73, wherein the task comprises enhancement of at least one machine analysis task.

Example 75. The apparatus of any of examples 43 to 74, wherein the signaled information comprises at least one filter identifier that identifies two or more post-processing filters used for a common purpose.

Example 76. The apparatus of example 75, wherein the signaled information comprises an indication that one of the two or more post-processing filters are to be activated or used for the common purpose for the at least one picture, and that another one of the two or more post-processing filters are to be deactivated or not used for the common purpose for the at least one picture.

Example 77. The apparatus of any of examples 75 to 76, wherein the signaled information explicitly or implicitly indicates to the decoder that one of: the two or more post-processing filters are activated or used for the common purpose for the at least one picture, or the two or more post-processing filters are deactivated or not used for the common purpose for the at least one picture.

Example 78. The apparatus of example 77, wherein based on the explicit or implicit signaled information, the two or more post-processing filters are activated or used for the common purpose for the at least one picture, or the two or more post-processing filters are deactivated or not used for the common purpose for the at least one picture.

Example 79. The apparatus of any of examples 75 to 78, wherein the signaled information indicates that a portion of at least one property of the two or more post-processing filters are shared or in common for the two or more post-processing filters.

Example 80. The apparatus of any of examples 43 to 79, wherein the at least one post-processing filter is a neural network based post-processing filter.

Example 81. The apparatus of any of examples 43 to 80, wherein the signaled information is signaled in-band with respect to encoded content.

Example 82. The apparatus of any of examples 43 to 81, wherein the signaled information is signaled out-of-band with respect to encoded content.

Example 83. The apparatus of any of examples 43 to 82, wherein the instructions, when executed by the at least one processor, cause the apparatus at least to: determine a gain using the at least one post-processing filter on the at least one picture or other data unit of a video sequence for which the at least one post-processing filter is activated.

Example 84. The apparatus of any of examples 43 to 83, wherein the signaled information comprises at least one of: a flag that indicates whether combination coefficients are present in the signaled information, the combination coefficients used to combine two or more outputs of respective two or more post-processing filters; a flag that indicates whether two or more post-processing filters identified with a filter identifier are to be run in parallel and their output combined, or an array of combination coefficients indexed by a respective identifier of the at least one post-processing filter, the array of combination coefficients indicating at least one combination coefficient to be used for combining an output of the at least one post-processing filter based on a combination operation.

Example 85. A method including: receiving, from an encoder, an encoding of at least one picture; receiving signaling from the encoder, the signaling comprising information related to a group of at least one post-processing filter; and using the information related to the group of the at least one post-processing filter to infer whether and how to use at least one post-processing filter in the group of the at least one post-processing filter for the at least one picture.

Example 86. A method including: transmitting, to a decoder, an encoding of at least one picture; determining information related to a group of at least one post-processing filter; and signaling, to the decoder, the information related to the group of the at least one post-processing filter; wherein the information related to the group of the at least one post-processing filter is configured to be used to infer whether and how to use at least one post-processing filter in the group of the at least one post-processing filter for the at least one picture.

Example 87. An apparatus including: means for receiving, from an encoder, an encoding of at least one picture; means for receiving signaling from the encoder, the signaling comprising information related to a group of at least one post-processing filter; and means for using the information related to the group of the at least one post-processing filter to infer whether and how to use at least one post-processing filter in the group of the at least one post-processing filter for the at least one picture.

Example 88. An apparatus including: means for transmitting, to a decoder, an encoding of at least one picture; means for determining information related to a group of at least one post-processing filter; and means for signaling, to the decoder, the information related to the group of the at least one post-processing filter; wherein the information related to the group of the at least one post-processing filter is configured to be used to infer whether and how to use at least one post-processing filter in the group of the at least one post-processing filter for the at least one picture.

Example 89. A non-transitory program storage device readable by a machine, tangibly embodying a program of instructions executable by the machine for performing operations, the operations including: receiving, from an encoder, an encoding of at least one picture; receiving signaling from the encoder, the signaling comprising information related to a group of at least one post-processing filter; and using the information related to the group of the at least one post-processing filter to infer whether and how to use at least one post-processing filter in the group of the at least one post-processing filter for the at least one picture.

Example 90. A non-transitory program storage device readable by a machine, tangibly embodying a program of instructions executable by the machine for performing operations, the operations including: transmitting, to a decoder, an encoding of at least one picture; determining information related to a group of at least one post-processing filter; and signaling, to the decoder, the information related to the group of the at least one post-processing filter; wherein the information related to the group of the at least one post-processing filter is configured to be used to infer whether and how to use at least one post-processing filter in the group of the at least one post-processing filter for the at least one picture.

Example 91: An apparatus comprising: at least one processor; and at least one memory storing instructions that, when executed by the at least one processor, causes the apparatus at least to: generate or amend an information message to include an indication whether the information message activates one or more base filters or one or more updated filters identified by filter identifiers equal to target filter identifiers, wherein the target filter identifiers identify target filters, and wherein the target filters are used for post-processing filtering; and signal the information message to a decoder.

Example 92: The apparatus of example 91, wherein the apparatus is further caused to: determine whether the one or more base filters or the one or more updated filters are beneficial for filtering one or more consecutive pictures.

Example 93: The apparatus of example 92, wherein the apparatus is further caused to: filter the one or more consecutive pictures with the one or more base filters; filter the one or more consecutive pictures with the one or more updated filters; and select the one or more base filters or the one or more updated filters based on which one performs better with one or more quality metrics.

Example 94: The apparatus of any of example 91 to 93, wherein the information message comprises a base filter flag, wherein a value of 1 for the base filter flag specifies that one or more target filters comprise one or more base filters with the filter identifiers equal to the target filter identifiers, and wherein the value equal to 0 for the base filter flag specifies that the one or more target filters are filters specified by a last information message with the filter identifiers equal to the target filter identifiers that precedes a first video coding layer network abstraction layer unit of a current picture in decoding order that is not a repetition of the information message comprising a base filter.

Example 95: An apparatus comprising: at least one processor; and at least one memory storing instructions that, when executed by the at least one processor, causes the apparatus at least to perform: receive an information message; decode, from the information message, whether one or more base filters or one or more updated filters are to be activated; and activate the one or more base filters or the one or more updated filters based on decoding the information message.

Example 96: The apparatus of example 95, wherein the information message comprises a base filter flag, wherein a value of 1 for the base filter flag specifies that one or more target filters comprise the one or more base filters with filter identifiers equal to target filter identifiers, and wherein the value equal to 0 for the base filter flag specifies that the one or more target filters are filters specified by a last information message with the filter identifiers equal to the target filter identifiers that precedes a first video coding layer network abstraction layer unit of a current picture in decoding order that is not a repetition of the information message comprising a base filter.

Example 97: An apparatus comprising: at least one processor; and at least one memory storing instructions that, when executed by the at least one processor, causes the apparatus at least to: receive, from an encoder, an encoding of at least one picture; receive information related to a group of at least one post-processing filter, wherein the information is received as part of a nesting supplemental enhancement information (SEI) message that comprises one or more other SEI messages; and use the information related to the group of the at least one post-processing filter to infer whether and how to use at least one post-processing filter in the group of the at least one post-processing filter for the at least one picture.

Example 98: The apparatus of example 97, wherein the one or more other SEI messages comprise one or more neural-network post-filter characteristics (NNPFC) SEI messages describing characteristics of respective one or more post-processing filters comprised in the group of one or more post-processing filters.

Example 99: An apparatus comprising: at least one processor; and at least one memory storing instructions that, when executed by the at least one processor, causes the apparatus at least to: transmit, to a decoder, an encoding of at least one picture; determine information related to a group of at least one post-processing filter; and signal, to the decoder, the information related to the group of the at least one post-processing filter, wherein the information is signaled as part of a nesting supplemental enhancement information (SEI) message that comprises one or more other SEI messages; wherein the information related to the group of the at least one post-processing filter is configured to be used to infer whether and how to use at least one post-processing filter in the group of the at least one post-processing filter for the at least one picture.

Example 100: The apparatus of example 99, wherein the one or more other SEI messages comprise one or more neural-network post-filter characteristics (NNPFC) SEI messages describing characteristics of respective one or more post-processing filters comprised in the group of one or more post-processing filters.

Example 101: An apparatus comprising: at least one processor; and at least one memory storing instructions that, when executed by the at least one processor, causes the apparatus at least to: receive information for identifying one or more post-filters comprised in a group of one or more post-filters, wherein the information is received as part of a nesting supplemental enhancement information (SEI) message, and wherein the nesting SEI message comprises one or more other SEI messages, and wherein the one or more other SEI messages comprise one or more SEI messages that describe or comprise the information about respective one or more postfilters that belong to the group represented by the nesting SEI message; and use the information for identifying the one or more post-filters comprised in the group of one or more post-filters.

Example 102: The apparatus of example 101, wherein the one or more other SEI messages comprise one or more neural-network post-filter characteristics (NNPFC) SEI messages describing characteristics of respective one or more post-processing filters comprised in the group of one or more post-processing filters.

Example 103: An apparatus comprising: at least one processor; and at least one memory storing instructions that, when executed by the at least one processor, causes the apparatus at least to: determine information for identifying one or more post-filters comprised in a group of one or more post-filters; and signal the information as part of a nesting supplemental enhancement information (SEI) message, wherein the nesting SEI message comprises one or more other SEI messages, and wherein the one or more other SEI messages comprise one or more SEI messages that describe or comprise the information about respective one or more postfilters that belong to the group represented by the nesting SEI message.

Example 104: The apparatus of example 103, wherein the one or more other SEI messages comprise one or more neural-network post-filter characteristics (NNPFC) SEI messages describing characteristics of respective one or more post-processing filters comprised in the group of one or more post-processing filters.

Example 105: A method comprising: generating or amending an information message to include an indication whether the information message activates one or more base filters or one or more updated filters identified by filter identifiers equal to target filter identifiers, wherein the target filter identifiers identify target filters, and wherein the target filters are used for post-processing filtering; and signaling the information message to a decoder.

Example 106: A method comprising: receiving an information message; decoding, from the information message, whether one or more base filters or one or more updated filters are to be activated; and activating the one or more base filters or the one or more updated filters based on decoding the information message.

Example 107: A method comprising: receiving, from an encoder, an encoding of at least one picture; receiving information related to a group of at least one post-processing filter, wherein the information is received as part of a nesting supplemental enhancement information (SEI) message that comprises one or more other SEI messages; and using the information related to the group of the at least one post-processing filter to infer whether and how to use at least one post-processing filter in the group of the at least one post-processing filter for the at least one picture.

Example 108: A method comprising: transmitting, to a decoder, an encoding of at least one picture; determining information related to a group of at least one post-processing filter; and signaling, to the decoder, the information related to the group of the at least one post-processing filter, wherein the information is signaled as part of a nesting supplemental enhancement information (SEI) message that comprises one or more other SEI messages; wherein the information related to the group of the at least one post-processing filter is configured to be used to infer whether and how to use at least one post-processing filter in the group of the at least one post-processing filter for the at least one picture.

Example 109: A method comprising: receiving information for identifying one or more post-filters comprised in a group of one or more post-filters, wherein the information is received as part of a nesting supplemental enhancement information (SEI) message, and wherein the nesting SEI message comprises one or more other SEI messages, and wherein the one or more other SEI messages comprise one or more SEI messages that describe or comprise the information about respective one or more postfilters that belong to the group represented by the nesting SEI message; and using the information for identifying the one or more post-filters comprised in the group of one or more post-filters.

Example 110: A method comprising: determining information for identifying one or more post-filters comprised in a group of one or more post-filters; and signaling the information as part of a nesting supplemental enhancement information (SEI) message, wherein the nesting SEI message comprises one or more other SEI messages, and wherein the one or more other SEI messages comprise one or more SEI messages that describe or comprise the information about respective one or more postfilters that belong to the group represented by the nesting SEI message.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

In the above, some embodiments have been described with reference to specific SEI messages, such as NNPFC SEI message(s) and/or NNPFA SEI message(s). It needs to be understood that embodiments may similarly be realized with any SEI messages of similar nature. For example, some embodiments may be realized with post-filter characteristics and/or activation SEI message(s) where post-filters are not based on neural networks.

In the above, some example embodiments have been described with reference to an SEI message or an SEI NAL unit. It needs to be understood, however, that embodiments may similarly be realized with any similar structures or data units, such as metadata OBUs. Where example embodiments have been described with SEI messages included in a structure, any independently parsable structures could likewise be used in embodiments. Specific SEI NAL unit and SEI message syntax structures have been presented in example embodiments, but it needs to be understood that embodiments generally apply to any syntax structures with a similar intent as SEI NAL units and/or SEI messages.

In the above, some embodiments have been described with reference to a post-filter or a post-processing filter. It is to be understood that embodiments may similarly be realized with reference to an in-loop filter.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:

| | |
|---|---|
| 3D | three-dimensional |
| 3GPP | 3rd generation partnership project |
| 4G | fourth generation of broadband cellular network technology |
| 5G | fifth generation cellular network technology |
| 802.x | family of IEEE standards dealing with local area networks and |
| | metropolitan area networks |
| AOM | alliance of open media |
| APS | adaptation parameter set |
| ASIC | application specific integrated circuit |
| AVx | Alliance for Open Media video codec (e.g. AV1, AV2) |
| AVC | advanced video coding |
| BD | Bjontegaard delta e.g. BD-rate |
| b(n) | byte having any pattern of bit string (8 bits) |
| BT.2020 | set of specifications covering various aspects of video broadcasting |
| CDMA | code-division multiple access |
| CLVS | coded layer video sequence |
| CPU | central processing unit |
| CTU | coding tree unit |
| CVS | coded video sequence |
| DCT | discrete cosine transform |
| DPB | decoded picture buffer |
| DSP | digital signal processor |
| FDMA | frequency division multiple access |
| FPGA | field programmable gate array |
| GBR | green, blue, red |
| GOP | group of pictures |
| GPU | graphical processing unit |
| GSM | global system for mobile communications |
| H.222.0 | MPEG-2 systems, standard for the generic coding of moving pictures |
| | and associated audio information |
| H.2xx | family of video coding standards in the domain of the ITU-T (e.g. |
| | H.263 and H.264) |
| HEVC | high efficiency video coding |
| HMD | head-mounted display |
| IBC | intra block copy |
| ID or id | identifier |
| IEC | International Electrotechnical Commission |
| IEEE | Institute of Electrical and Electronics Engineers |
| I/F | interface |
| IMD | integrated messaging device |
| IMS | instant messaging service |
| I/O | input/output |
| IoT | internet of things |
| IP | internet protocol |
| ISO | International Organization for Standardization |
| ISOBMFF | ISO base media file format |
| ITU | International Telecommunication Union |
| ITU-R | International Telecommunication Union Radiocommunication Sector |
| ITU-T | ITU Telecommunication Standardization Sector |
| JCT-VC | joint collaborative team - video coding |
| JVT | joint video team |
| JVET | Joint Video Experts Team |
| LTE | long-term evolution |
| MAC | multiply-accumulate |
| mAP | mean average precision |
| MMS | multimedia messaging service |
| MOS | mean opinion score |
| MOTA | multiple object tracking accuracy |
| MPEG | moving picture experts group |
| MPEG-2 | H.222/H.262 as defined by the ITU |
| MPEG-H | MPEG HEVC |
| MPEG-I | MPEG immersive |
| MS | multi-scale (e.g. MS-SSIM) |
| MSE | mean squared error |
| MV | multiview |
| MVC | multiview video coding |
| NAL | network abstraction layer |
| NN | neural network |
| NNPF | neural-network post-filter |
| NNPFA | neural-network post-filter activation |
| NNPFC | neural-network post-filter characteristics |
| N/W | network |
| OBU | open bitstream unit |
| PC | personal computer |
| PDA | personal digital assistant |
| PFG | postfilter group |
| PID | packet identifier |
| PLC | power line communication |
| POC | picture order count |
| PPS | picture parameter set |
| PSNR | peak signal-to-noise ratio |
| QP | quantization parameter |
| RAM | random access memory |
| RBSP | raw byte sequence payload |
| REXT | range extensions |
| RFID | radio frequency identification |
| RFM | reference frame memory |
| RGB | red, green, blue |
| ROI | region of interest |
| SEI | supplemental enhancement information |
| SHVC | scalabilty extension of HEVC |
| SMS | short messaging service |
| SNR | signal to noise ratio |
| SON | self-organizing/optimizing network |
| SPS | sequence parameter set |
| SSIM | structural similarity index measure |
| st(v) | null-terminated string encoded as universal coded character set |
| | (UCS) transmission format-8 (UTF-8) characters as specified in |
| | ISO/IEC 10646. The parsing process is specified as follows: st(v) |
| | begins at a byte-aligned position in the bitstream and reads and |
| | returns a series of bytes from the bitstream, beginning at the current |
| | position and continuing up to but not including the next byte-aligned |
| | byte that is equal to 0x00, and advances the bitstream pointer by |
| | ( stringLength + 1 ) * 8 bit positions, where stringLength is equal to |
| | the number of bytes returned. |
| SVC | scalable video coding |
| TCP-IP | transmission control protocol-internet protocol |
| TDMA | time divisional multiple access |
| TS | transport stream |
| TV | television |
| UCS | universal coded character set |
| UE | user equipment |
| ue(v) | unsigned integer Exp-Golomb-coded syntax element with the left bit |
| | first |
| UHDTV | ultra-high-definition television |
| UI | user interface |
| UICC | universal integrated circuit card |
| UMTS | universal mobile telecommunications system |
| u(n) | unsigned integer using n bits |
| URI | uniform resource identifier |
| URN | uniform resource name |
| USB | universal serial bus |
| UTF-8 | universal coded character set transmission format-8 |
| VCEG | video coding experts group |
| VCL | video coding layer |
| VCM | video coding for machines |
| VUI | video usability information |
| VPS | video parameter set |
| VSEI | versatile supplemental enhancement information |
| VVC | versatile video coding |

1-110. (canceled)

111. An apparatus comprising:
at least one processor; and
at least one memory storing instructions that, when executed by the at least one processor, causes the apparatus at least to:
generate or amend an information message to include an indication whether the information message activates one or more base filters or one or more updated filters identified by filter identifiers equal to target filter identifiers, wherein the target filter identifiers identify target filters, and wherein the target filters are used for post-processing filtering; and
signal the information message to a decoder.

112. The apparatus of claim 111, wherein the apparatus is further caused to:
determine whether the one or more base filters or the one or more updated filters are beneficial for filtering one or more consecutive pictures.

113. The apparatus of claim 112, wherein the apparatus is further caused to:
filter the one or more consecutive pictures with the one or more base filters;
filter the one or more consecutive pictures with the one or more updated filters; and
select the one or more base filters or the one or more updated filters based on which one performs better with one or more quality metrics.

114. The apparatus of claim 111, wherein the information message comprises a base filter flag, wherein a first value for the base filter flag specifies that one or more target filters comprise one or more base filters with the filter identifiers equal to the target filter identifiers, and wherein a second value for the base filter flag specifies that the one or more target filters are filters specified by a last information message with the filter identifiers equal to the target filter identifiers that precedes a first video coding layer network abstraction layer unit of a current picture in decoding order that is not a repetition of the information message comprising a base filter.

115. The apparatus of claim 114, wherein the first value comprises one and the second value comprises zero.

116. The apparatus of claim 114, wherein the first value comprises zero and the second value comprises one.

117. An apparatus comprising:
at least one processor; and
at least one memory storing instructions that, when executed by the at least one processor, causes the apparatus at least to perform:
receive an information message;
decode, from the information message, whether one or more base filters or one or more updated filters are to be activated; and
activate the one or more base filters or the one or more updated filters based on decoding the information message.

118. The apparatus of claim 117, wherein the information message comprises a base filter flag, wherein a first value for the base filter flag specifies that one or more target filters comprise the one or more base filters with filter identifiers equal to target filter identifiers, and wherein a second value for the base filter flag specifies that the one or more target filters are filters specified by a last information message with the filter identifiers equal to the target filter identifiers that precedes a first video coding layer network abstraction layer unit of a current picture in decoding order that is not a repetition of the information message comprising a base filter.

119. The apparatus of claim 118, wherein the first value comprises one and the second value comprises zero.

120. The apparatus of claim 118, wherein the first value comprises zero and the second value comprises one.

121. A method comprising:
generating or amending an information message to include an indication whether the information message activates one or more base filters or one or more updated filters identified by filter identifiers equal to target filter identifiers, wherein the target filter identifiers identify target filters, and wherein the target filters are used for post-processing filtering; and
signaling the information message to a decoder.

122. The method of claim 121 further comprising:
determining whether the one or more base filters or the one or more updated filters are beneficial for filtering one or more consecutive pictures.

123. The method of claim 122 further comprising:
filtering the one or more consecutive pictures with the one or more base filters;
filtering the one or more consecutive pictures with the one or more updated filters; and
selecting the one or more base filters or the one or more updated filters based on which one performs better with one or more quality metrics.

124. The method of claim 121, wherein the information message comprises a base filter flag, wherein a first value for the base filter flag specifies that one or more target filters comprise one or more base filters with the filter identifiers equal to the target filter identifiers, and wherein a second value for the base filter flag specifies that the one or more target filters are filters specified by a last information message with the filter identifiers equal to the target filter identifiers that precedes a first video coding layer network abstraction layer unit of a current picture in decoding order that is not a repetition of the information message comprising a base filter.

125. The method of claim 124, wherein the first value comprises one and the second value comprises zero.

126. The method of claim 124, wherein the first value comprises zero and the second value comprises one.

127. A method comprising:
receiving an information message;
decoding, from the information message, whether one or more base filters or one or more updated filters are to be activated; and
activating the one or more base filters or the one or more updated filters based on decoding the information message.

128. The method of claim 127, wherein the information message comprises a base filter flag, wherein a first value for the base filter flag specifies that one or more target filters comprise the one or more base filters with filter identifiers equal to target filter identifiers, and wherein a second value equal for the base filter flag specifies that the one or more target filters are filters specified by a last information message with the filter identifiers equal to the target filter identifiers that precedes a first video coding layer network abstraction layer unit of a current picture in decoding order that is not a repetition of the information message comprising a base filter.

129. The method of claim 128, wherein the first value comprises one and the second value comprises zero.

130. The apparatus of claim 128, wherein the first value comprises zero and the second value comprises one.
